(19) United States
(12) Patent Application Publication
(10) Pub. No.: US 2014/0142861 A1
(43) Pub. Date: May 22, 2014

(54) Biomarkers For Predicting Progressive Joint Damage

(71) Applicants: William A. Hagstrom, Los Altos, CA (US); David N. Chernoff, San Rafael, CA (US); Yijing Shen, San Mateo, CA (US); Guy L. Cavet, Burlingame, CA (US); Michael Centola, Oklahoma City, OK (US)

(72) Inventors: William A. Hagstrom, Los Altos, CA (US); David N. Chernoff, San Rafael, CA (US); Yijing Shen, San Mateo, CA (US); Guy L. Cavet, Burlingame, CA (US); Michael Centola, Oklahoma City, OK (US)

(73) Assignees: OKLAHOMA MEDICAL RESEARCH FOUNDATION, Oklahoma City, OK (US); CRESCENDO BIOSCIENCE, South San Francisco, CA (US)

(21) Appl. No.: 13/883,749

(22) PCT Filed: Nov. 7, 2011
(86) PCT No.: PCT/US11/59621

§ 371 Date: Dec. 30, 2013

Related U.S. Application Data
(60) Provisional application No. 61/410,883, filed on Nov. 6, 2010.

(51) Int. Cl. G06F 19/18

(52) U.S. Cl. CPC G06F 19/18
USPC 702/19

(57) ABSTRACT

A method scores a sample, by receiving a first dataset associated with a first sample obtained from a first subject, wherein said first dataset comprises quantitative data for at least two markers selected from the group consisting of: CCL22; CHI3L1; COMP; CRP; CSF1; CXCL10; EGF; ICAM1; ICAM3; ICTP; IL1B; IL2RA; IL6; IL6R; IL8; LEP; MMP1; MMP3; PYD; RETN; SAA1; THBD; TIMP1; TNFRSF11B; TNFRSF1A; TNFSF11; VCAM1; and VEGFA; and determining a first SDI score from said first dataset using an interpretation function, wherein the first SDI score provides a quantitative measure of the rate of change in joint structural damage in said first subject.

### RELATED APPLICATIONS

This application claims the benefit of earlier-field and co-pending U.S. Application No. 61/410,883 filed on Nov. 6, 2010 which is hereby incorporated by reference in its entirety for all purposes.

### INTRODUCTION

The present teachings are generally directed to biomarkers that report on the rate of disease progression in a subject with inflammatory and/or autoimmune disease, for example rheumatoid arthritis (RA), as well as various other embodiments as described herein.

The section headings used herein are for convenience and organizational purposes only, and are not to be construed as limiting the subject matter described in any way. All literature and similar materials cited in this application, including but not limited to scientific publications, articles, books, treatises, published patent applications, issued patents, and internet web pages, regardless the format of such literature and similar materials, are expressly incorporated by reference in their entirety for any purpose.

### BACKGROUND

RA is an example of an inflammatory disease, and is a chronic, systemic autoimmune disorder. It is one of the most common systemic autoimmune diseases worldwide. In RA, the immune system of the subject mounts an immune response to the subject's own joints as well as other organs, including the lung, blood vessels and pericardium, leading to inflammation of the joints (arthritis), widespread endothelial inflammation, and, as the disease progresses, joint structural damage (SD) due to joint space narrowing and erosion of joint tissue. This joint damage is largely irreversible, and cumulatively results in joint destruction, loss of joint function and subject disability.

The precise etiology of RA has not been established, but its underlying disease pathogenesis is complex and includes inflammation and immune dysregulation. The precise mechanisms involved are different in individual subjects, and can change in those subjects over time. Variables such as race, sex, genetics, hormones, and environmental factors can also impact the development and severity of RA disease. Emerging data also reveal the characteristics of new RA subject subgroups, and complex overlapping relationships with other autoimmune disorders. Disease duration and level of inflammatory activity is also associated with other comorbidities such as risk of lymphoma, extra-articular manifestations, and cardiovascular disease. See, e.g., S. Banerjee et al., Am. J. Cardiol. 2008, 101(8):1201-1205; E. Baecklund et al., Arth. Rheum. 2006, 54(3):692-701; and, N. Goodson et al., Ann. Rheum. Dis. 2005, 64(11):1595-1601. Because of the complexity of RA, it has proven difficult to develop a single test that can accurately and consistently assess, quantify, and monitor RA disease activity and/or disease progression in every subject.

Traditional models for treating RA are based on the expectation that bringing inflammatory disease activity to clinical remission should slow or prevent disease progression in terms of cartilage loss and joint erosion. It should be noted, however, that different cell signaling pathways and mediators are involved in the two processes, inflammatory disease activity and disease progression (see, e.g., W. van den Berg et al., Arth. Rheum. 2005, 52:995-999), and the two do not always function completely in tandem, but can be uncoupled. This uncoupling of inflammatory disease activity and disease progression is described in a number of RA clinical trials and animal studies; indeed, RA subjects treated to clinical remission may continue to show progressive radiographic damage. See A K Brown et al., Arth. Rheum. 2008, 58(10):2958-2967. See also P E Lipsky et al., N. Engl. J. Med. 2003, 343:1594-602; A K Brown et al., Arth. Rheum. 2006, 54:3761-3773; and, A R Pettit et al., Am. J. Pathol. 2001, 159:1689-99. Furthermore, studies of RA subjects indicate limited association between clinical and radiographic responses. See E. Zatarain and V. Strand, Nat. Clin. Pract. Rheum. 2006, 2(11):611-618 (Review). RA subjects have been described who demonstrated radiographic benefits from combination treatment with infliximab and methotrexate (MTX), yet did not demonstrate any clinical improvement as measured by DAS (Disease Activity Score; see Definitions, below) and CRP (C-reactive protein). See J S Smolen et al., Arth. Rheum. 2005, 52(4):1020-30.

It has been shown that frequent, e.g. monthly, monitoring of disease activity (such frequent monitoring known as “tight control”) results in quicker improvement in the subjects and better subject outcomes. For example, subjects with monthly disease activity assessments have better radiographic outcomes and physical function over time than those with standard of care (standard of care being no assessment of disease activity, or assessments made less frequently than monthly), and more tight-control subjects are in remission (remission being the ultimate goal of treatment for RA and other chronic inflammatory diseases) after one year than subjects receiving standard of care. See Y P M Goekoop-Ruiterman et al., Ann. Rheum. Dis. 2009 (Epublication Jan. 20, 2009); C. Grigor et al., Lancet 2004, 364:263-269; W. Kievit et al., Ann. Rheum. Dis. 2008, 67(9):1229-1234; T. Mottonen et al., Arth. Rheum. 2002, 46(4):894-898; VK Ranganath et al., J. Rheum. 2008, 35:1966-1971; T. Sokka et al., Clin. Exp. Rheum. 2006, 24(Suppl. 43):S74-76; LHD van Tuyl et al., Ann. Rheum. Dis. 2008, 67:1574-1577; and, SMM Verstappen et al., Ann. Rheum. Dis. 2007, 66:1443-1449. The effective monitoring of disease activity thus leads to better outcomes and quicker improvement for the RA subject.

There are many reasons that it is also important to be able to monitor and predict a subject's rate of disease progression, and to classify subjects according to this rate of progression; for example, in order to ensure that each subject receives treatment that is timely, appropriate and optimized for that subject, or to increase or decrease the level of treatment depending on the rate of disease progression. For example, combinations of disease-modifying anti-rheumatic drugs (DMARDS) have become accepted treatment for the RA subject whose disease continues to progress (as evidenced by the rate of joint damage) despite treatment with a single DMARD. Studies analyzing treatment with MTX alone and treatment with MTX in combination with other DMARDs demonstrate that in DMARD-naive subjects, the balance of efficacy versus toxicity favors MTX monotherapy. In regards to biologics (e.g., anti-TNFα therapy), studies support the use of biologics in combination with MTX in subjects with early RA, or in subjects with established RA who have not yet been treated with MTX. See, e.g., G. Cohen et al., Ann. Rheum. Dis. 2007, 66:358-363. See also Y P M Goekoop-Ruiterman et al., Arth. Rheum. 2005, 52(11):3381-3390. The number of drugs available for treating RA is increasing; from this it follows that the number of possible combinations of these drugs is increasing as well. In addition, the chronological order in which each drug in a combination is administered can vary depending on the needs of the subject. The clinician who applies a simple trial-and-error process to finding the optimum treatment for the RA subject from among the myriad of possible combinations, thus runs the risk of under- or over-treating the subject. Continued disease progression and irreversible joint damage could be the result. Clearly there exists a need to accurately classify subjects by rate of disease progression in order to establish their optimal treatment regimens.

Current clinical management and treatment goals, in the case of RA, focus on the suppression of disease activity, slowing the progression of joint damage, and improving the subject's functional ability. Clinical assessments of RA disease activity include measuring the subject's difficulty in performing activities, morning stiffness, pain, inflammation, and number of tender and swollen joints, an overall assessment of the subject by the physician, an assessment by the subject of how good s/he feels in general, and measuring the subject's erythrocyte sedimentation rate (ESR) and levels of acute phase reactants, such as CRP. Composite indices comprising multiple variables, such as those just described, have been developed as clinical assessment tools to monitor disease activity. Some of the most commonly used are: the American College of Rheumatology criteria (ACR20, ACR 50, and ACR70) (DT Felson et al., Arth. Rheum. 1993, 36(6):729-740 and DT Felson et al., Arth. Rheum. 1995, 38(6):727-735); Clinical Disease Activity Index (CDAI) (D. Aletaha et al., Arth. Rheum. 2005, 52(9):2625-2636); the Disease Activity Score (DAS) (MLL Prevoo et al., Arth. Rheum. 1995, 38(1):44-48 and A M van Gestel et al., Arth. Rheum. 1998, 41(10):1845-1850); the Rheumatoid Arthritis Disease Activity Index (RADAI) (G. Stucki et al., Arth. Rheum. 1995, 38(6):795-798); the Clinical Disease Activity Index (CDAI); and, the Simplified Disease Activity Index (SDAI) (J S Smolen et al., Rheumatology (Oxford) 2003, 42:244-257).

Current laboratory tests routinely used to monitor disease activity in RA subjects, such as CRP and ESR, are relatively non-specific (e.g., are not RA-specific and cannot be used to diagnose RA), do not provide specific information as to the subject's disease progression status or rate of progression (as regards joint tissue destruction), and cannot be used to determine response to treatment or predict future outcomes. See, e.g., L. Gossec et al., Ann. Rheum. Dis. 2004, 63(6):675-680; EJA Kroot et al., Arth. Rheum. 2000, 43(8):1831-1835; H. Mäkinen et al., Ann. Rheum. Dis. 2005, 64(10):1410-1413; Z. Nadareishvili et al., Arth. Rheum. 2008, 59(8):1090-1096; N A Khan et al., Abstract, ACR/ARHP Scientific Meeting 2008; T A Pearson et al., Circulation 2003, 107(3):499-511; M J Plant et al., Arth. Rheum. 2000, 43(7):1473-1477; T. Pincus et al., Clin. Exp. Rheum. 2004, 22(Suppl. 35):S50-S56; and, P M Ridker et al., NEJM 2000, 342(12):836-843. In the case of ESR and CRP, RA subjects may continue to have elevated ESR or CRP levels despite being in clinical remission (and non-RA subjects may display elevated ESR or CRP levels). Some subjects in clinical remission, as determined by DAS, continue to demonstrate continued disease progression radiographically, by joint tissue erosion or joint space narrowing. Furthermore, some subjects who do not demonstrate clinical benefits still demonstrate radiographic benefits from treatment. See, e.g., F C Breedveld et al., Arth. Rheum. 2006, 54(1):26-37. Clearly, in order to predict future outcome and treat the RA subject accordingly, there is a need for clinical assessment tools that accurately assess an RA subject's disease status and rate of progression, and that can act as predictors of the future course of disease.

Clinical assessments of RA disease progression, as witnessed by joint damage (erosion and joint space narrowing) include X-rays and ultrasonography (US), both of which require subjective and possibly variable determinations of the extent of damage by the clinician. X-rays expose the subject to radiation that is potentially harmful when repeated over time. Importantly, both X-rays and US are lagging indicators for disease progression—they indicated what damage has already occurred, but do not predict future damage or the rate of change in joint damage. Further, a determination of the rate of change in joint damage requires repeated examinations and a comparison of the results. All of this is difficult to quantify consistently and objectively.

The Sharp score has been used as a quantitative measurement of joint damage. It is a composite measure of joint space narrowing and erosion in a subject based on X-rays, and can be given by, e.g., units/year. There are subjectivity and variability components to the use of the Sharp score as a clinical assessment of RA disease progression. Disease progression scoring by X-ray is time-consuming and subject to inter- and intra-operator variability. A method of clinically assessing disease progression is needed that is less time-consuming, provides less risk to the subject than X-rays, and is more consistent, objective and quantitative, while being specific to the disease assessed (such as RA).

Developing biomarker-based tests for the clinical assessment of RA disease progression has proved difficult in practice because of the complexity of RA biology—the various molecular pathways involved and the intersection of autoimmune dysregulation and inflammatory response. Adding to the difficulty of developing RA-specific biomarker-based tests are the technical challenges involved; e.g., the need to block non-specific matrix binding in serum or plasma samples, such as rheumatoid factor (RF) in the case of RA. The detection of cytokines using bead-based immunoassays, for example, is generally not reliable because of interference by RF; hence, RF-positive subjects cannot be tested for RA-related cytokines using this technology (and RF removal methods attempted have not significantly improved the results). See S. Churchman et al., Ann. Rheum. Dis. 2009, 68:A1-A56, Abstract A77. Approximately 70% of RA subjects are RF-positive, so any biomarker-based test that cannot assess RF-positive patients is clearly of limited use.

To achieve the maximum therapeutic benefits for individual subjects, it is important to be able to specifically quantify and assess the subject's inflammatory disease progression status and the rate of progression, determine the effects of treatment on disease progression, and predict future outcomes. No existing single biomarker or multi-biomarker test produces results demonstrating a high association with level of RA disease progression. The embodiments of the present teachings identify multiple serum biomarkers for the accurate clinical assessment of disease progression in subjects with chronic inflammatory disease, such as RA, along with methods of their use.

### SUMMARY

The present teachings relate to biomarkers associated with inflammatory disease, and specifically with autoimmune inflammatory disease, including RA, and methods of using the biomarkers to measure inflammatory disease progression in a subject. For further explanation of some of the terms that appear in this section, see Definitions.

In one embodiment, a method for scoring a sample comprises: receiving a first dataset associated with a first sample obtained from a first subject, wherein said first dataset comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); and, determining a first SDI score from said first dataset using an interpretation function, wherein the first SDI score provides a quantitative measure of the rate of change in joint structural damage in said first subject.

In some embodiments said first dataset is obtained by a method comprising: obtaining said first sample from said first subject, wherein said first sample comprises a plurality of analytes; contacting said first sample with a reagent; generating a plurality of complexes between said reagent and said plurality of analytes; and, detecting said plurality of complexes to obtain said first dataset associated with said first sample, wherein said first dataset comprises quantitative data for said at least two markers.

In some embodiments said first subject is diagnosed with an inflammatory disease which is rheumatoid arthritis in some embodiments.

In some embodiments said first SDI score is predictive of the rate of change of a clinical assessment. In some embodiments said clinical assessment is selected from the group consisting of: a DAS, a DAS28, a DAS28-ESR, a DAS28-CRP, a RAMRIS, a Sharp score, a total Sharp score (TSS), a van der Heijde-modified Sharp score, a van der Heijde modified total Sharp score, a tender joint count, a swollen joint count, a joint space narrowing score, an erosion score, and an ultrasound score. In some embodiments said clinical assessment is a Sharp score. In some embodiments said clinical assessment is a total Sharp score.

In some embodiments said interpretation function is based on a predictive model. In some embodiments said predictive model is developed using an algorithm comprising a Curds and Whey method, Curds and Whey-Lasso method, forward linear stepwise regression, or a Lasso shrinkage and selection method for linear regression.

In some embodiments said joint structural damage comprises joint erosion and joint space narrowing.

In some embodiments the method further comprises receiving a second dataset associated with a second sample obtained from said first subject, wherein said first sample and said second sample are obtained from said first subject at different times; determining a second SDI score from said second dataset using said interpretation function; and comparing said first SDI score and said second SDI score to determine a change in said SDI scores, wherein said change indicates a change in said rate of joint structural damage in said first subject. In some embodiments said indicated change in rate of joint structural damage indicates the presence, absence or extent of the subject's response to a therapeutic regimen. In some embodiments the method further comprises determining a prognosis for rheumatoid arthritis progression in said first subject based on said predicted Sharp score change rate.

In some embodiments one of said at least two markers is CRP or SAA1.

In some embodiments said interpretation function is SDIₖ=β₀+Σᵢ₌₁ⁿβᵢXᵢₖ+eₖ, where Xᵢₖ is the marker concentration for the ith biomarker and kth patient, β is the biomarker coefficient, and SDIₖ represents the predicted change in Sharp score from the time that the biomarkers are measured over the period of interest for subject k.

In some embodiments said SDI score is used as an inflammatory disease surrogate endpoint. In some embodiments said inflammatory disease is rheumatoid arthritis.

Also provided is a method for determining a presence or absence of rheumatoid arthritis in a subject, the method comprising determining SDI scores for subjects in a population wherein said subjects are negative for rheumatoid arthritis; deriving an aggregate SDI value for said population based on said determined SDI scores; determining a second SDI score for a second subject; comparing the aggregate SDI value to the second SDI score; and determining a presence or absence of rheumatoid arthritis in said second subject based on said comparison.

In some embodiments said first subject has received a treatment for rheumatoid arthritis, and further comprising the steps of: determining a second SDI score for a second subject wherein said second subject is of the same species as said first subject and wherein said second subject has received treatment for rheumatoid arthritis; comparing said first SDI score to said second SDI score; and determining a treatment efficacy for said first subject based on said score comparison.

In some embodiments the method further comprises determining a response to rheumatoid arthritis therapy based on said SDI score.

In some embodiments the method further comprises selecting a rheumatoid arthritis therapeutic regimen based on said SDI score.

In some embodiments the method further comprises determining a rheumatoid arthritis treatment course based on said SDI score.

In some embodiments the method further comprises rating a rate of change in joint structural damage as low, medium or high based on said SDI score.

In some embodiments the predictive model performance is characterized by an AUC ranging from 0.60 to 0.99, from 0.70 to 0.79 or from 0.80 to 0.89.

In some embodiments said at least two markers (IL2RA and IL6), (IL2RA and SAA1), (IL6 and SAA1), (IL1B and IL2RA), (TNFRSF11B and IL6), (ICAM1 and IL6), (IL6 and PYD), (CCL22 and IL6), (CHI3L1 and IL6), (CRP and IL6), (IL6 and MMP3), (ICAM3 and IL2RA), (IL6 and VEGFA), (IL6 and RANKL), (ICAM3 and IL6), (IL6 and THBD), (IL6 and MCSF), (IL6 and TNFRSF1A), (IL6 and LEP), (IL6 and IL6R), (IL6 and VCAM1), (IL6 and IL8), (COMP and IL6), (IL2RA and RETN), (IL6 and RETN), (IL2RA and IL6R), (IL6 and MMP1), (TNFRSF11B and RETN), (COMP and IL2RA), (IL1B and IL6), (IL6 and TIMP1), (CHI3L1 and RETN), (IL2RA and LEP), (IL2RA and TIMP1), (CXCL10 and IL6), (EGF and IL6), (IL2RA and RANKL), (IL2RA and MMP3), (IL2RA and THBD), (IL1B and SAA1), (LEP and SAA1), (CRP and IL2RA), (ICTP and IL6), (IL2RA and MCSF) or (ICAM1 and IL2RA).

In some embodiments said at least two markers comprise one set of markers selected from the group consisting of TWOMRK Set Nos. 1 through 138 of FIG. 1.

In some embodiments said at least two markers comprises at least three markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

In some embodiments said at least two markers comprises one set of three markers selected from the group consisting of THREEMRK Set Nos. 1 through 482 of FIG. 2.

In some embodiments said at least two markers comprises at least four markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

In some embodiments said at least two markers comprises one set of four markers selected from the group consisting of FOURMRK Set Nos. 1 through 25 of FIG. 3.

In some embodiments said at least two markers comprises at least five markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

In some embodiments said at least two markers comprises one set of five markers selected from the group consisting of FIVEMRK Set Nos. 1 through 30 of FIG. 4.

In some embodiments said at least two markers comprises at least six markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

In some embodiments said at least six markers comprises one set of six markers selected from the group consisting of SIXMRK Set Nos. 1 through 36 of FIG. 5.

In some embodiments the method further comprises reporting said SDI score to said first subject.

In some embodiments said first SDI score is predictive of the risk of joint structural damage progression.

Also provided are computer-implemented methods, systems and non-transitory computer-readable media comprising program code for implementing the disclosed methods.

In some embodiments, the present teachings comprise a method or a computer-implemented method for quantifying the rate of change in joint structural damage in a mammalian subject, which method comprises storing, in a storage memory, a first dataset associated with a first sample obtained from the subject, wherein the dataset comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); determining, by a computer processor, a first SDI score from the first dataset using an interpretation function, wherein the first SDI score provides a quantitative measure of the rate of change in joint structural damage in the subject. In some embodiments, the interpretation function is based on a predictive model. In some embodiments, the joint structural damage comprises joint erosion and joint space narrowing. In some embodiments, the dataset further comprises a clinical assessment, a clinical parameter, or a combination of a clinical assessment and a clinical parameter.

In certain embodiments of the present teachings, the clinical assessment is selected from the group consisting of: a DAS, a DAS28, a DAS28-ESR, a DAS28-CRP, an HAQ, an mHAQ, an MDHAQ, a physician global assessment VAS, a patient global assessment VAS, a pain VAS, a fatigue VAS, an overall VAS, a sleep VAS, an SDAI, a RAPID, a CDAI, an ACR20, an ACR50, an ACR70, an SF-36, a RAMRIS, a total Sharp score, a van der Heijde-modified Sharp score, a van der Heijde modified total Sharp score, a Larsen score, a tender joint count, and a swollen joint count. In some embodiments, the clinical parameter is selected from the group consisting of: age, race/ethnicity, gender/sex, disease duration, diastolic blood pressure, systolic blood pressure, a family history parameter, height, weight, a body-mass index, resting heart rate, tender joint count, swollen joint count, a morning stiffness parameter, a parameter indicating arthritis of three or more joint areas, a parameter indicating arthritis of hand joints, a symmetric arthritis parameter, a rheumatoid nodules parameter, a radiographic changes parameter, a parameter indicating other imaging data, therapeutic regimen, CCP status, RF status, ESR, and smoker/non-smoker.

In some embodiments of the present teachings, the predictive model is developed using machine learning methods which include discriminant function analysis, Curds and Whey method, Curds and Whey-Lasso, classification and regression tree (CART), boosted CART, bagging algorithm, meta-learner algorithm, quadratic discriminant analysis, linear discriminant analysis, boosting, Ada-boosting, genetic algorithm, rules based classifier, a super principal component, nearest neighbor classification and regression, Kth-nearest neighbor, clustering algorithm, dimension reduction methods, PCA, factor rotation, factor analysis, logistic regression, linear discriminant analysis, Eigengene linear discriminant analysis, support vector machine, recursive support vector machine, random forest, recursive partitioning tree, shrunken centroids, decision tree, neural network, Bayesian network, hidden Markov model, linear regression, forward linear stepwise regression, Lasso shrinkage and selection method, elastic net for regularization, variable selection for linear regression, general linear model net, Lasso regularized general linear model, elastic net-regularized general linear model, nonlinear regression or classification algorithm, kernel based machine algorithm, kernel density estimation, kernel partial least squares algorithm, kernel matching pursuit algorithm, kernel Fisher's discriminate analysis algorithm, kernel principal components analysis algorithm, sliced inverse regression, or a partial least square.

In some embodiments, the subject is a human subject diagnosed with an inflammatory disease. In some embodiments, the inflammatory disease is rheumatoid arthritis. In certain embodiments, the SDI score provides a quantitative measure of the rate of change in a clinical assessment selected from the group consisting of: a total Sharp score, an MRI score, and an ultrasound score.

Certain embodiments of the present teachings further comprise storing, in the storage memory, a second dataset associated with a second sample obtained from the subject, wherein the second sample is obtained from the subject later in time than the first sample; determining, by the computer processor, a second SDI score from the second dataset using the interpretation function; and, comparing the first SDI score and the second SDI score and determining a change in the SDI scores, wherein the change in SDI scores indicates a change in the rate of joint structural damage in the subject. In some embodiments, a therapy is administered to the subject after the first sample is obtained and before the second sample is obtained, and the change in the rate of joint structural damage is a quantitative measure of the subject's response to the therapy.

Certain embodiments of the present teachings further comprise quantifying the rate of change in joint structural damage in each of the subjects of a population, whereby an SDI score is determined for each of the subjects of the population, wherein each of the subjects of the population has a negative rheumatoid arthritis diagnosis; deriving an aggregate SDI score for the population from the SDI scores for each of the subjects of the population; comparing the first subject SDI score to the aggregate SDI score; and, determining a positive or negative rheumatoid arthritis diagnosis for the first subject based on the comparison of the first subject SDI score and the aggregate SDI score. In some embodiments, the first sample is obtained from the subject after the subject has received a therapy for rheumatoid arthritis, and the rate of change in joint structural damage is quantified in a second mammalian subject of the same species as the first subject, whereby an SDI score is determined for the second subject, and wherein the second subject has received the treatment for rheumatoid arthritis; the first subject's SDI score is compared to the second subject's SDI score; and the efficacy of the therapy is determined based on the score comparison. In some embodiments, a rheumatoid arthritis therapy is selected based on the SDI score.

In certain embodiments of the present teachings, the rate of change in joint structural damage is classified as low or high based on the SDI score.

In some embodiments, the performance of the predictive model used in quantifying rate of change in joint structural damage is characterized by an AUC ranging from 0.60 to 0.69. In other embodiments, the predictive model performance is characterized by an AUC ranging from 0.70 to 0.79. In other embodiments, the predictive model performance is characterized by an AUC ranging from 0.80 to 0.89. In other embodiments, the predictive model performance is characterized by an AUC ranging from 0.90 to 0.99.

In certain embodiments, the dataset associated with a sample from a subject comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA). In other embodiments, the at least two markers comprise one set of markers selected from the group consisting of TWOMRK Set Nos. 1 through 138 of FIG. 1.

In other embodiments, the at least two markers comprises at least three markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA). In other embodiments, the at least three markers comprise the markers in a set of markers selected from the group consisting of THREEMRK Set Nos. 1 through 482 of FIG. 2.

In other embodiments, the dataset comprises quantitative data for at least four markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA). In other embodiments, the at least four markers comprise the markers in a set of markers selected from the group consisting of FOURMRK Set Nos. 1 through 25 of FIG. 3.

In other embodiments, the dataset comprises quantitative data for at least five markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA). In other embodiments, the at least five markers comprise the markers in a set of markers selected from the group consisting of FIVEMRK Set Nos. 1 through 30 of FIG. 4.

In other embodiments, the dataset comprises quantitative data for at least six markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA). In other embodiments, the at least six markers comprise the markers in a set of markers selected from the group consisting of SIXMRK Set Nos. 1 through 36 of FIG. 5.

In certain embodiments, the quantitative data is based on an antibody binding assay.

Certain embodiments of the present teachings describe methods of comparing the aggregate joint structural damage of two or more populations of subjects by obtaining the SDI scores for the subjects of the two or more populations using the interpretation function as described herein; using the SDI scores obtained for the subjects of each of the two or more populations to derive an aggregate value for each population; and, comparing the aggregate values between the two or more populations to determine the aggregate response of each population to a therapy.

In some embodiments, the quantitative measure of the rate of change in joint structural damage is predictive of whether a subject is in clinical remission or in joint structural damage remission.

Some embodiments of the present teachings describe a computer-implemented method for quantifying the cumulative joint structural damage in a mammalian subject, comprising storing, in a storage memory, a first dataset associated with a first sample obtained from the subject, wherein the dataset comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); and, determining, by a computer processor, a first SDI score from the first dataset using an interpretation function, wherein the first SDI score provides a quantitative measure of the cumulative joint structural damage in the subject.

In addition to the foregoing, the present teachings comprise variations that encompass systems for carrying out any of the computer-implemented embodiments described above. As an example, certain embodiments of the present teachings comprise a system for quantifying RA disease progression in a mammalian subject, the system comprising: an input device for receiving a dataset associated with a sample obtained from the subject, wherein the dataset comprises quantitative data for at least two markers selected from the SDMRK group described above, and a processor communicatively coupled to the input device for determining an SDI score with an interpretation function, wherein the SDI score provides a quantitative measure of RA disease progression in the subject, etc.

Certain embodiments of the present teachings comprise a computer-readable storage medium storing computer-executable program code, the program code comprising program code for obtaining a dataset associated with a sample obtained from the subject, wherein the dataset comprises quantitative data for at least two markers selected from the SDMRK group; and program code for determining an SDI score with an interpretation function wherein the SDI score provides a quantitative measure of inflammatory disease progression in the subject. In other embodiments, the interpretation function of the computer-readable storage medium is based on a predictive model.

Other embodiments of the present teachings encompass variations that comprise quantifying inflammatory disease progression in a subject by methods comprising contacting the subject sample with reagents to form complexes, and detecting those complexes to obtain a dataset associated with the sample, wherein the dataset comprises quantitative data for markers of the SDMRK group, an SDI score is determined from the dataset via an interpretation function, and the SDI score provides a quantitative measure of inflammatory disease progression in the subject.

In one embodiment of the present teachings a kit is provided for use in quantifying inflammatory disease progression in a mammalian subject, comprising a set of reagents comprising a plurality of reagents for determining from a sample obtained from the subject quantitative data for at least two markers selected from the SDMRK group and instructions for using the plurality of reagents to determine quantitative data from the sample. In certain embodiments the instructions in the kit comprise instructions for conducting an antibody binding assay. In other embodiments, the kit further comprises instructions for using an interpretation function with the quantitative data to determine an SDI score wherein the SDI score provides a quantitative measure of inflammatory disease progression in the subject.

### BRIEF DESCRIPTION OF THE DRAWINGS

The skilled artisan will understand that the drawings, described below, are for illustration purposes only. The drawings are not intended to limit the scope of the present teachings in any way.

FIG. 1 depicts a list of two-biomarker (TWOMRK) sets or panels. Predictive models were built, as described in certain embodiments of the present teachings, to estimate the rate of structural damage in subjects. Biomarker concentrations obtained at one timepoint were used to predict the change of total Van der Heijde Sharp Scores (DSS) that would occur over the next 12 months. The combinations of different biomarkers that provided model performance with Area under the ROC Curve (AUROC) of 0.6 or greater in 100 cross validations are reported in this figure. BeSt and SONORA were the two datasets used to carry out this procedure.

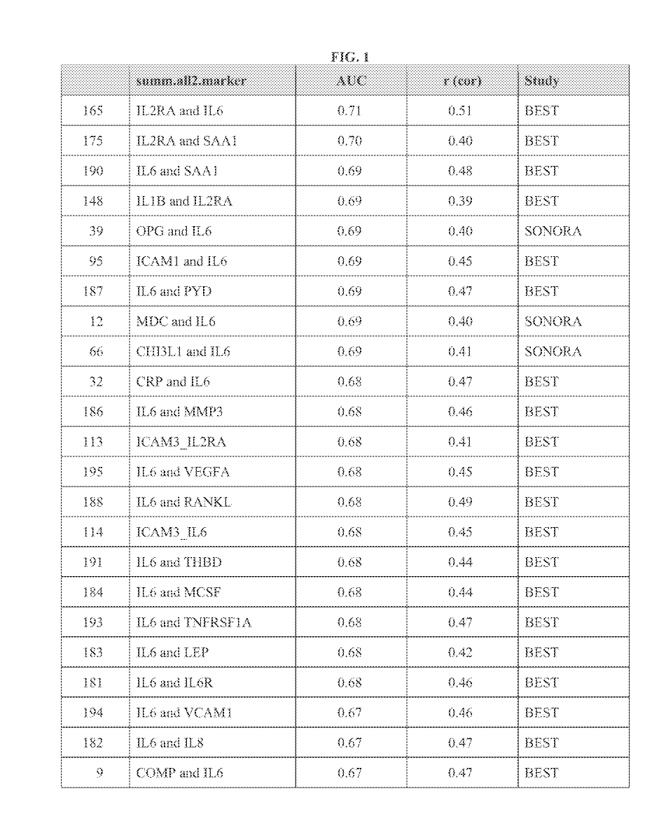

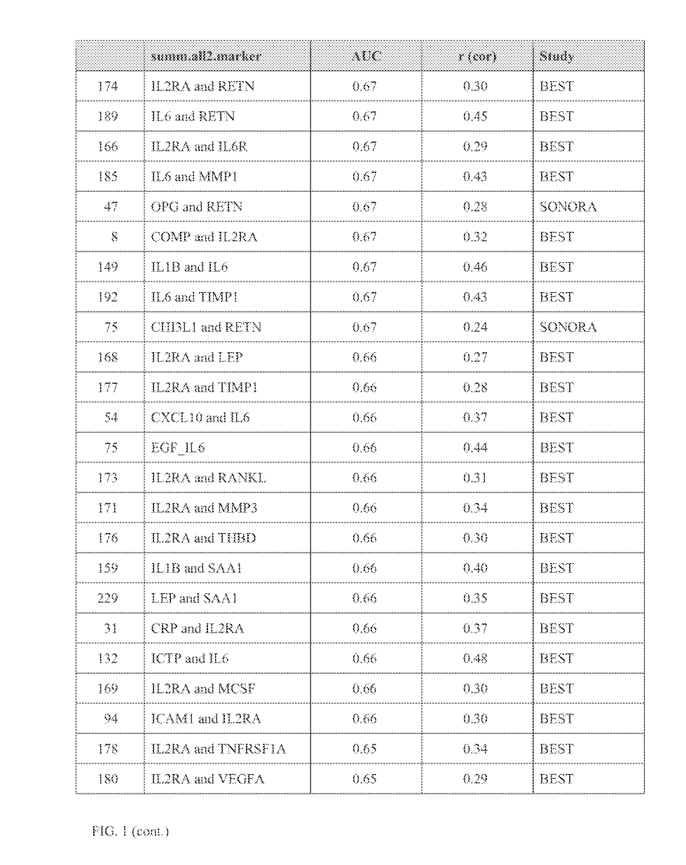

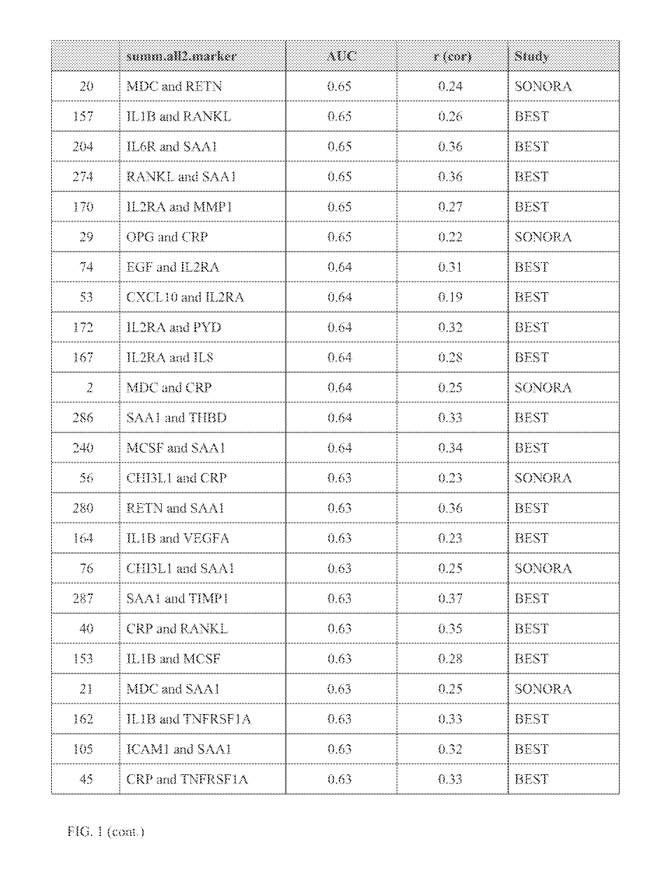

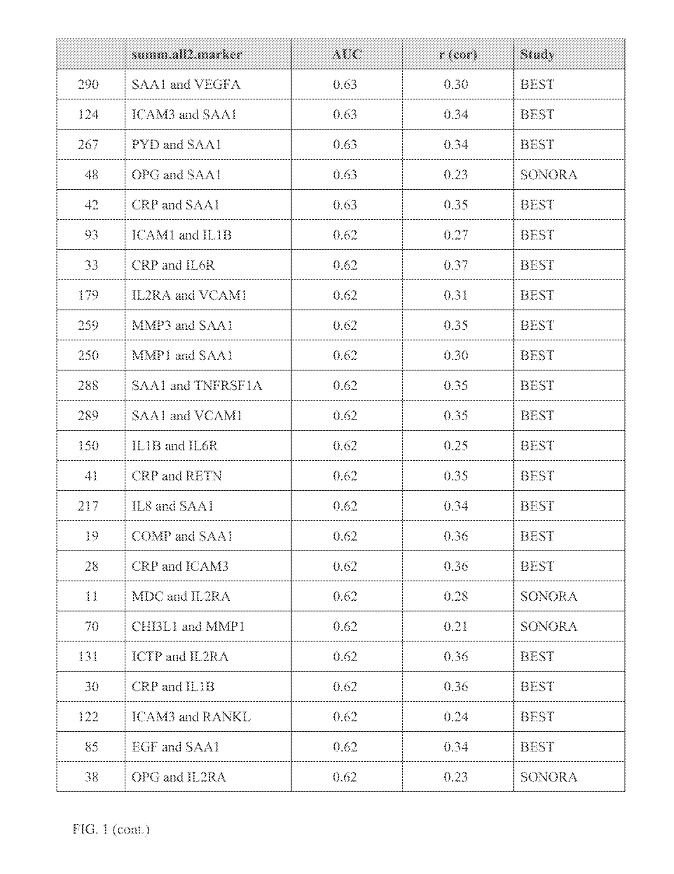

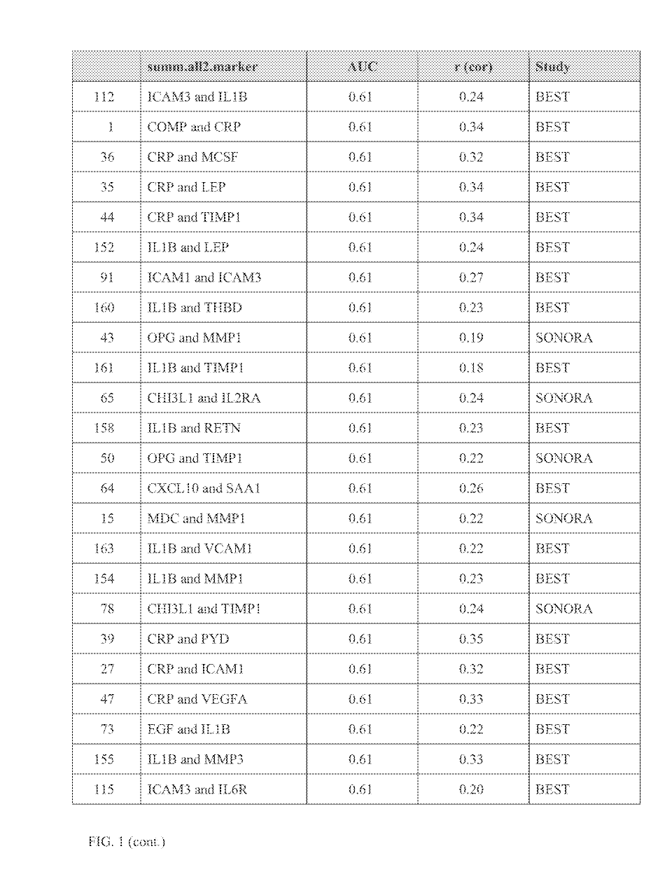

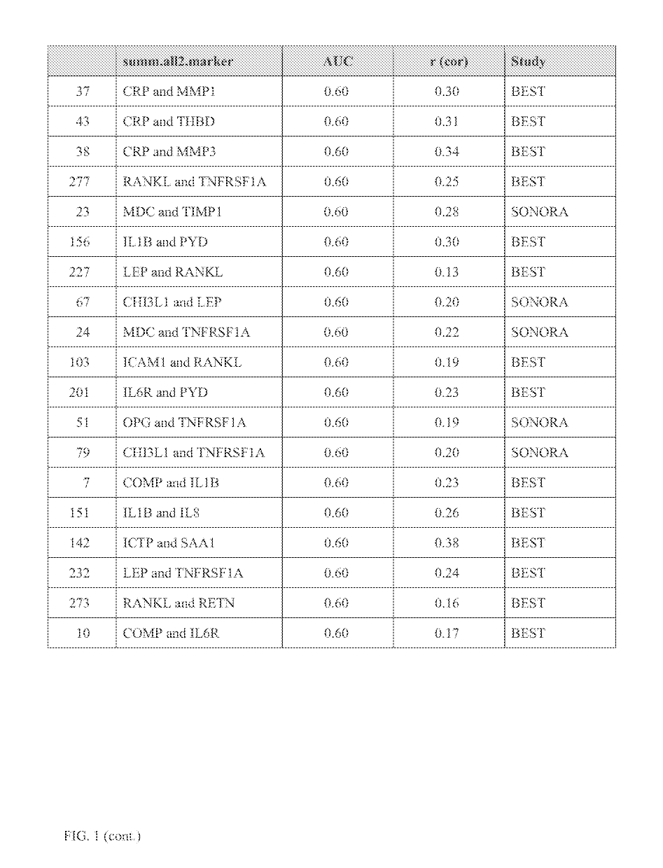

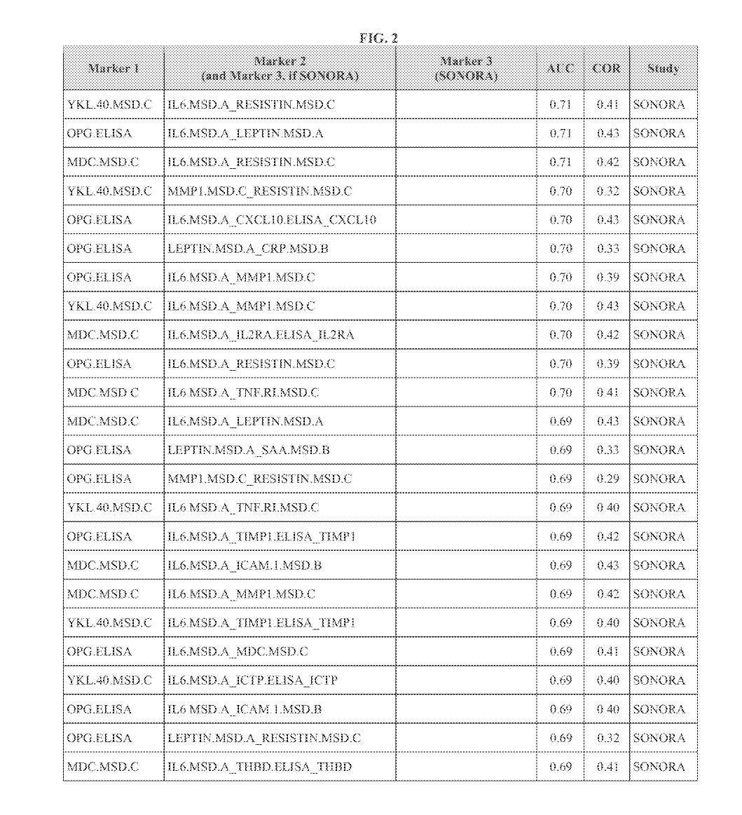

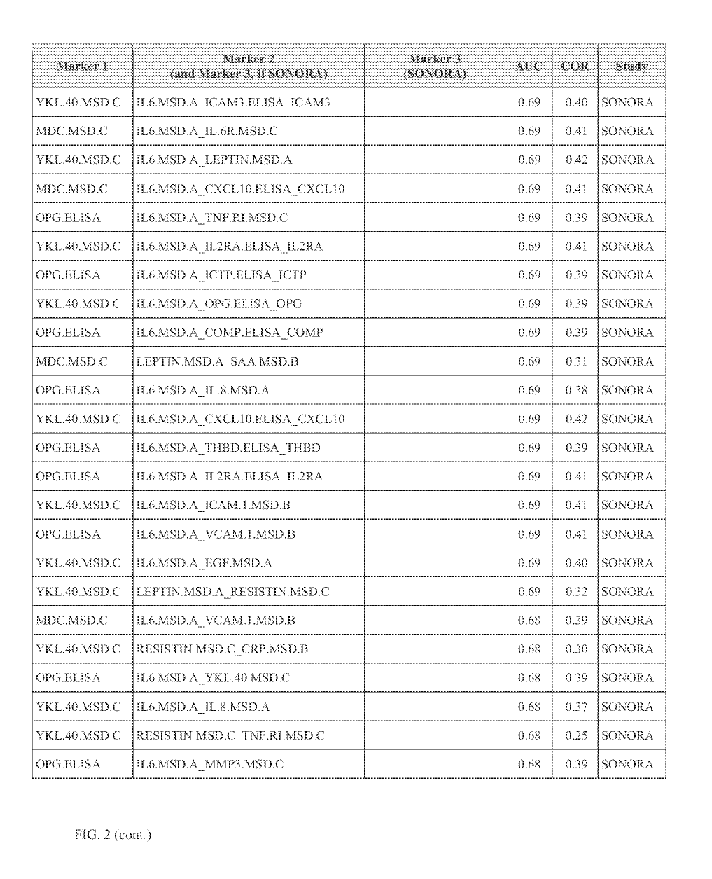

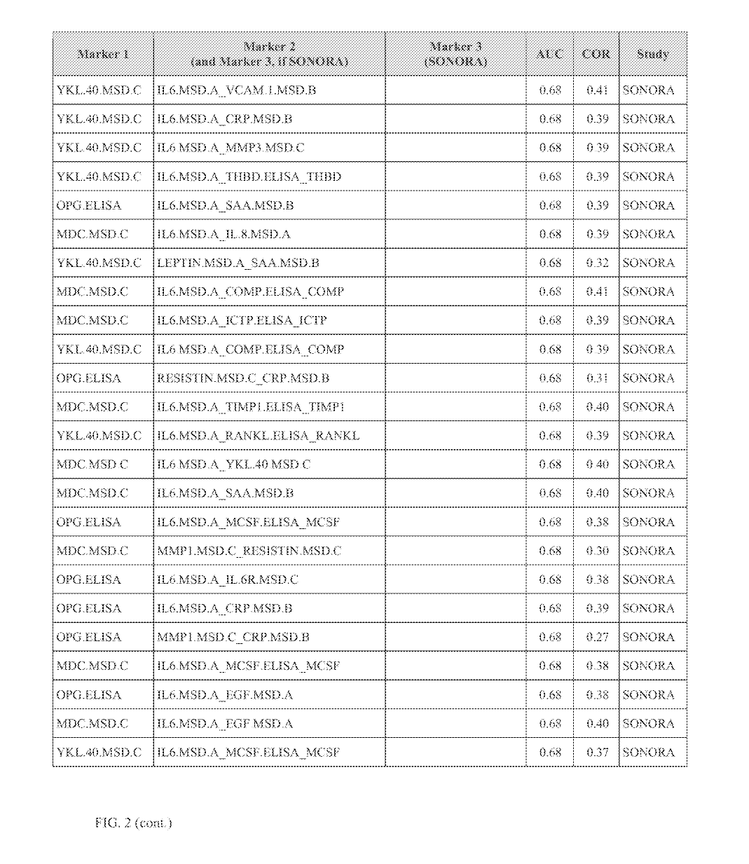

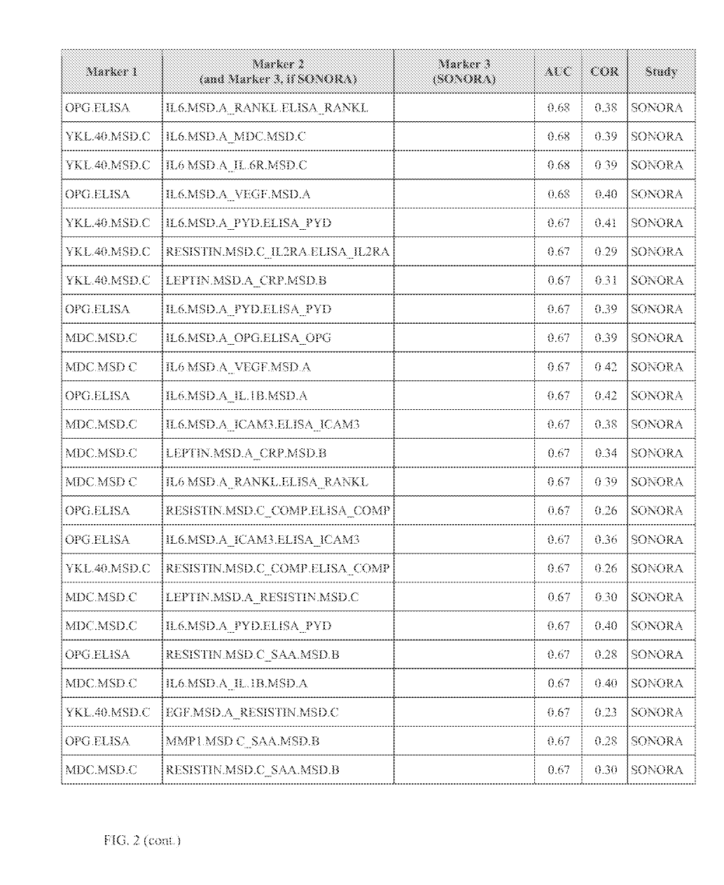

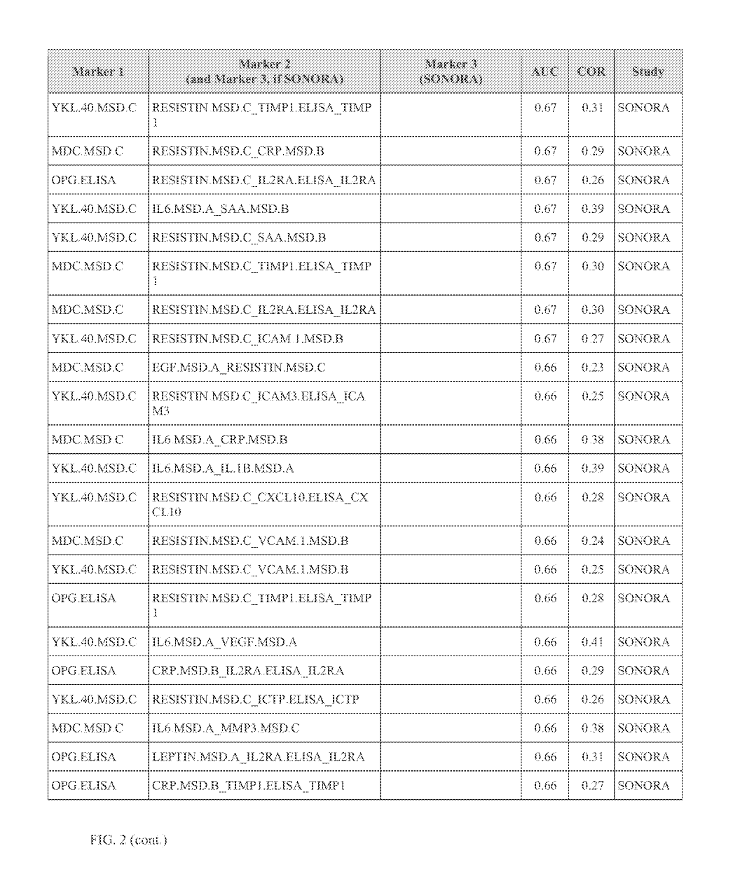

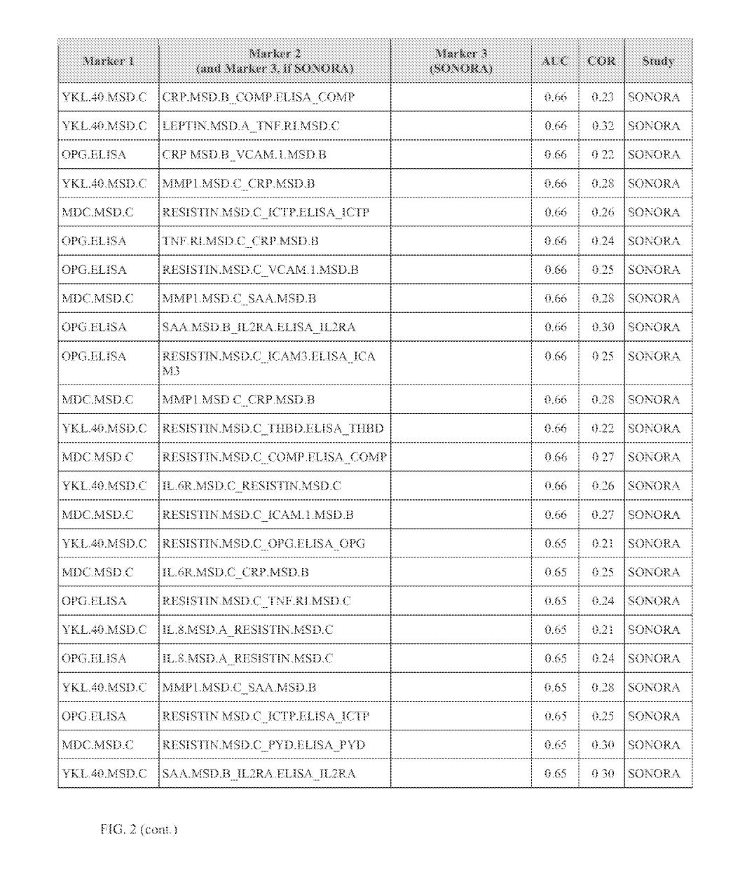

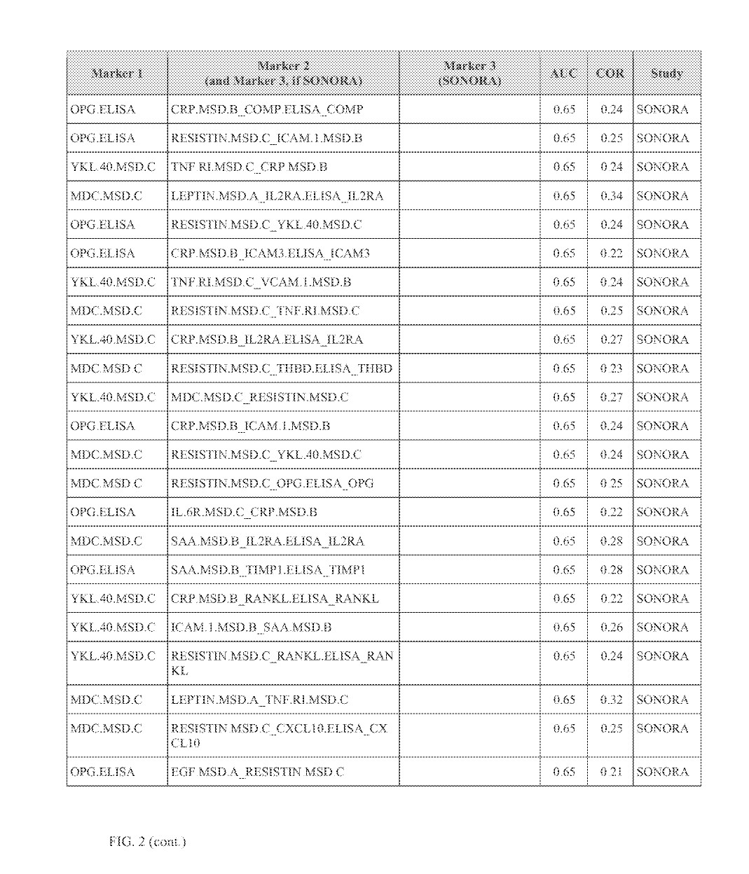

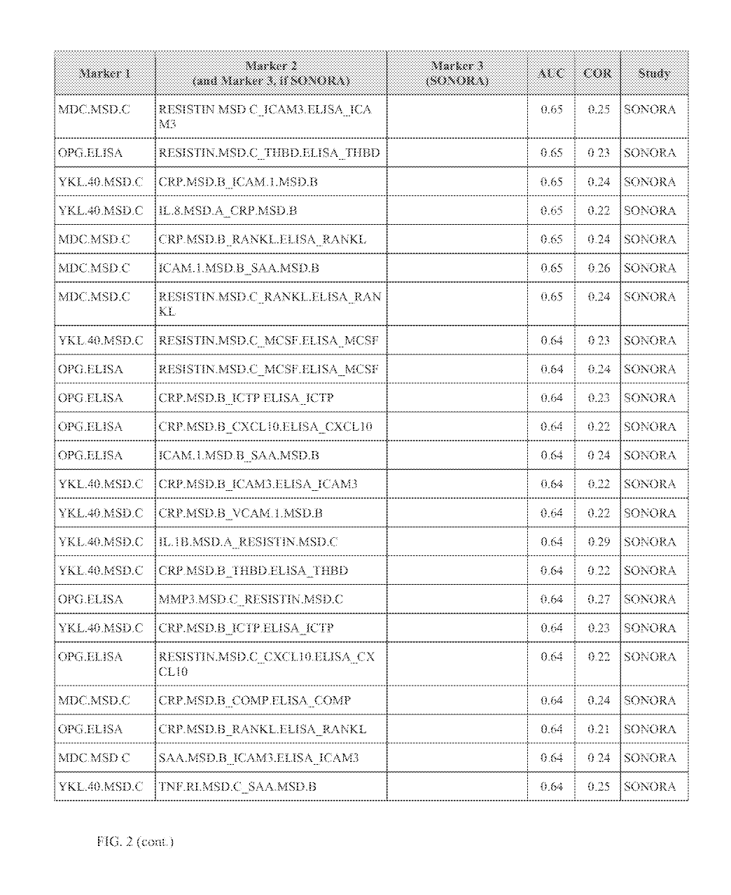

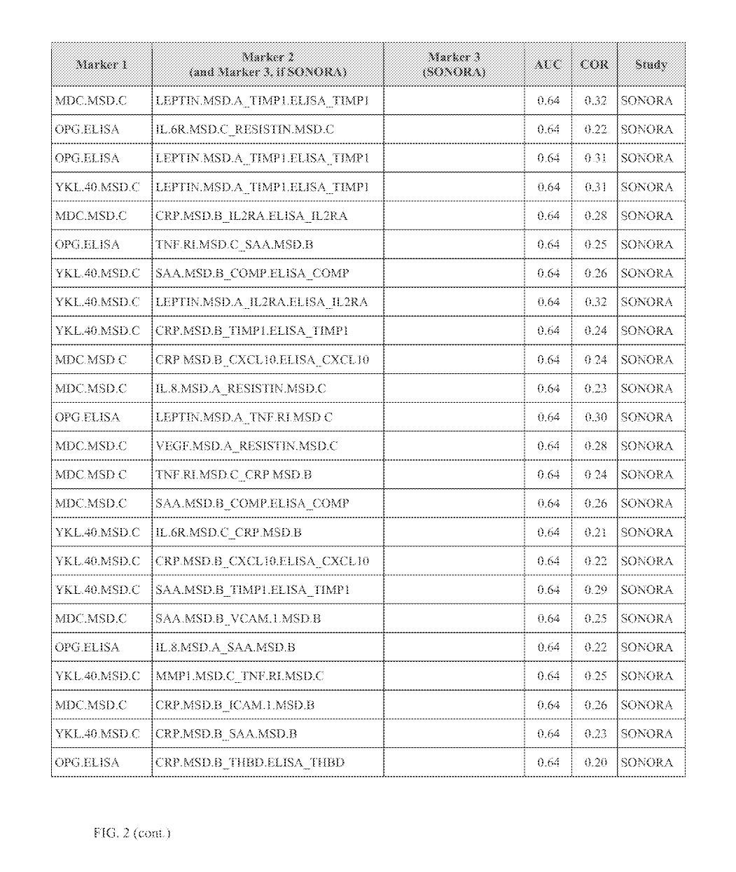

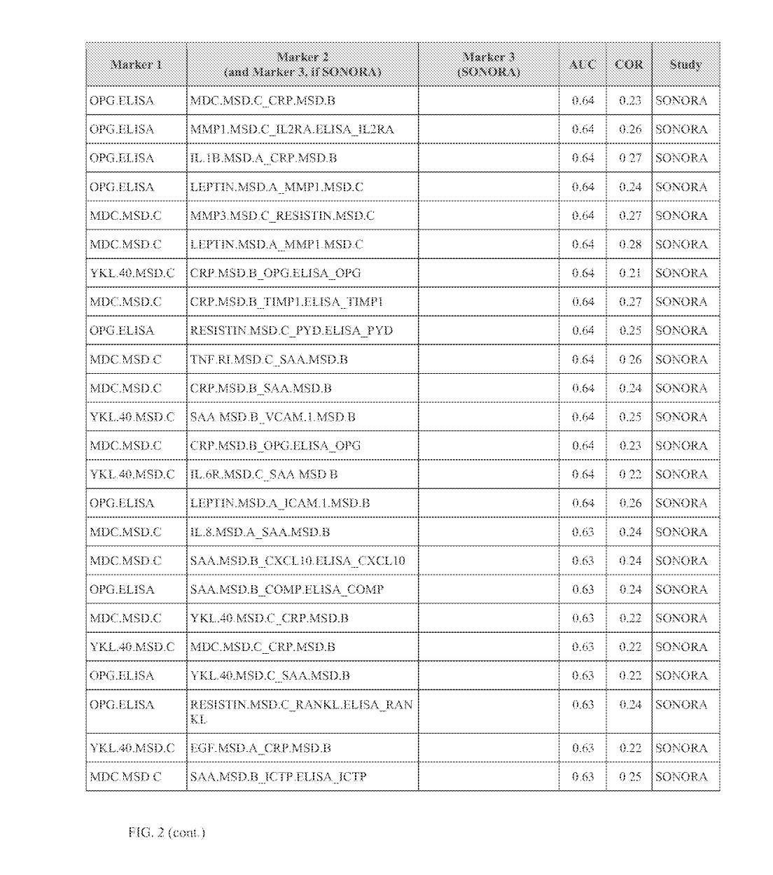

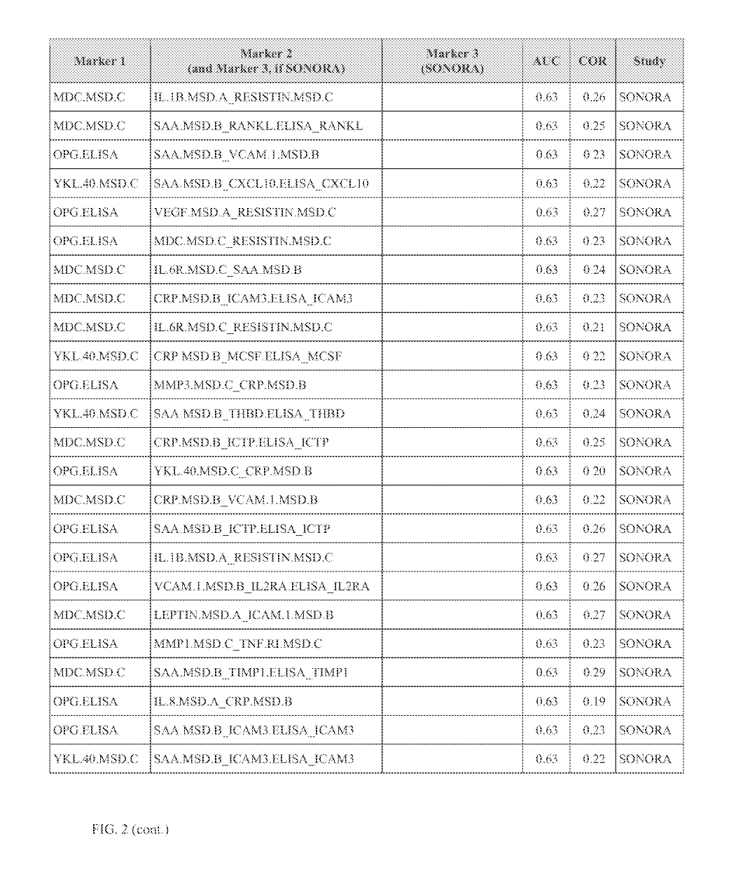

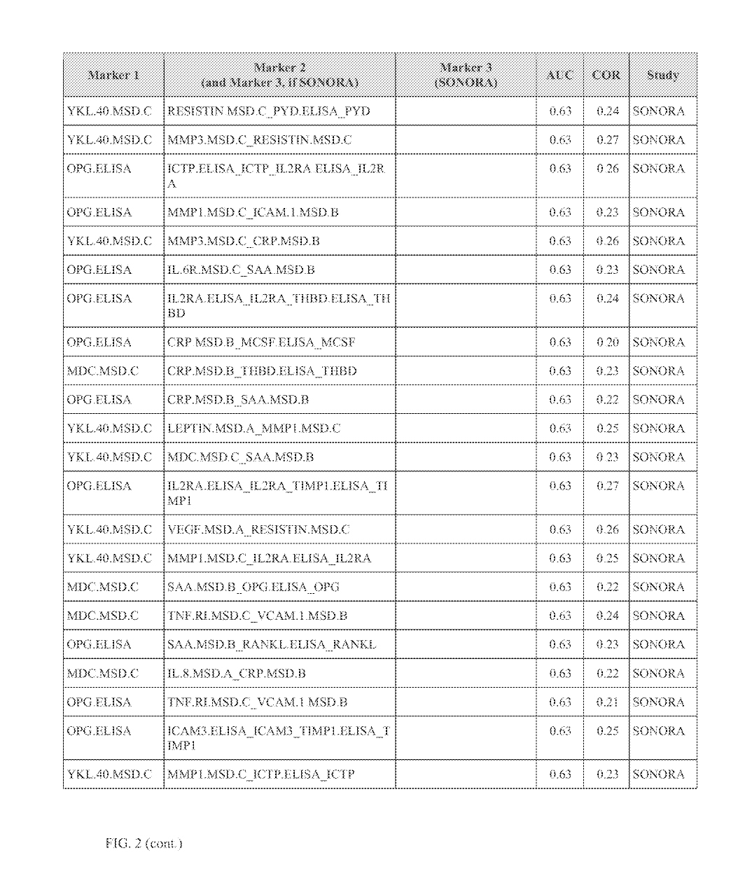

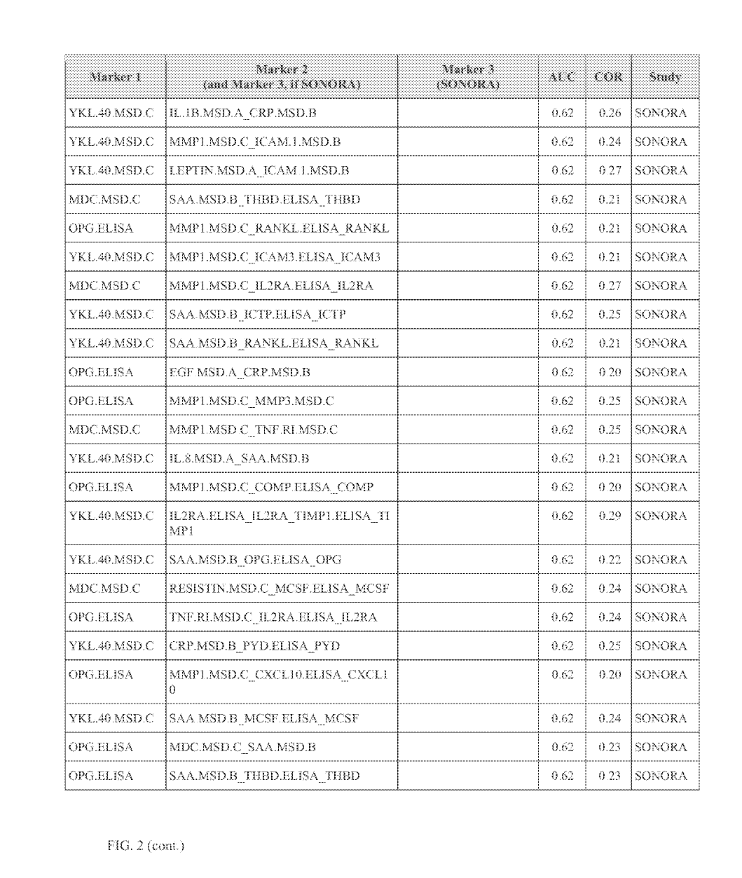

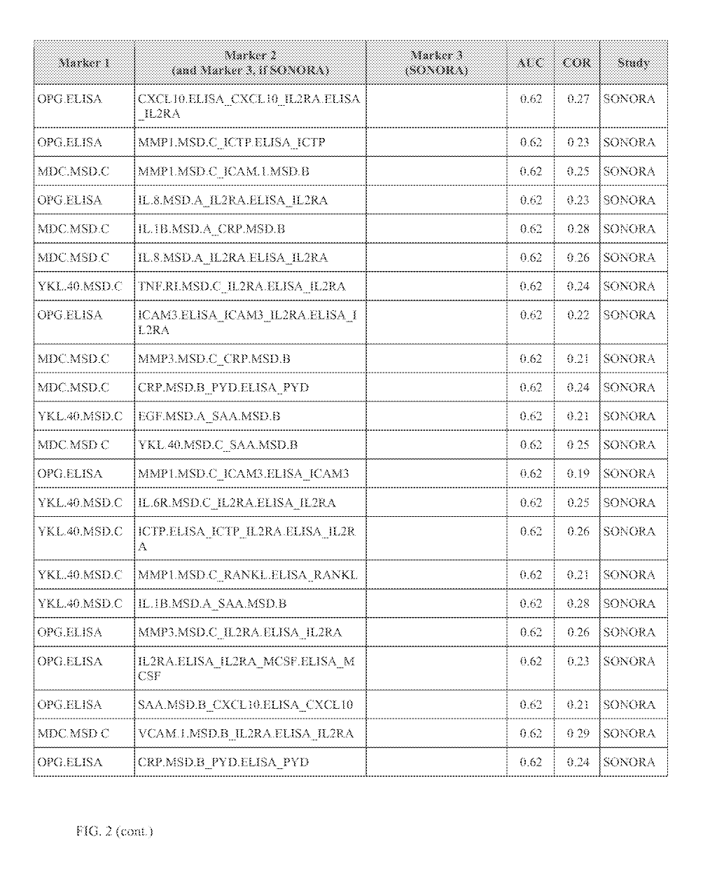

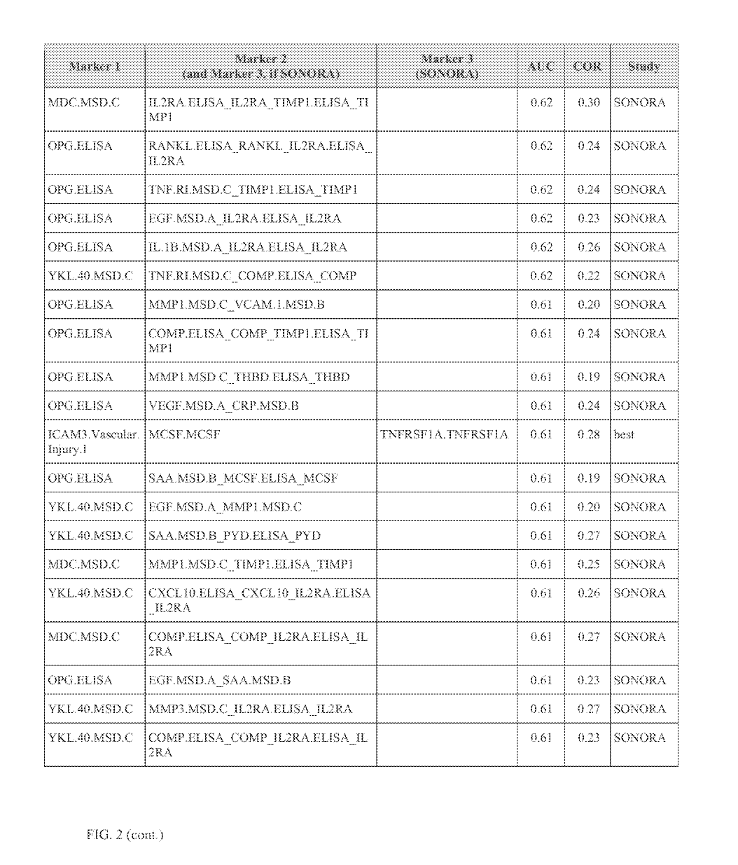

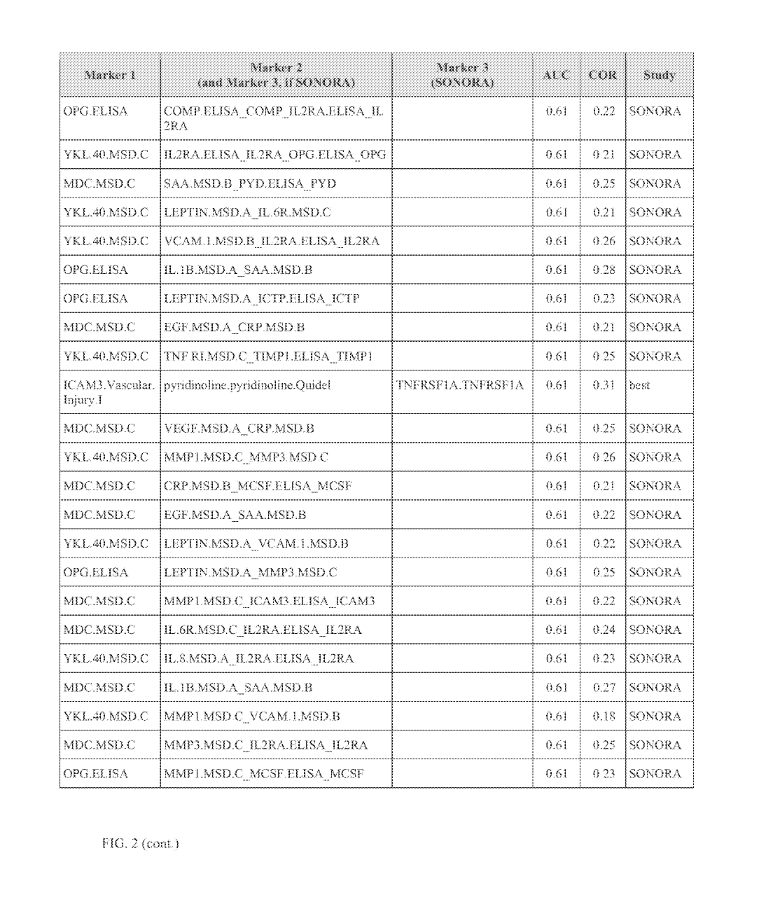

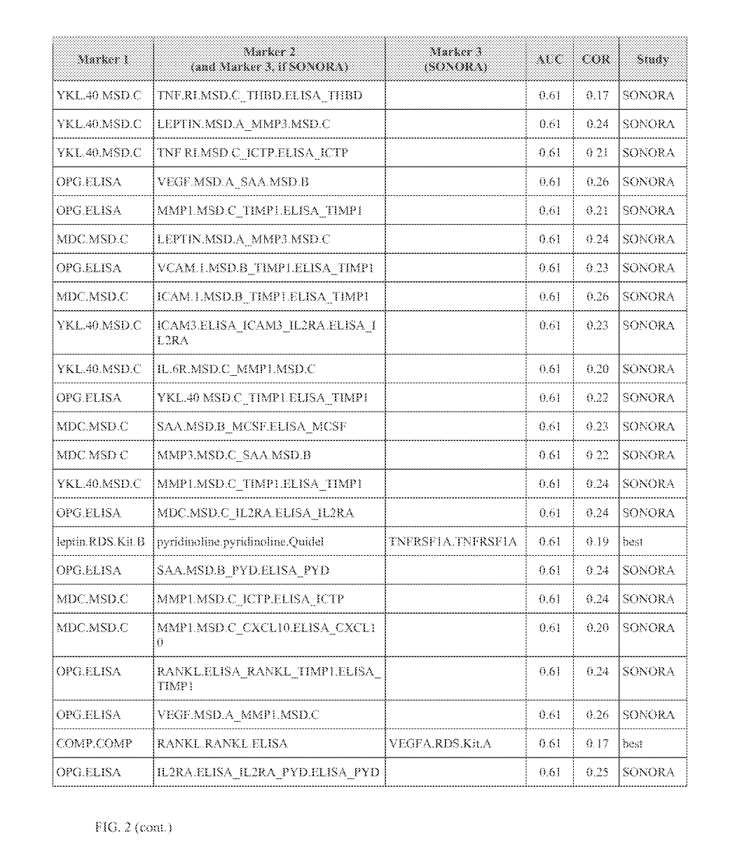

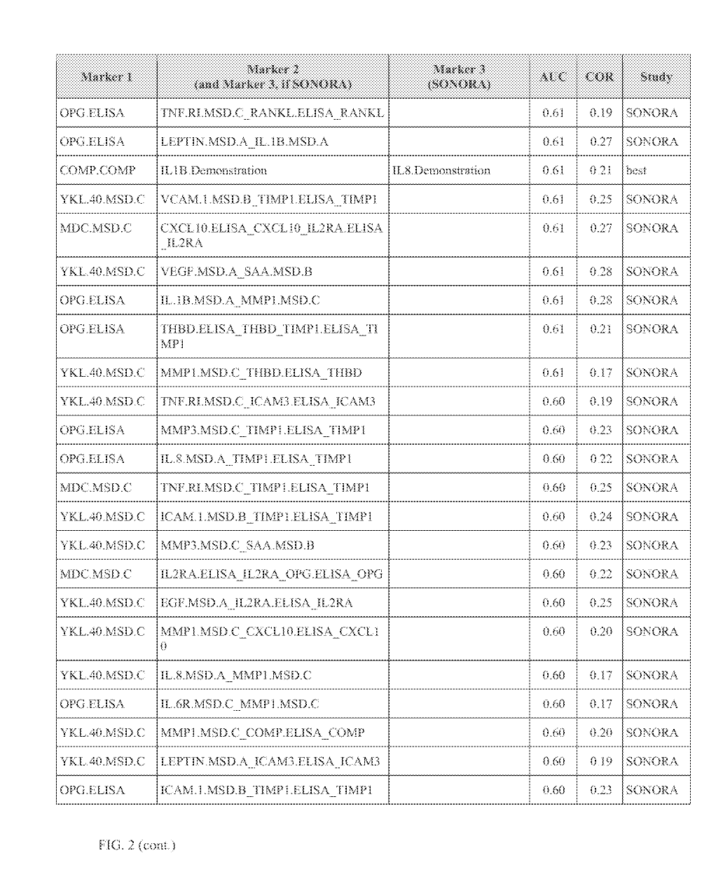

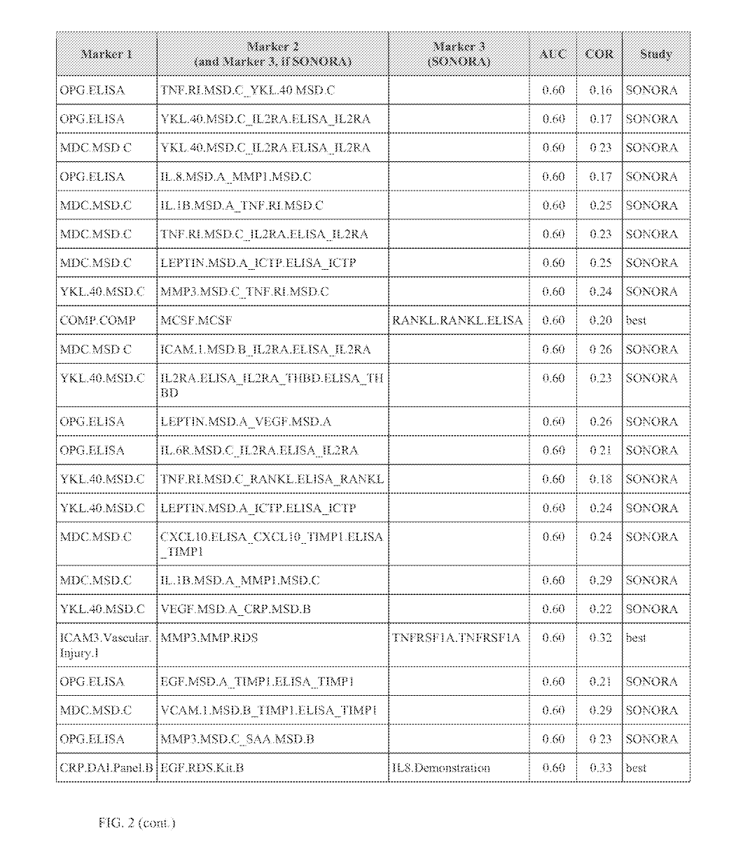

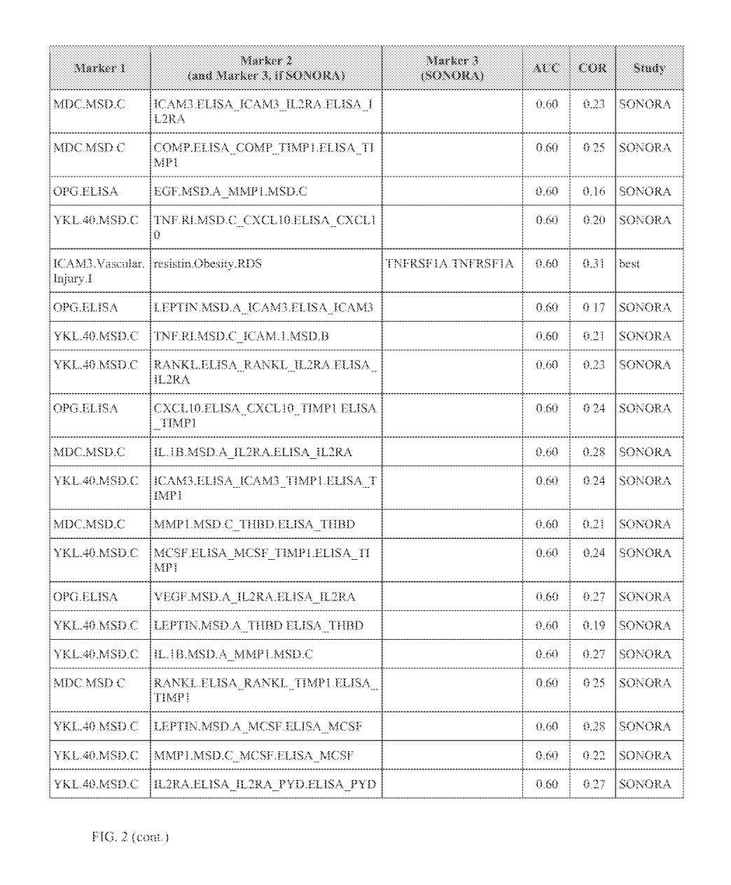

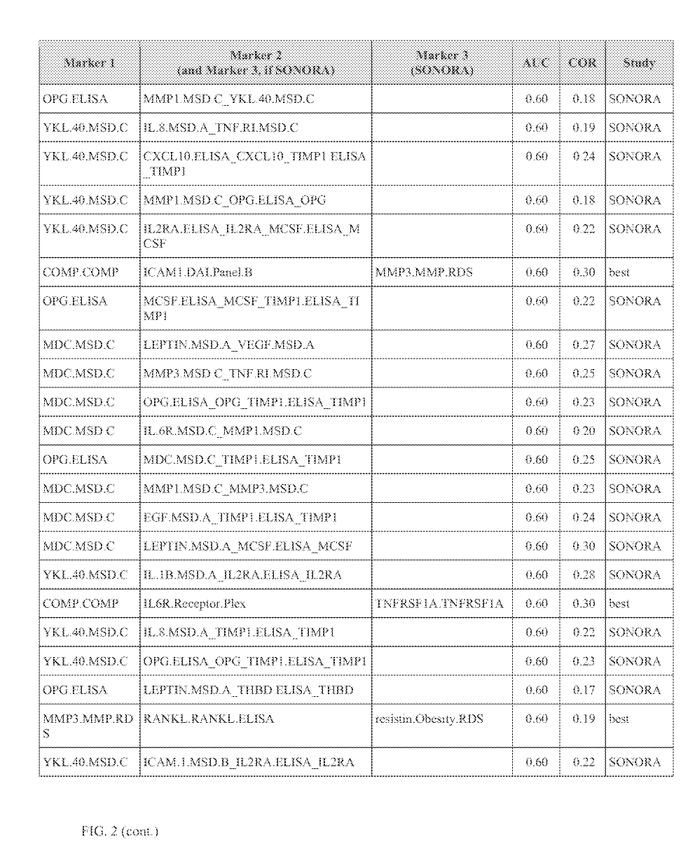

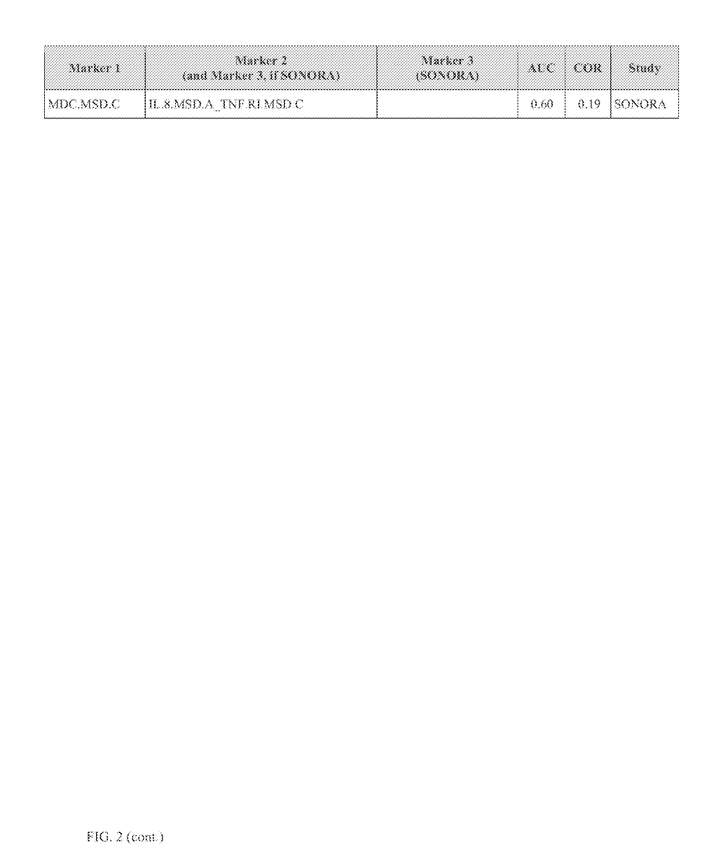

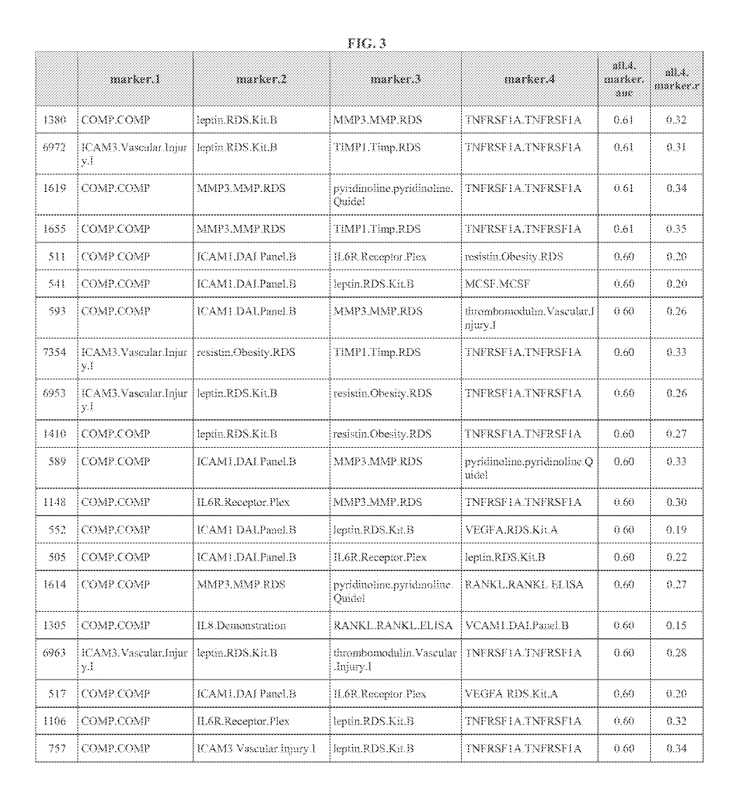

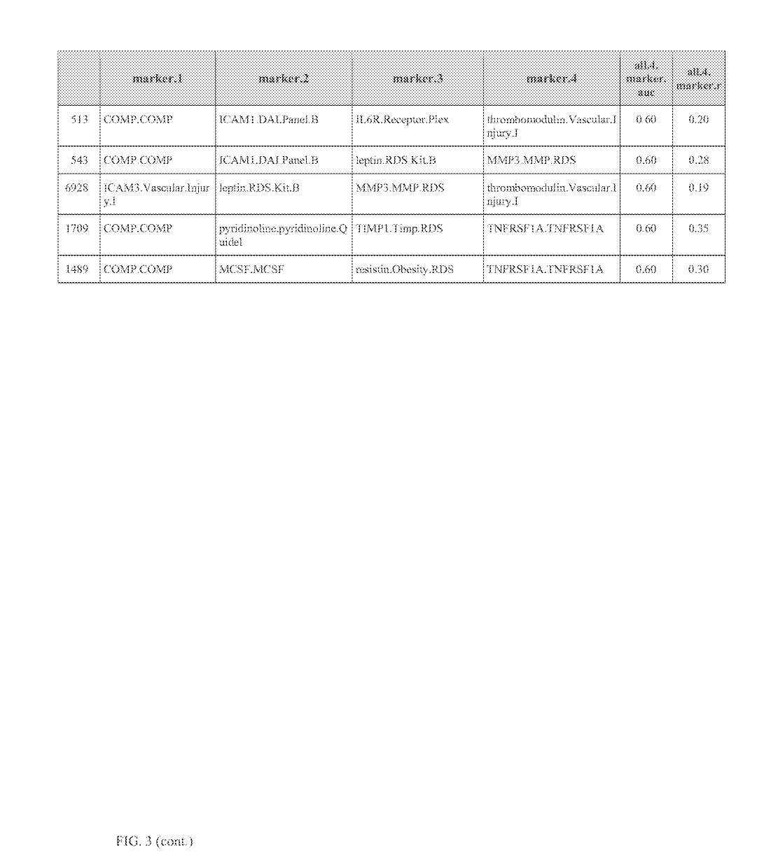

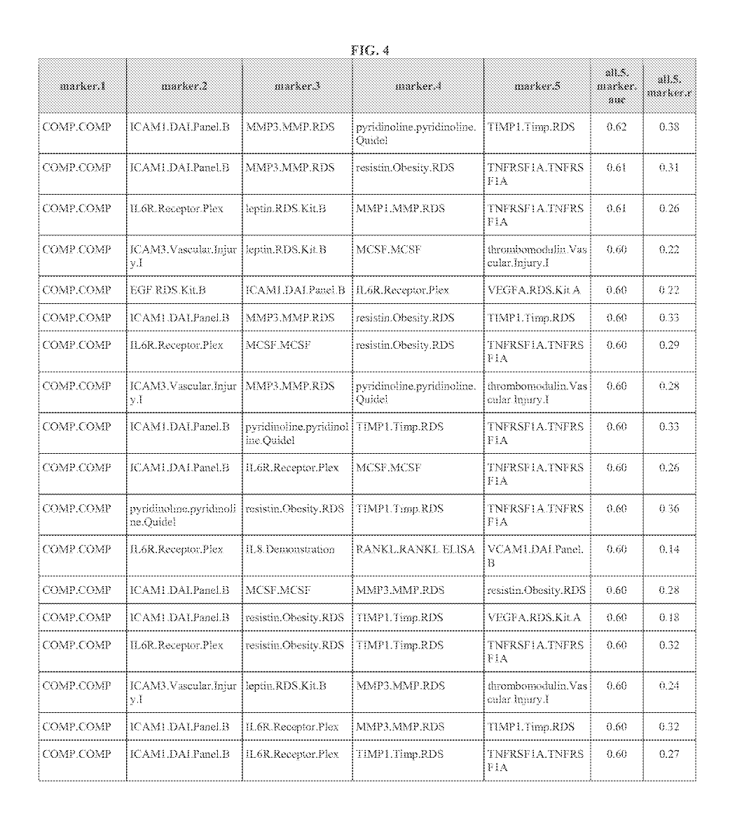

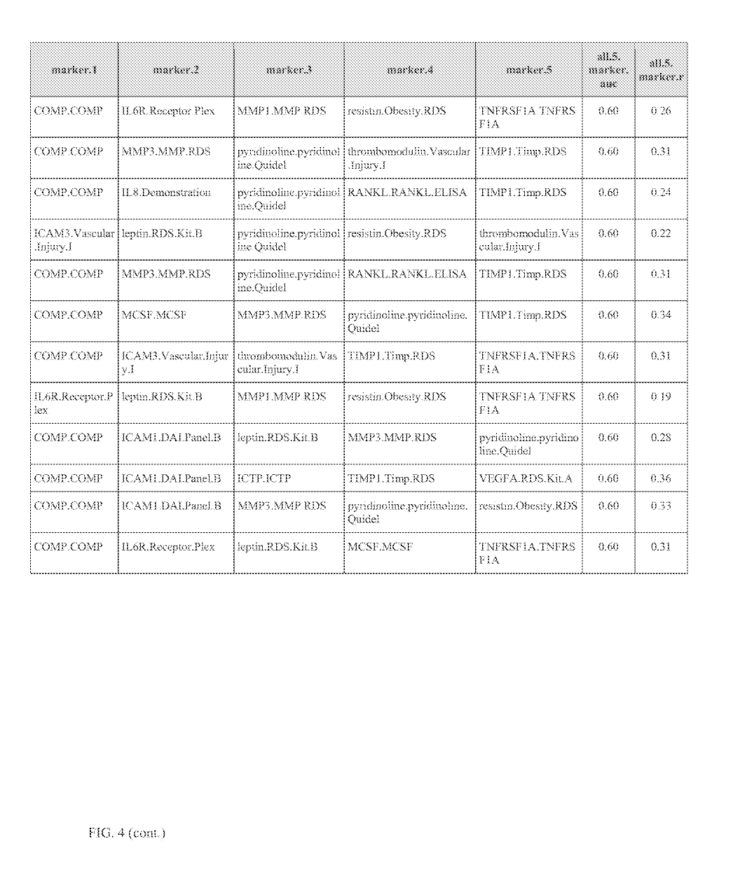

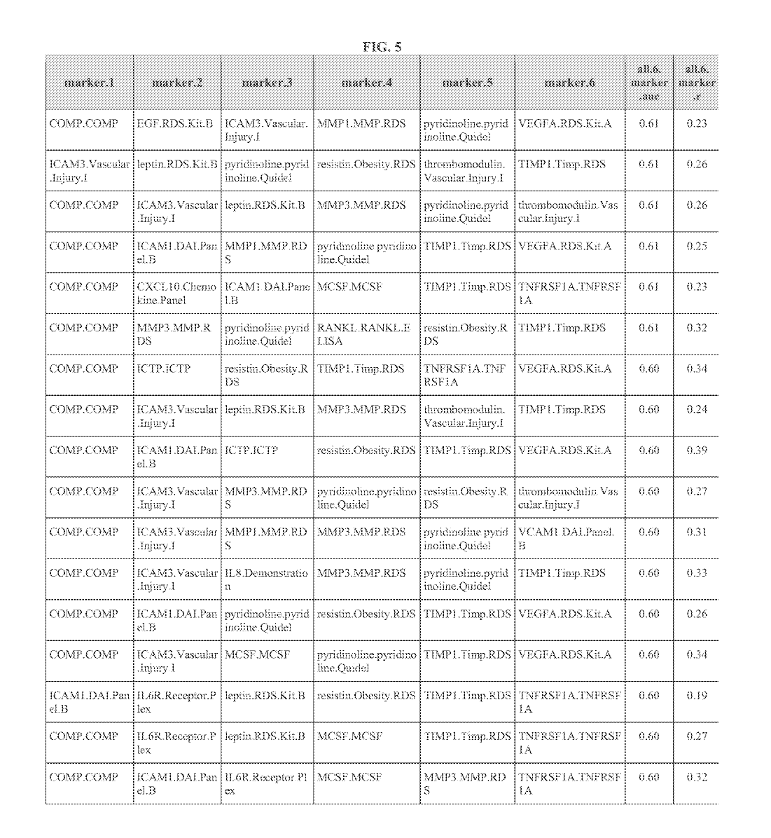

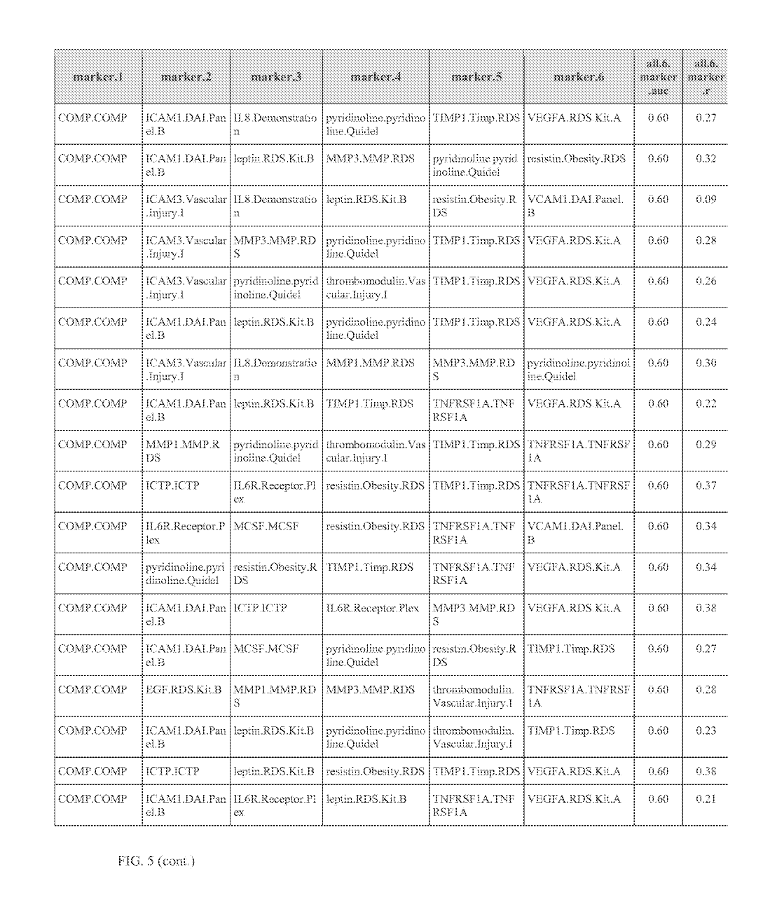

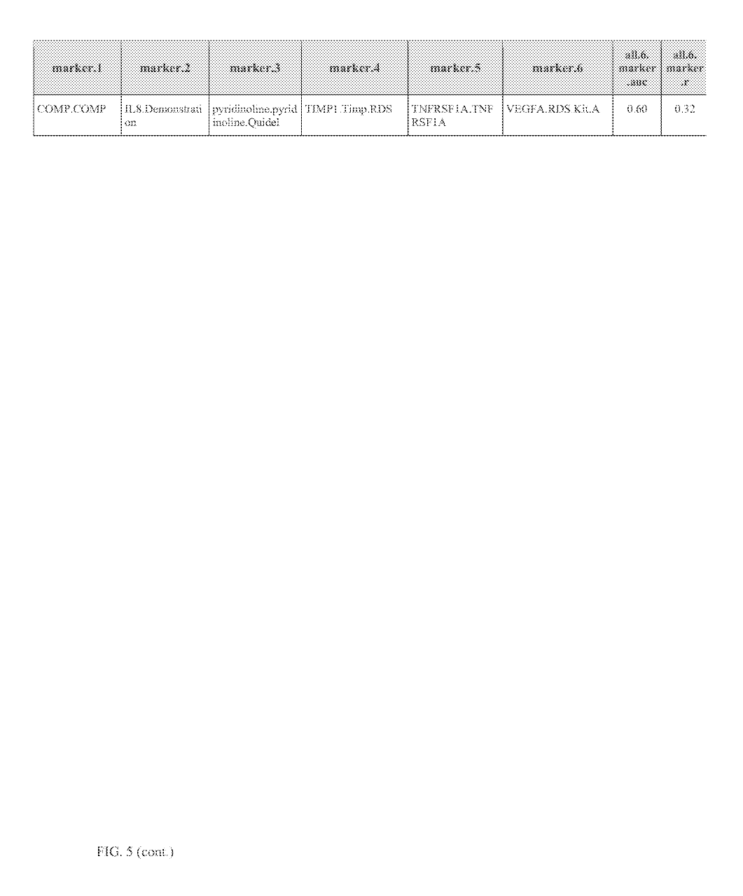

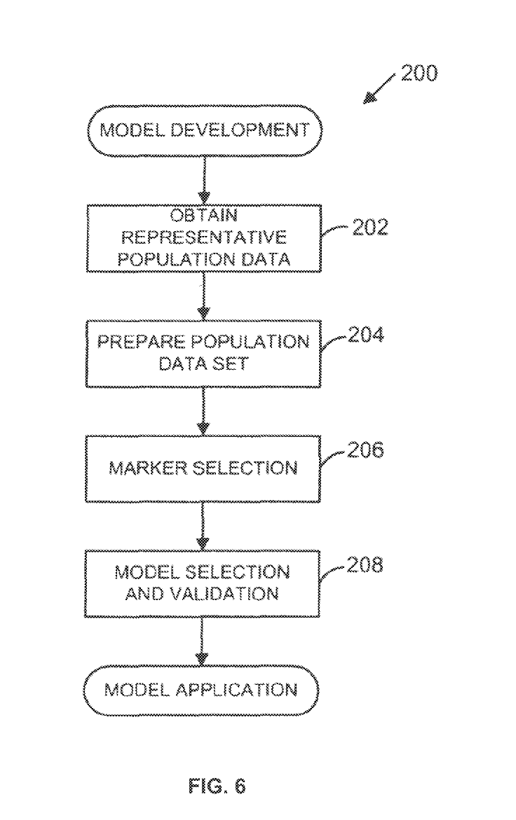

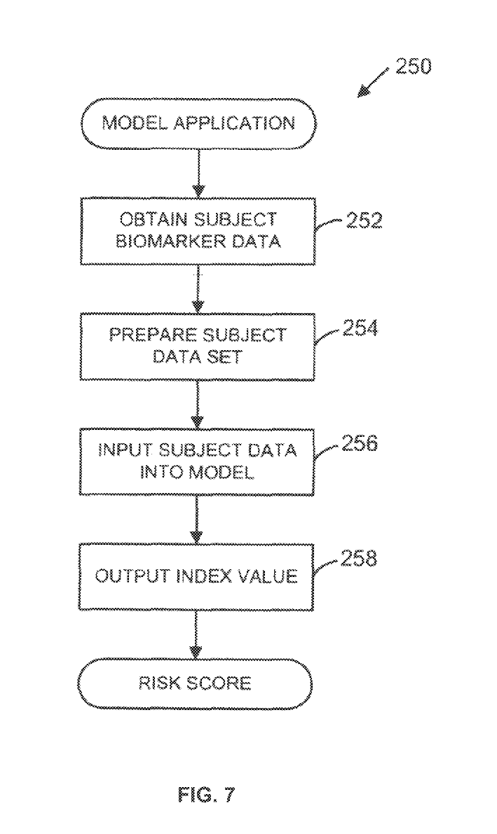

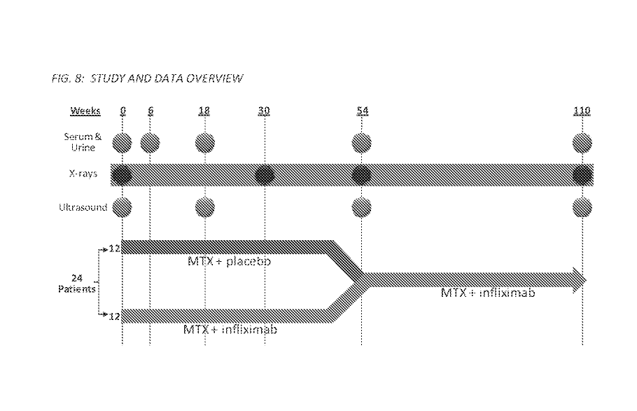

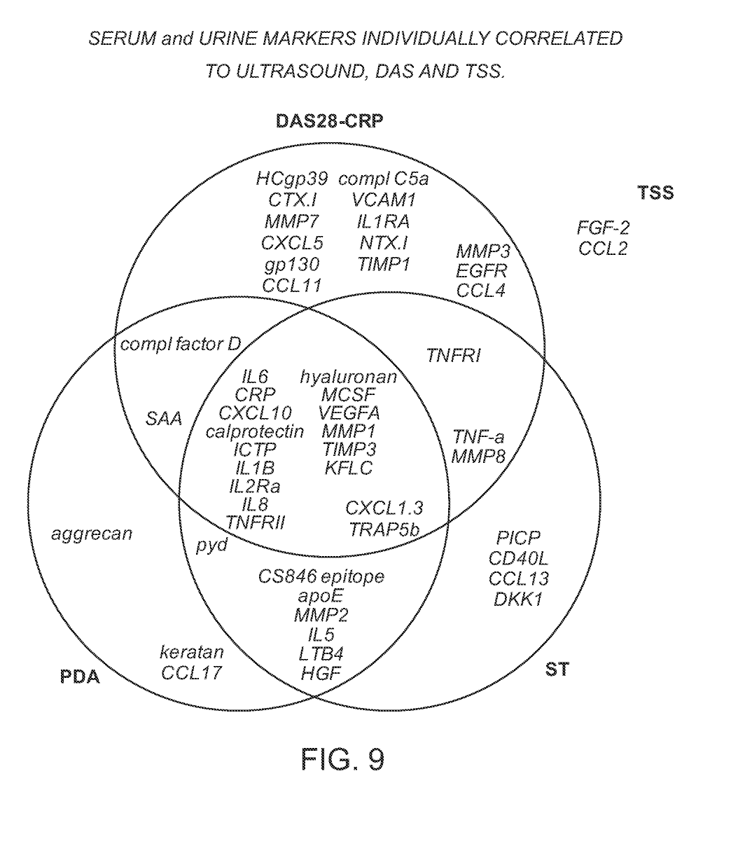

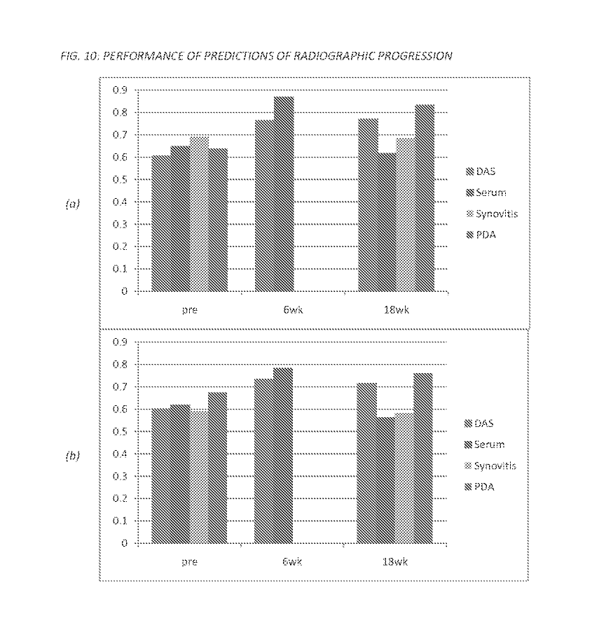

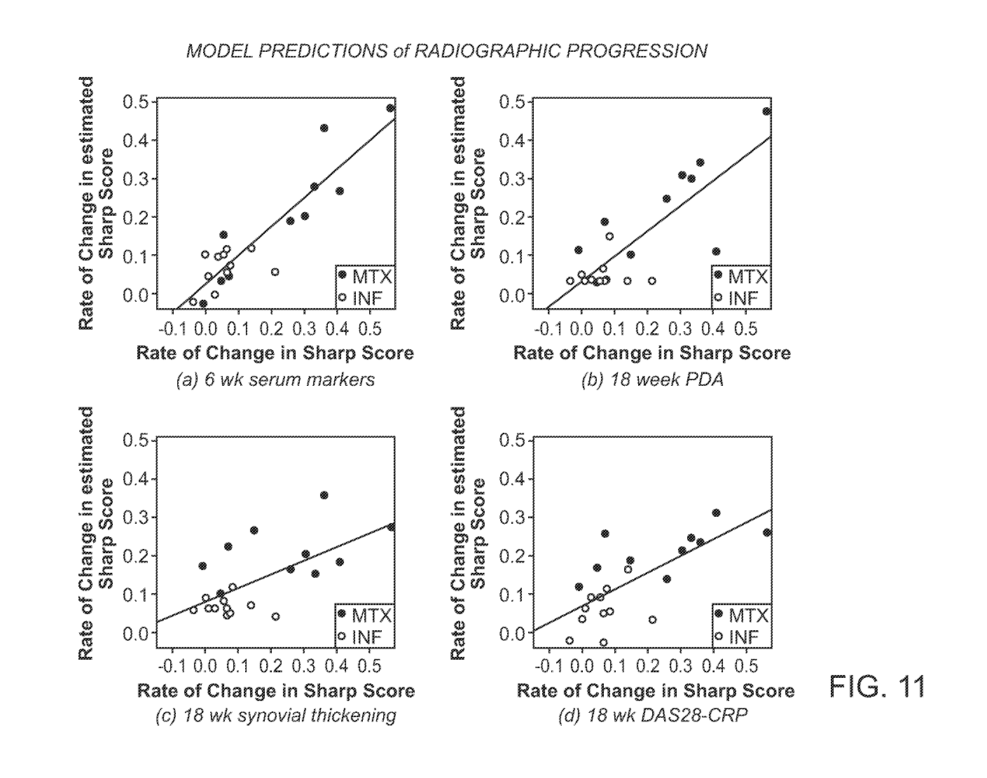

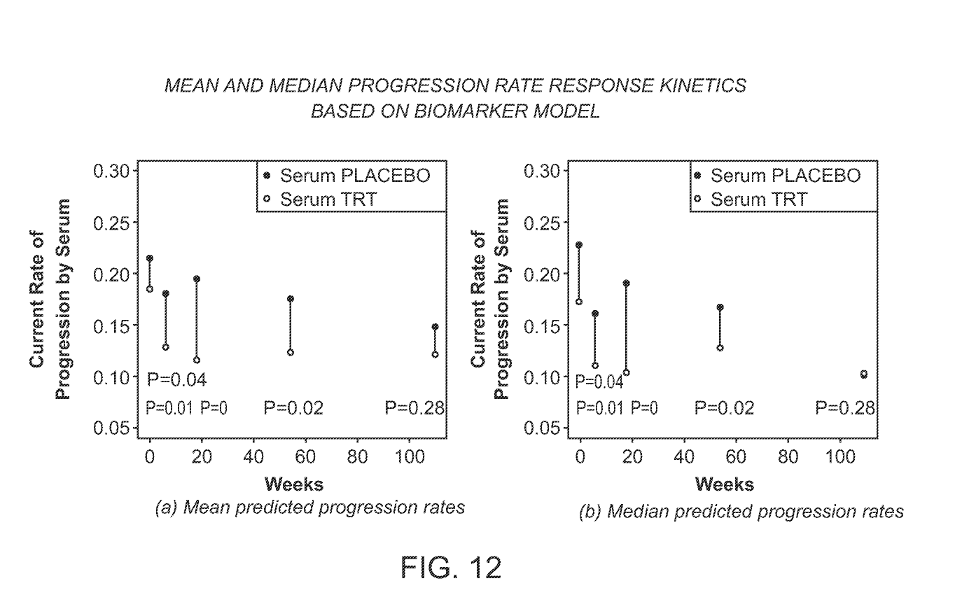

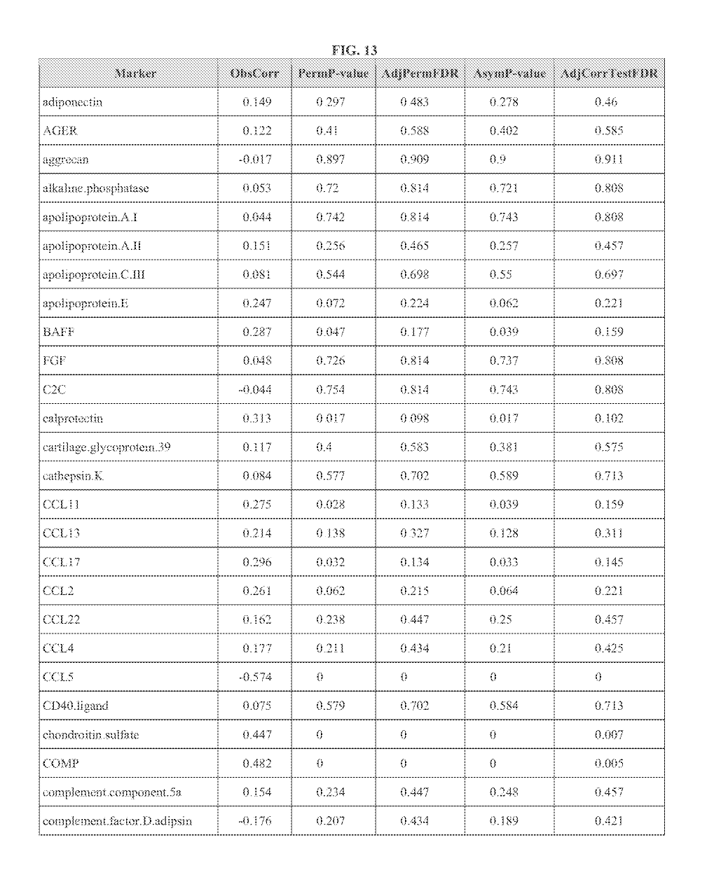

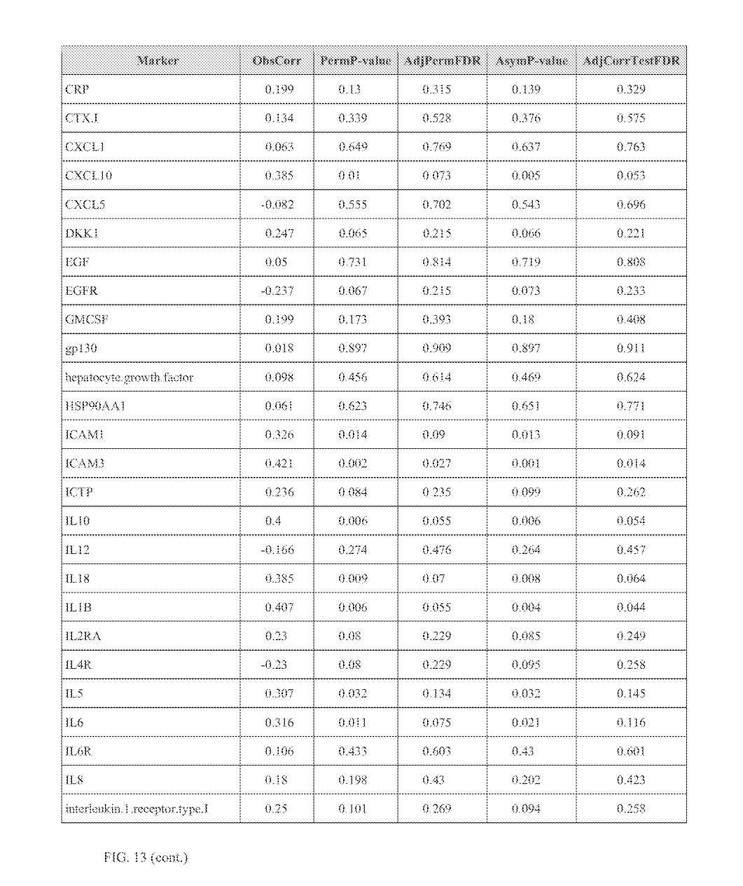

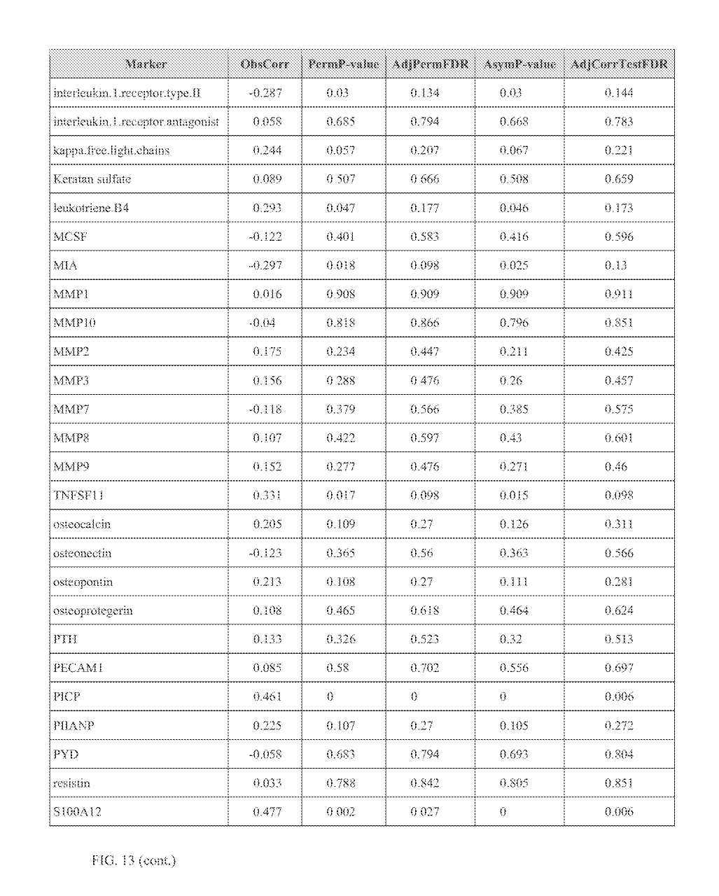

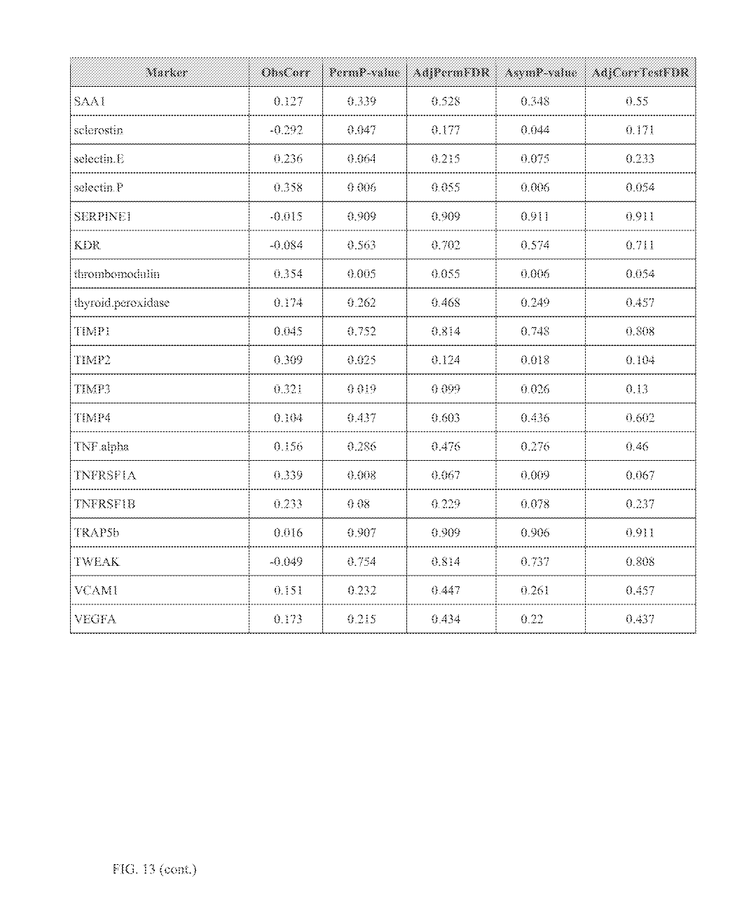

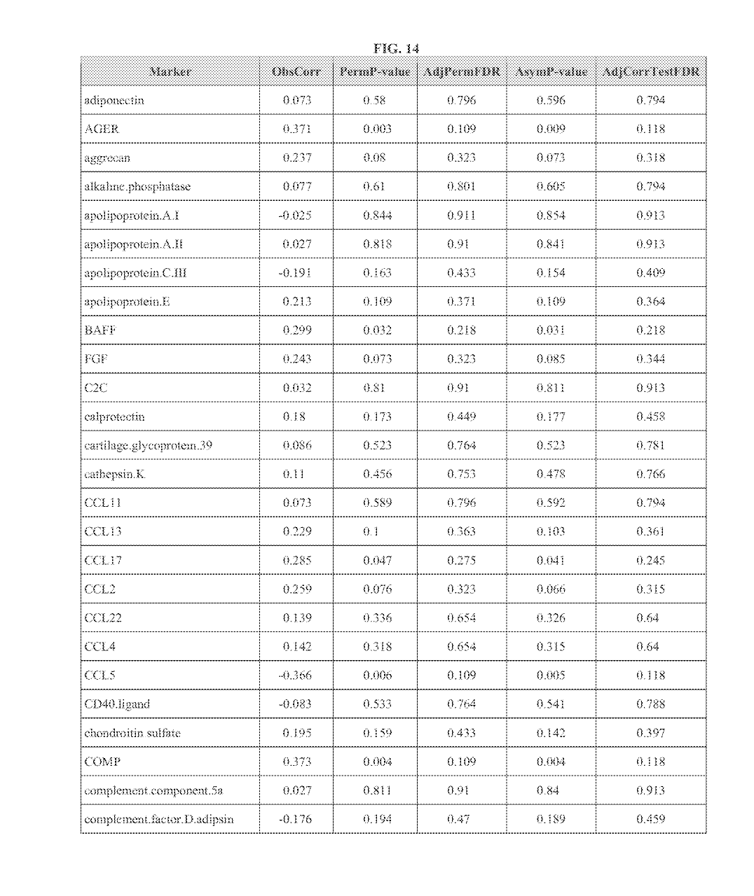

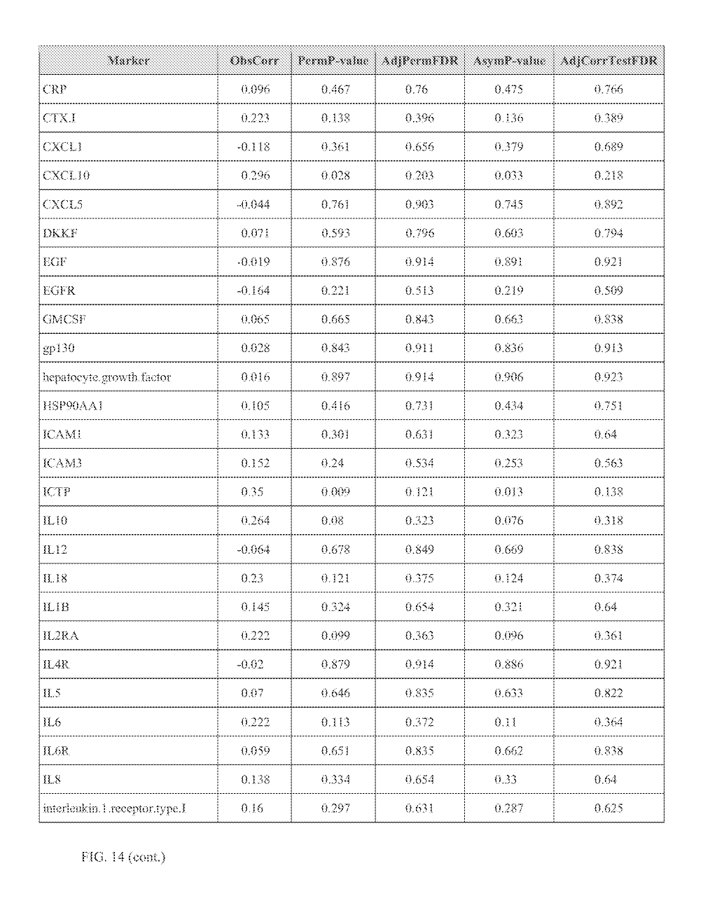

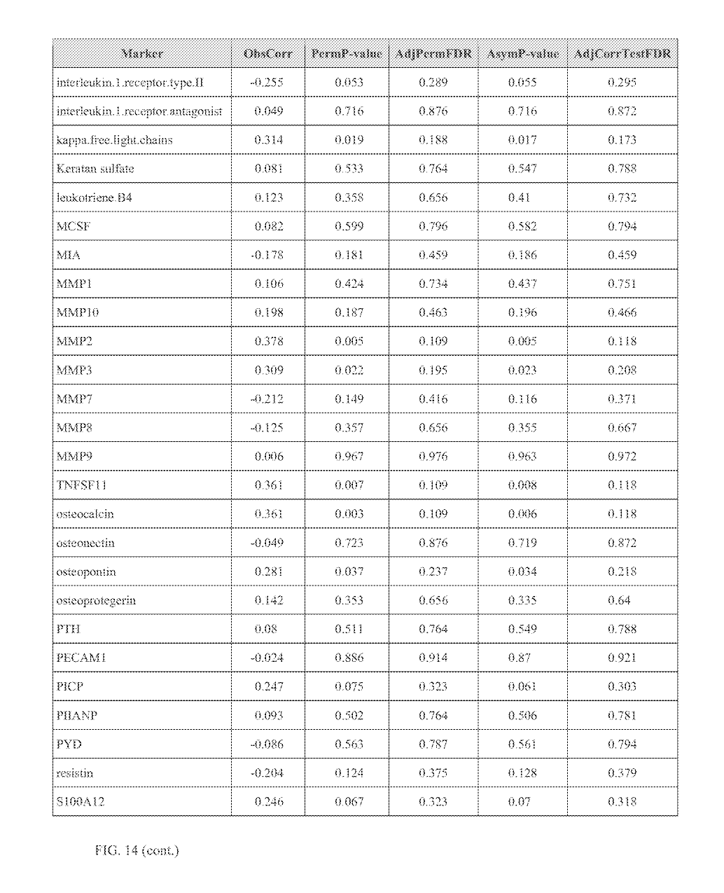

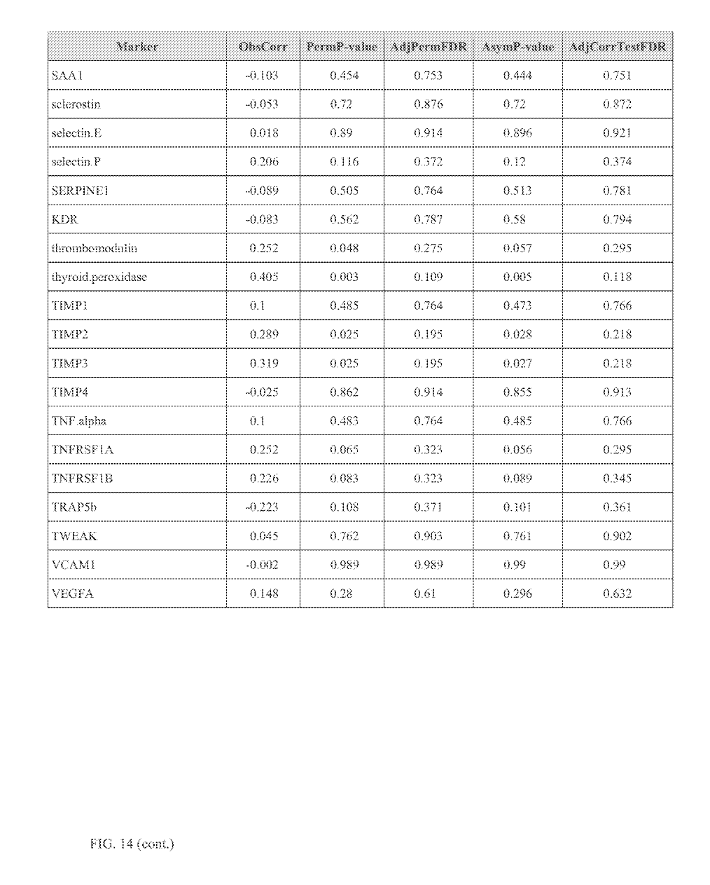

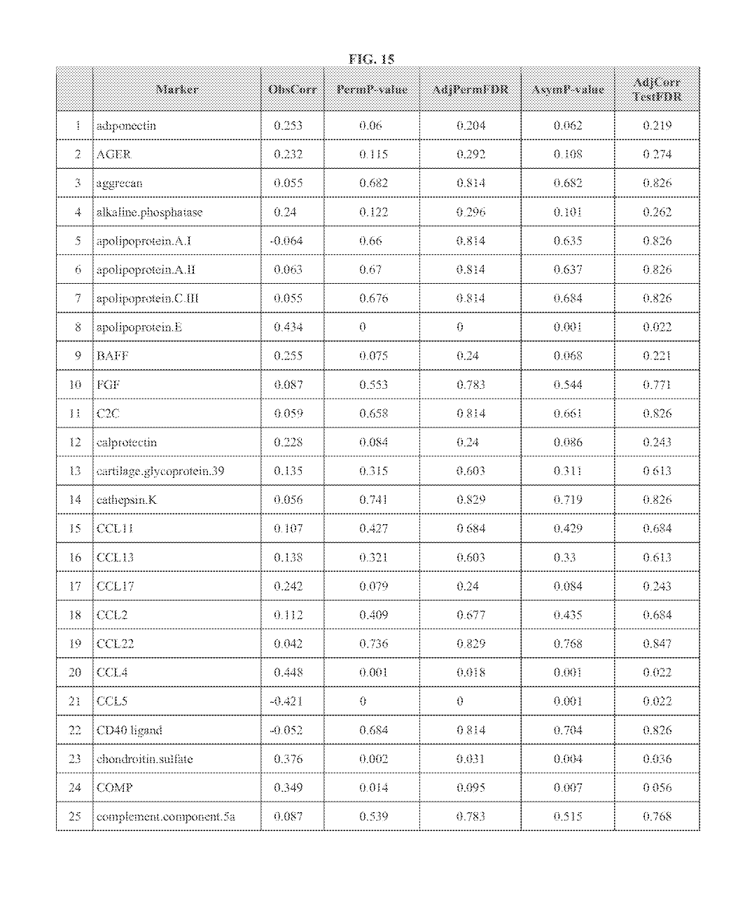

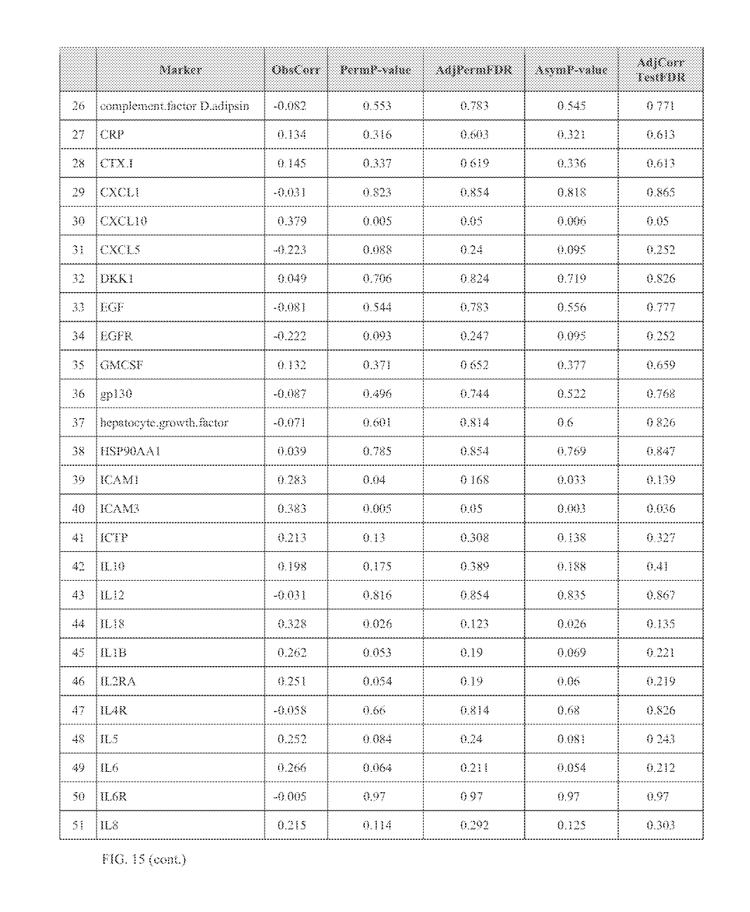

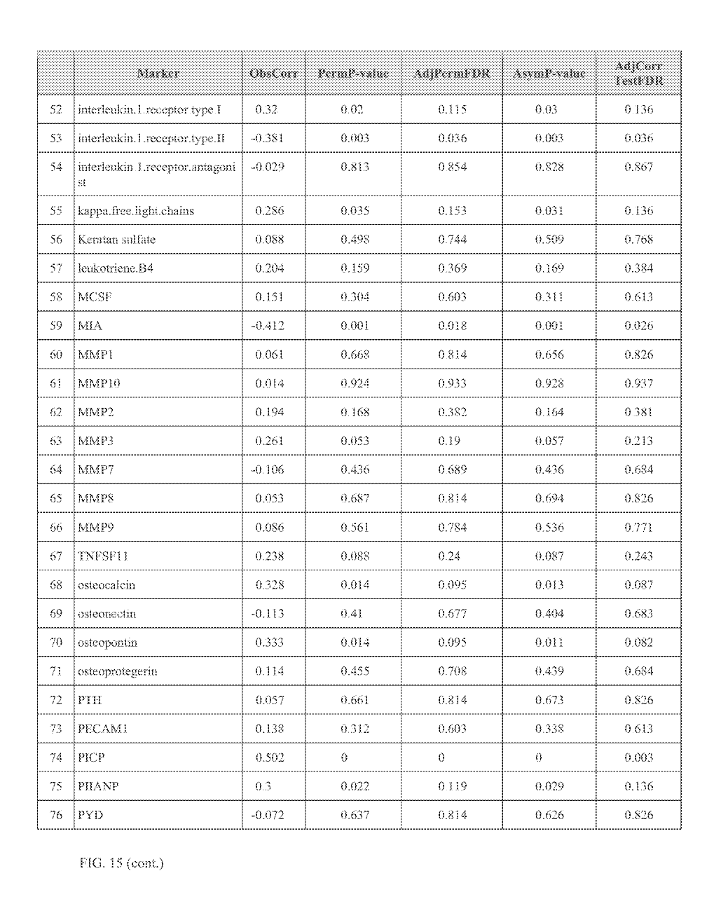

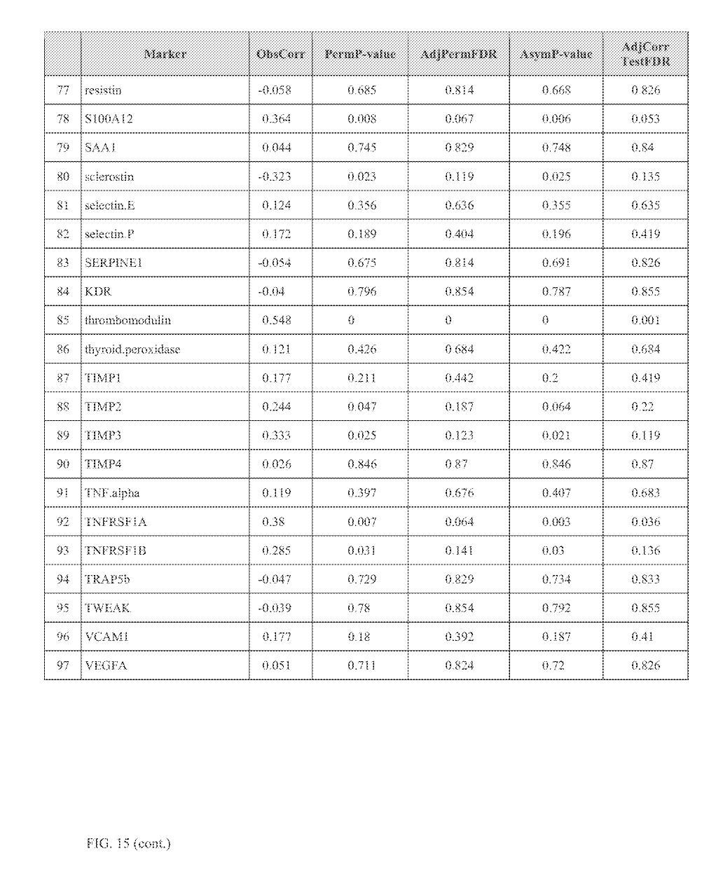

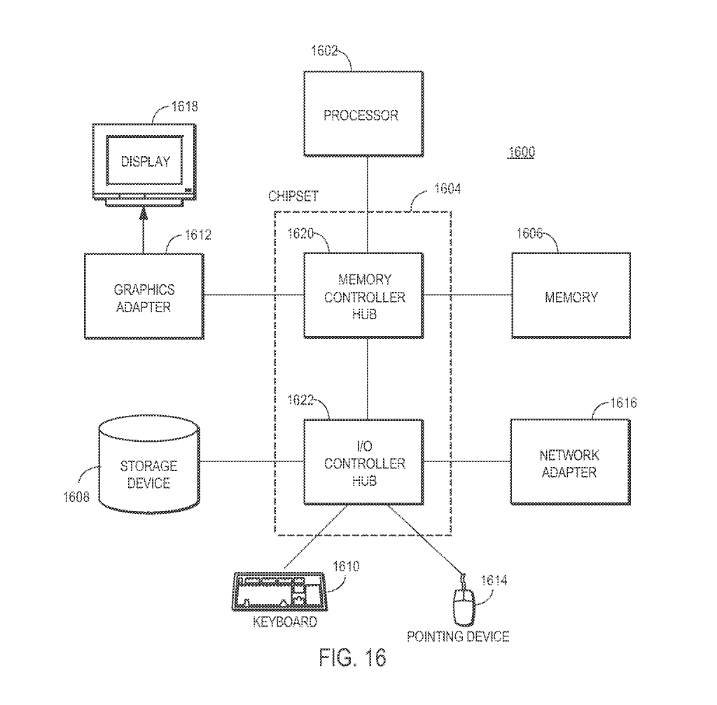

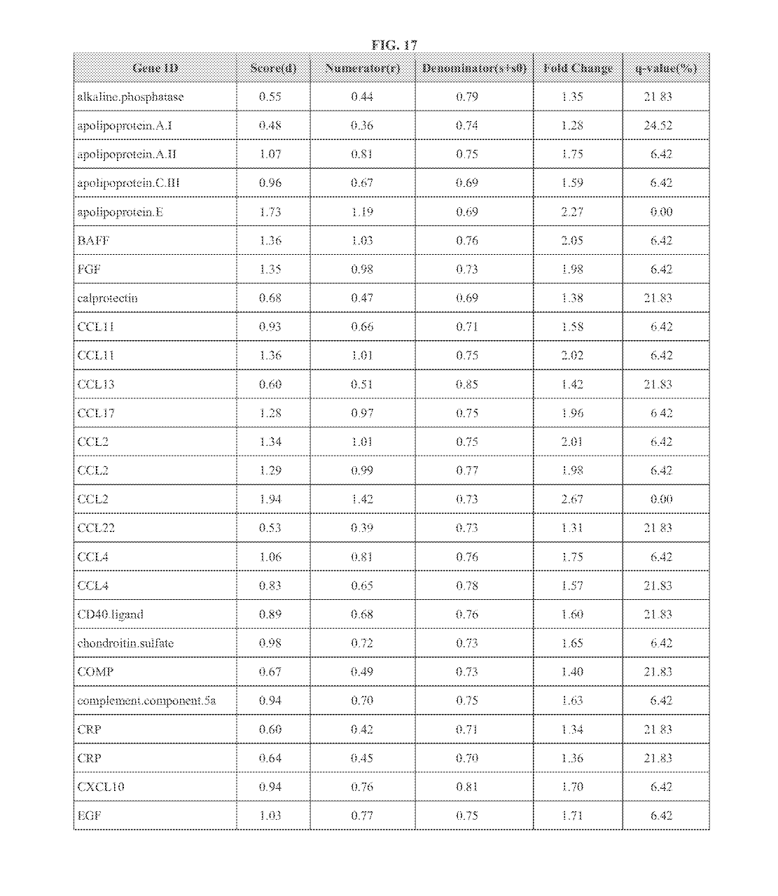

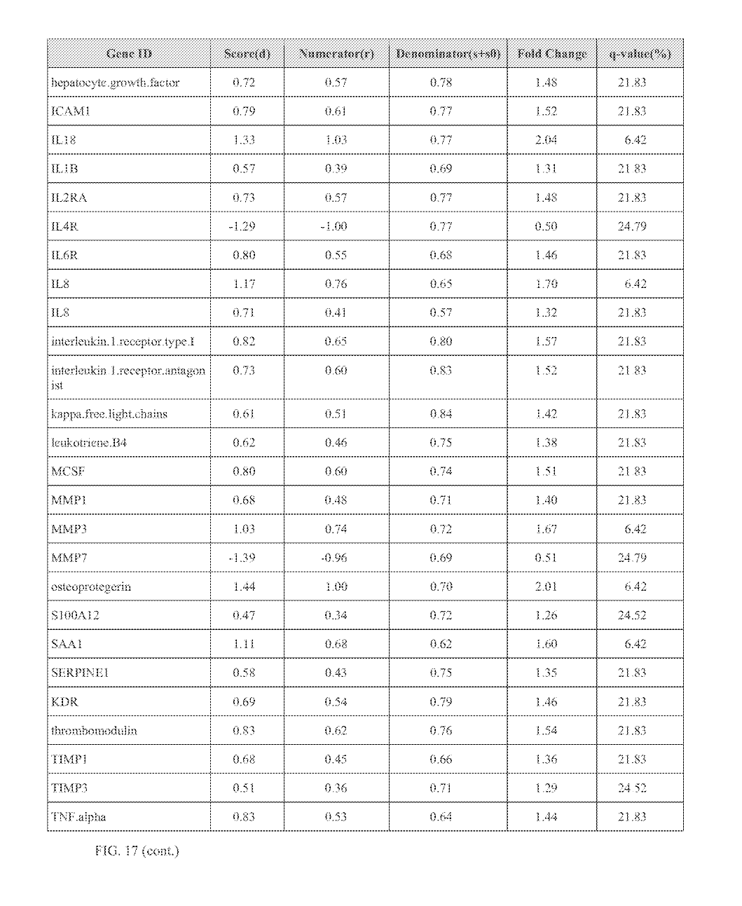

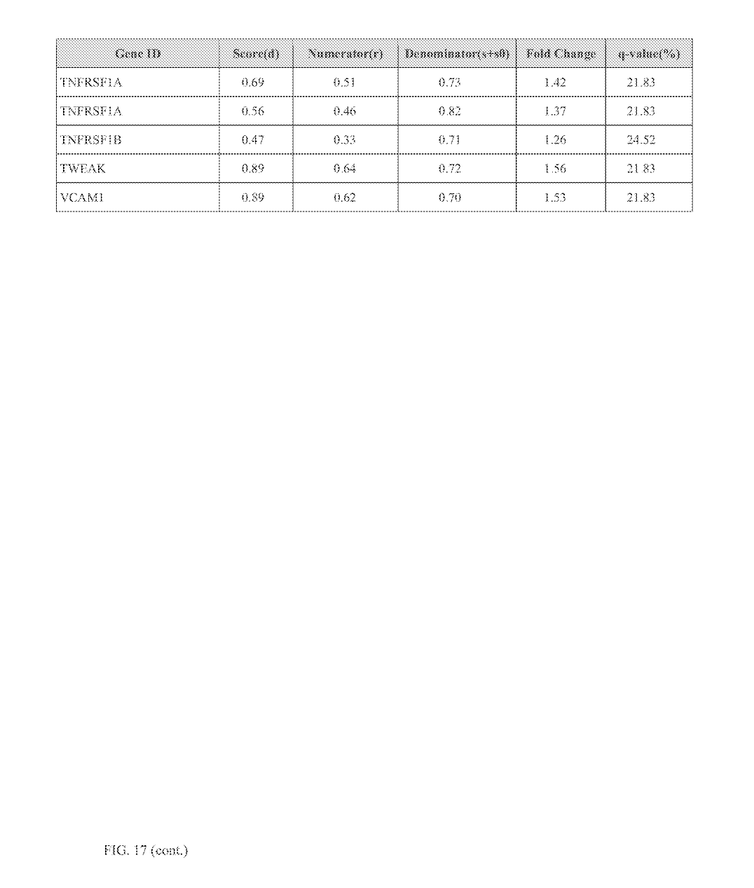

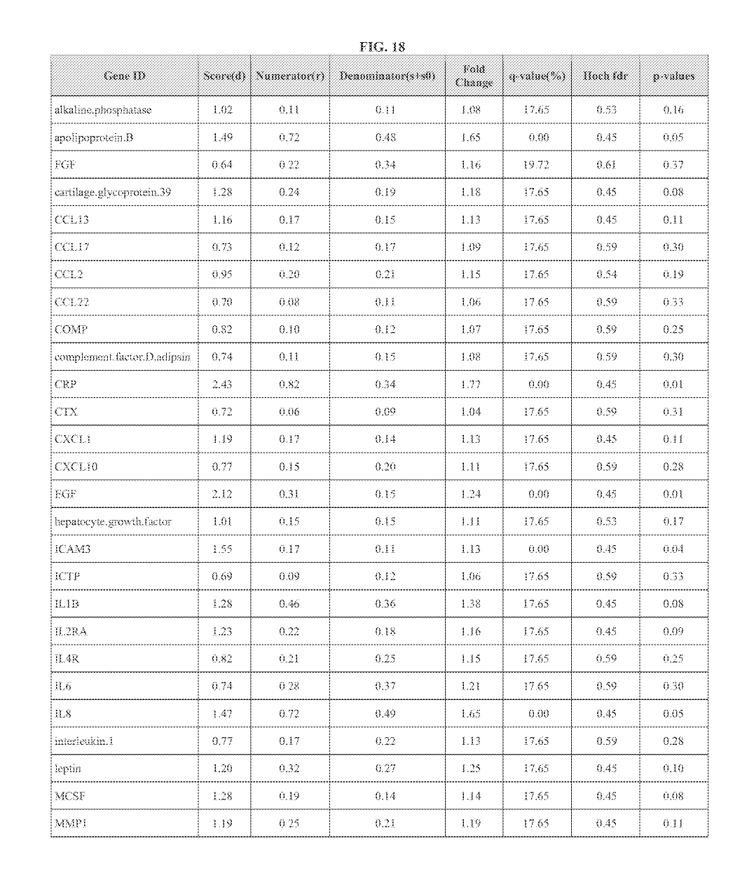

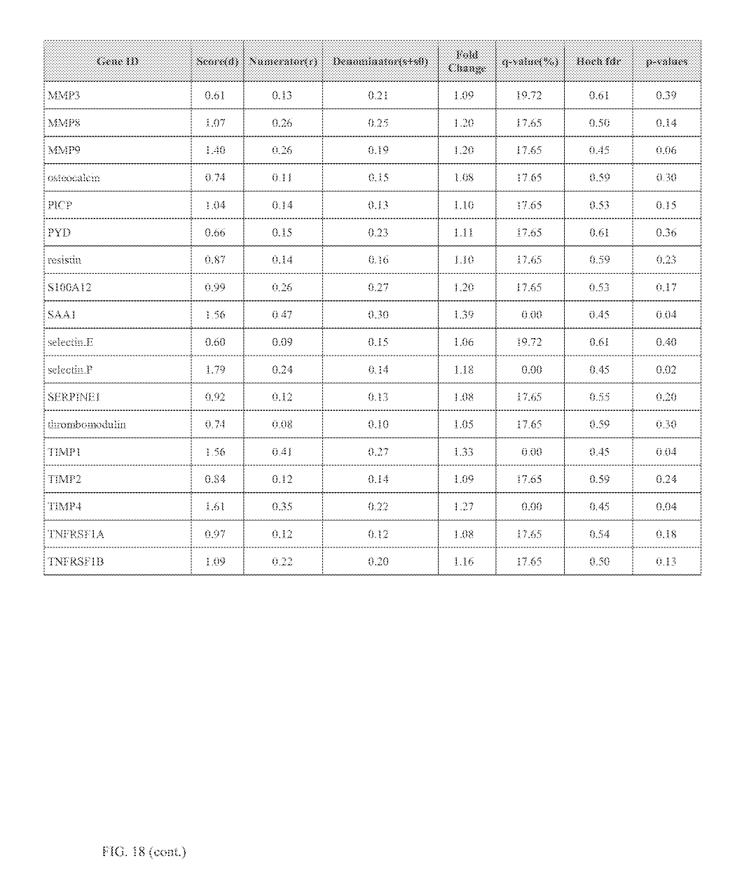

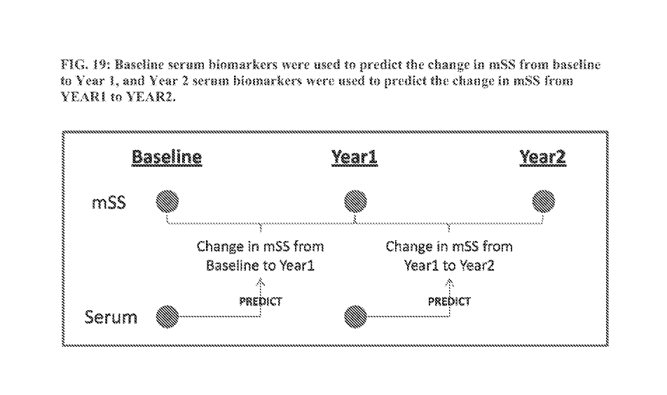

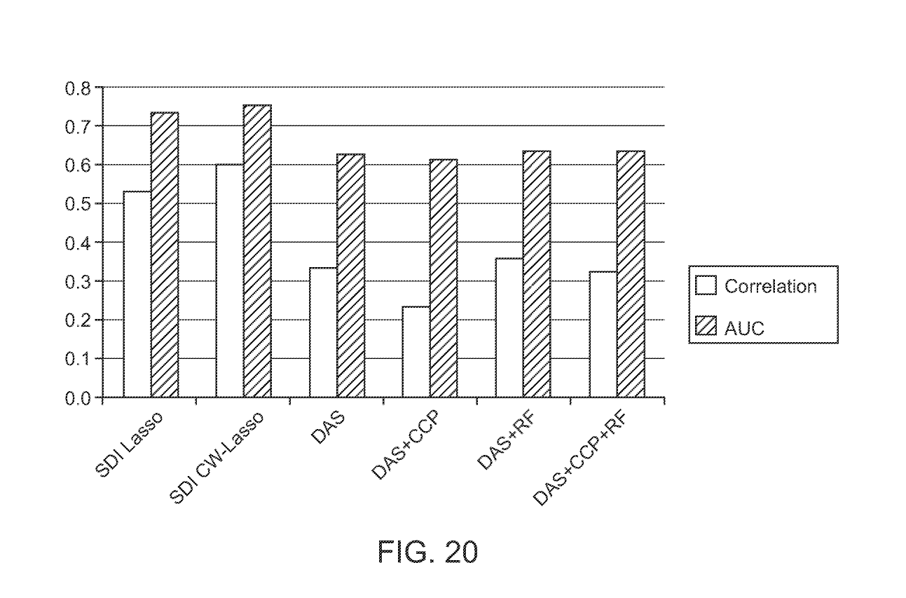

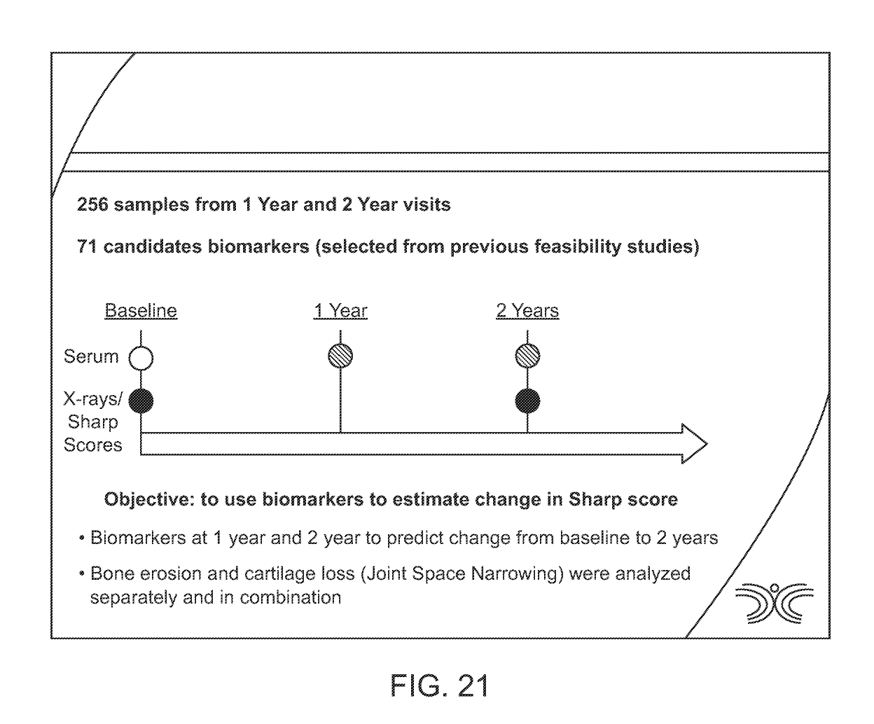

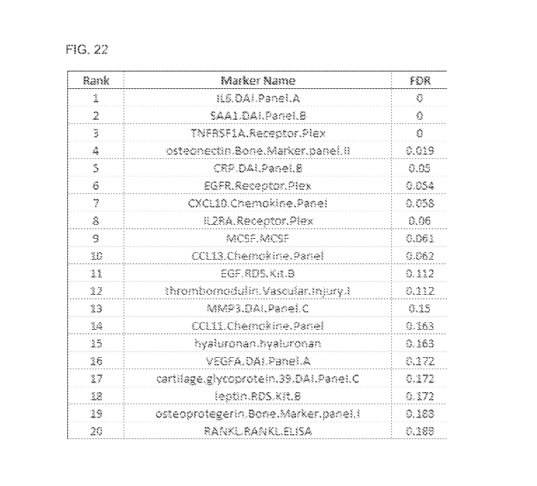

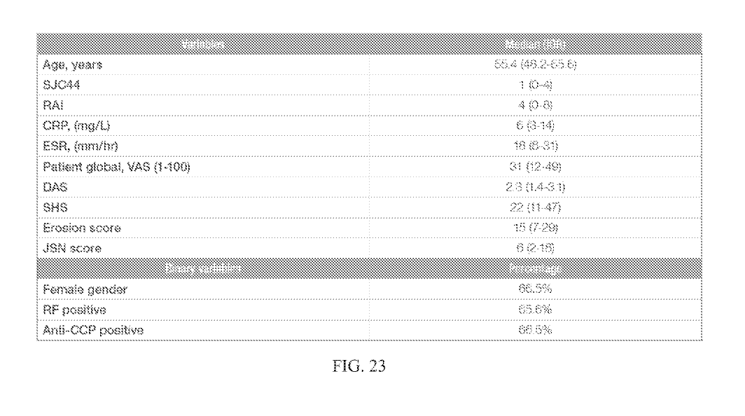

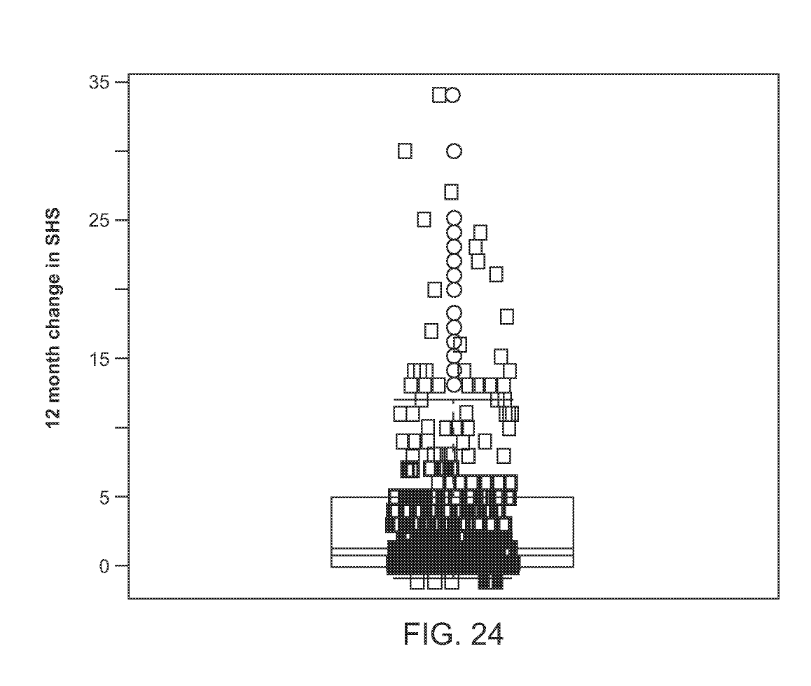

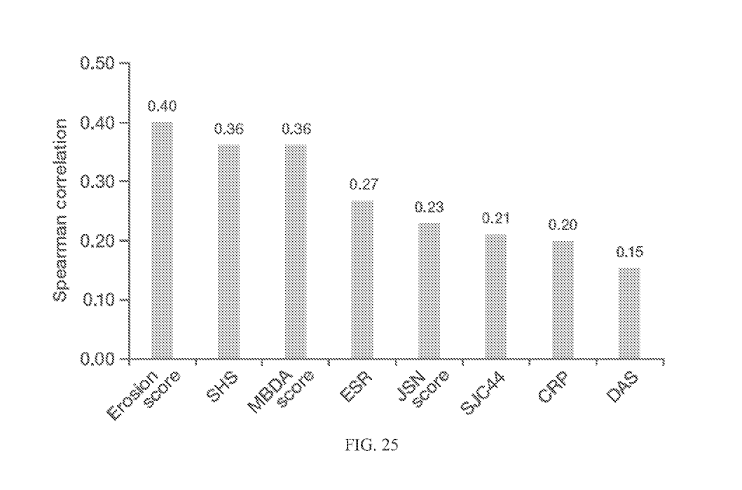

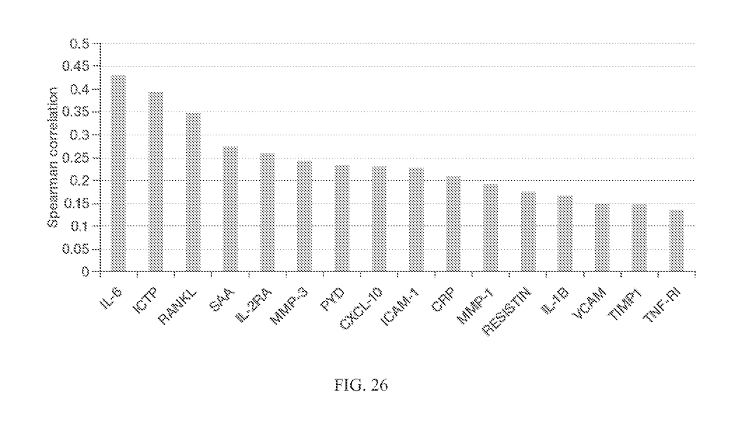

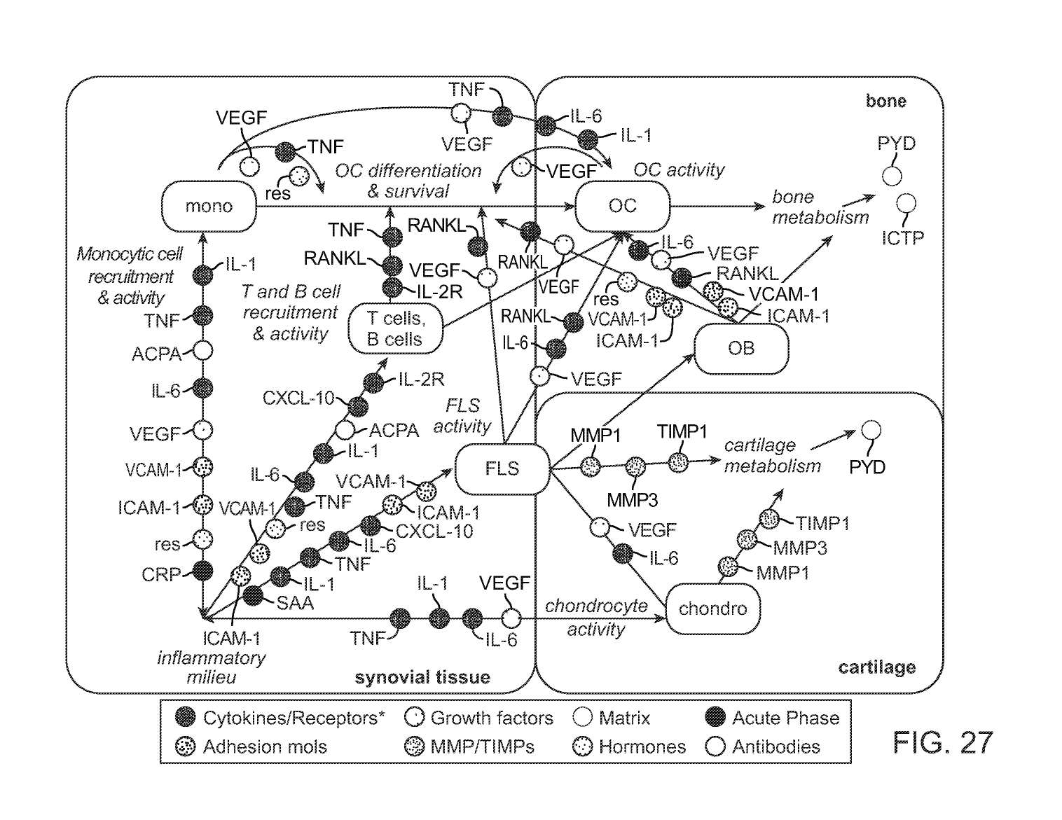

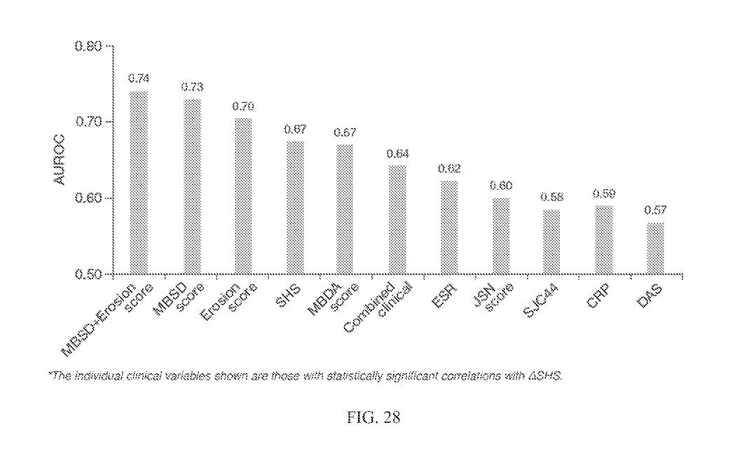

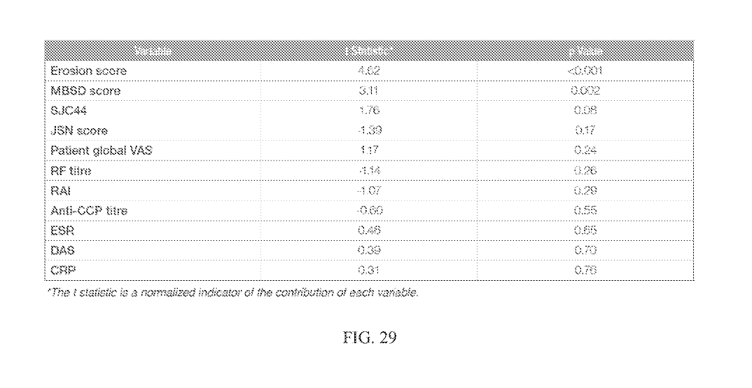

The detailed procedure for deriving TWOMRK sets is as follows. For all possible models with two-biomarker combinations, 70/30 cross validation performance was computed, as measured by AUROC. 70/30 means repeatedly training in a randomly selected 70% of the data, and testing in the remaining 30%. Because each randomly selected test set has different ranges of DSS, to ensure balanced groups, a median DSS threshold was used. The two-biomarker combinations (TWOMRK sets) with AUROC>=0.6 are reported in this FIG. 1. This process was repeated for all combinations of 3, 4, 5, and 6 biomarkers (FIGS. 3-6, respectively). To avoid redundancy, the n-biomarker combinations list contain only those marker sets with AUROC>=0.6, and do not contain any previously reported combination. For example, FIG. 3 describes 4-biomarker sets (FOURMRK), and does not list any set of 2 or 3 biomarkers that are already found in a TWOMRK or THREEMRK set.

See Example 4 for a description of the BeSt cohort of samples. Biomarker concentrations obtained at the year 1 timepoint were used to predict DSS over the next 12 months, because biomarker-based models predict radiographic outcomes best after anti-rheumatic therapy has taken effect. Note that at baseline in BeSt, subjects were just initiating therapy. Biomarker levels that were measured in this dataset were COMP, CRP, CXCL10, EGF, ICAM1, ICAM3, ICTP, IL1B, IL2RA, IL6, IL6R, IL8, LEP, MCSF, MMP1, MMP3, PYD, RANKL, RETN, SAA1, THBD, TIMP1, TNFRSF1A, VCAM1, and VEGFA.

Three biomarkers (TNFRSF11B, CCL22 and CHI3L1) were not measured in samples obtained from BeSt. Hence, marker sets that included these three biomarkers were obtained by analyzing marker levels in samples from the SONORA cohort. SONORA is a North American observational study of subjects with early RA. Biomarker concentrations were determined from samples obtained at study baseline (73 samples) and year 1 (128 samples), from a total of 130 patients (201 samples total). Sharp scores were measured at baseline, year1, and year2. Since this was an observational study, subjects did not initiate therapy at any consistent timepoint. Serum samples at baseline and year 1 were pooled together to predict DSS over the next 12 months, starting from whenever the biomarkers were measured. Only the marker sets including TNFRSF11B, CCL22 and CHI3L1 were modeled from SONORA. The combinations including those three markers that yielded model prediction of AUROC>=0.6 are reported in FIG. 1.

SDI scores derived from the levels of the sets of biomarkers comprising the TWOMRK sets in FIG. 1 demonstrated a strong predictive ability to classify subject disease progression, as evidenced by the AUC values shown (greater than or equal to 0.60).

FIG. 2 depicts a list of three-biomarker (THREEMRK) sets or panels. Predictive models were built, as described in certain embodiments of the present teachings, to estimate the rate of structural damage in subjects. Biomarker concentrations obtained at one timepoint were used to predict the change of total Van der Heijde Sharp Scores (DSS) that would occur over the next 12 months. The combinations of different biomarkers that provided model performance with Area under the ROC Curve (AUROC) of 0.6 or greater in 100 cross validations are reported in this figure. See description of FIG. 1 for an explanation of how these sets were obtained. Note that the list of THREEMRK sets in FIG. 2 does not contain any panels comprising the two-biomarker sets of FIG. 1.

FIG. 3 depicts a list of four-biomarker (FOURMRK) sets or panels. Predictive models were built, as described in certain embodiments of the present teachings, to estimate the rate of structural damage in subjects. Biomarker concentrations obtained at one timepoint were used to predict the change of total Van der Heijde Sharp Scores (DSS) that would occur over the next 12 months. The combinations of different biomarkers that provided model performance with Area under the ROC Curve (AUROC) of 0.6 or greater in 100 cross validations are reported in this figure. See description of FIG. 1 for an explanation of how these sets were obtained. Note that the list of FOURMRK sets in FIG. 3 does not contain any panels comprising the two-biomarker sets of FIG. 1, or the three-biomarker sets of FIG. 2.

FIG. 4 depicts a list of five-biomarker (FIVEMRK) sets or panels. Predictive models were built, as described in certain embodiments of the present teachings, to estimate the rate of structural damage in subjects. Biomarker concentrations obtained at one timepoint were used to predict the change of total Van der Heijde Sharp Scores (DSS) that would occur over the next 12 months. The combinations of different biomarkers that provided model performance with Area under the ROC Curve (AUROC) of 0.6 or greater in 100 cross validations are reported in this figure. See description of FIG. 1 for an explanation of how these sets were obtained. Note that the list of FIVEMRK sets in FIG. 4 does not contain any panels comprising the two-biomarker sets of FIG. 1, or the three-biomarker sets of FIG. 2, or the four-biomarker sets of FIG. 3.

FIG. 5 depicts a list of six-biomarker (SIXMRK) sets or panels. Predictive models were built, as described in certain embodiments of the present teachings, to estimate the rate of structural damage in subjects. Biomarker concentrations obtained at one timepoint were used to predict the change of total Van der Heijde Sharp Scores (DSS) that would occur over the next 12 months. The combinations of different biomarkers that provided model performance with Area under the ROC Curve (AUROC) of 0.6 or greater in 100 cross validations are reported in this figure. See description of FIG. 1 for an explanation of how these sets were obtained. Note that the list of SIXMRK sets in FIG. 5 does not contain any panels comprising the two-biomarker sets of FIG. 1, or the three-biomarker sets of FIG. 2, or the four-biomarker sets of FIG. 3, or the five-biomarker sets of FIG. 4.

FIG. 6 is a flow diagram, which describes an example of a method for developing a model that can be used to determine inflammatory disease progression in a person or population.

FIG. 7 is a flow diagram, which describes an example of a method for using the model of FIG. 6 to determine the inflammatory disease progression in a subject or population.

FIG. 8 depicts the study design and data overview for Example 1, below. A total of 24 study subjects were initially randomized 1:1 to methotrexate plus infliximab therapy, or methotrexate plus placebo. Placebo arm subjects were switched to methotrexate plus infliximab after 1 year and the trial was continued on an open-label basis. Circles in this figure indicate the timepoints at which data of each type were collected for analysis.

FIG. 9 depicts and serum and urine markers individually correlated to ultrasound, DAS28-CRP, and total Sharp score (TSS) measurements, from Example 1. Serum and urine markers individually correlated to TSS are indicated in red and blue text, respectively.

FIG. 10 depicts the performance of predictions of radiographic progression in Example 1. Bars show the Spearman correlation between observed and predicted rates of change in TSS, in leave-one-out cross-validation for progression between (a) 0 and 54 weeks, and (b) 0 and 110 weeks. Predictions were made using data from the timepoint indicated on the x axis.

FIG. 11 depicts the model predictions of radiographic progression, from Example 1. Plots show observed (x axis) vs. predicted (y axis) rate of change in TSS (points/week). Predictions were made using (a) 6-week serum biomarker data (rho=0.90), (b) 18-week PDA data (rho=0.81), (c) 18-week ST data (rho=0.64), or (d) 18-week DAS data (rho=0.72), in combination with information on treatment and time elapsed since start of study. For each prediction, a single patient was left out, a statistical model was trained on the remaining 23 patients, and that model was used to estimate the outcome for the omitted patient.

FIG. 12 depicts the mean and median progression rate response kinetics based on the biomarker model of Example 1. A modified model without treatment variables was trained using 6 week data and was applied to each timepoint to estimate the joint damage progression rate at that timepoint.

FIG. 13 depicts the Spearman correlation values obtained in Example 2, for each biomarker's correlation with the erosion scores. In this figure and FIGS. 14 and 15, ObsCorr is the observed correlation between the biomarker level and the particular MRI score (erosion, osteitis or synovitis); PermP-value is the p-value for that ObsCorr via the permutation test; AdjPermFDR is the false discovery rate for that PermP-value (e.g., an AdjPermP-value of 0.2 means 20% of the biomarker levels could be expected to be false positives for that ObsCorr value); AsymP-value is the p-value for that ObsCorr via the parametric test; and, AdjCorrTestFDR is the FDR for that AsymP-value.

FIG. 14 depicts the Spearman correlation values obtained in Example 2, for each biomarker's correlation with osteitis scores.

FIG. 15 depicts the Spearman correlation values obtained in Example 2, for each biomarker's correlation with synovitis scores.

FIG. 16 is a high-level block diagram of a computer (1600). Illustrated are at least one processor (1602) coupled to a chipset (1604). Also coupled to the chipset (1604) are a memory (1606), a storage device (1608), a keyboard (1610), a graphics adapter (1612), a pointing device (1614), and a network adapter (1616). A display (1618) is coupled to the graphics adapter (1612). In one embodiment, the functionality of the chipset (1604) is provided by a memory controller hub 1620) and an I/O controller hub (1622). In another embodiment, the memory (1606) is coupled directly to the processor (1602) instead of the chipset (1604). The storage device 1608 is any device capable of holding data, like a hard drive, compact disk read-only memory (CD-ROM), DVD, or a solid-state memory device. The memory (1606) holds instructions and data used by the processor (1602). The pointing device (1614) may be a mouse, track ball, or other type of pointing device, and is used in combination with the keyboard (1610) to input data into the computer system (1600). The graphics adapter (1612) displays images and other information on the display (1618). The network adapter (1616) couples the computer system (1600) to a local or wide area network.

FIG. 17 depicts the results of Example 2, wherein markers were identified that differed in serum levels between subjects whose RAMRIS erosion scores increased, and those whose scores did not. For this analysis, the methodology of Significance Analysis of Microarrays (SAM) was used, analogous to the T-test that is used when comparing groups. In this Example the two groups compared were eroders and non-eroders, and the marker levels were compared between these erosion groups. The Score(d), then, was derived from Numerator (r)/Denominator (s+s0), where Numerator (r) is the difference between the two groups, and Denominator (s+s0) is the standard deviation. The Fold Change is the ratio of two values, describing how much the two values differ. The q-value measures how significant the marker is: as d>0 increases, the corresponding q-value decreases.

FIG. 18 depicts the results of Example 3, wherein biomarkers are correlated with change in total Sharp score. The headers in this figure have the same meaning as in FIGS. 13-15. Markers were identified that differed in concentration between eroders and non-eroders, based on cross-sectional X-rays, using SAM (see Example 2).

FIG. 19 depicts the study plan of Example 4, wherein baseline serum biomarkers were used to predict the change in modified Sharp score (mSS) from baseline to Year 1, and Year 2 serum biomarkers were used to predict the change in mSS from Year 1 to Year 2.

FIG. 20 depicts the results of Example 4, wherein performance of the SDI score, derived from serum biomarker combinations, to predict rate of change in Sharp score was compared to other baseline clinical assessments.

FIG. 21 depicts an outline of the objectives and study plan for Example 5.

FIG. 22 depicts the results of Example 5: 20 biomarkers that were shown to be significantly associated with joint damage, where false discovery rate (FDR) was less than 0.2.

FIG. 23 is a table of characteristics of patients used in Example 6 at first visit.

FIG. 24 is a distribution of Δ SHS for all patient visits examined in Example 6.

FIG. 25 illustrates statistically significant correlations between clinical variables and Δ SHS over 12 months in Example 6.

FIG. 26 illustrates statistically significant correlations between individual biomarker concentrations and ΔSHS over 12 months in Example 6.

FIG. 27 illustrates the roles of candidate structural damage biomarkers in the biology of joint destruction in Example 6.

FIG. 28 illustrates AUROC for variables predicting whether patients would have progression greater than median (ΔSHS=1) wherein the individual clinical variables shown are those with statistically significant correlations with ΔSHS in Example 6.

FIG. 29 illustrates the result of multivariate OLS regression to identify independent predictors of ΔSHS in Example 6.

### DESCRIPTION OF VARIOUS EMBODIMENTS

These and other features of the present teachings will become more apparent from the description herein. While the present teachings are described in conjunction with various embodiments, it is not intended that the present teachings be limited to such embodiments. On the contrary, the present teachings encompass various alternatives, modifications, and equivalents, as will be appreciated by those of skill in the art.

The present teachings relate generally to the identification of biomarkers associated with subjects having inflammatory and/or autoimmune diseases, such as for example RA, and that are useful in determining or assessing inflammatory disease progression.

Most of the words used in this specification have the meaning that would be attributed to those words by one skilled in the art. Words specifically defined in the specification have the meaning provided in the context of the present teachings as a whole, and as are typically understood by those skilled in the art. In the event that a conflict arises between an art-understood definition of a word or phrase and a definition of the word or phrase as specifically taught in this specification, the specification shall control. It must be noted that, as used in the specification and the appended claims, the singular forms “a,” “an,” and “the” include plural referents unless the context clearly dictates otherwise.

### DEFINITIONS

“Accuracy” refers to the degree that a measured or calculated value conforms to its actual value. “Accuracy” in clinical testing relates to the proportion of actual outcomes (true positives or true negatives, wherein a subject is correctly classified as having disease or as healthy/normal, respectively) versus incorrectly classified outcomes (false positives or false negatives, wherein a subject is incorrectly classified as having disease or as healthy/normal, respectively). Other and/or equivalent terms for “accuracy” can include, for example, “sensitivity,” “specificity,” “positive predictive value (PPV),” “the AUC,” “negative predictive value (NPV),” “likelihood,” and “odds ratio.” “Analytical accuracy,” in the context of the present teachings, refers to the repeatability and predictability of the measurement process. Analytical accuracy can be summarized in such measurements as, e.g., coefficients of variation (CV), and tests of concordance and calibration of the same samples or controls at different times or with different assessors, users, equipment, and/or reagents. See, e.g., R. Vasan, Circulation 2006, 113(19):2335-2362 for a summary of considerations in evaluating new biomarkers.

The term “algorithm” encompasses any formula, model, mathematical equation, algorithmic, analytical or programmed process, or statistical technique or classification analysis that takes one or more inputs or parameters, whether continuous or categorical, and calculates an output value, index, index value or score. Examples of algorithms include but are not limited to ratios, sums, regression operators such as exponents or coefficients, biomarker value transformations and normalizations (including, without limitation, normalization schemes that are based on clinical parameters such as age, gender, ethnicity, etc.), rules and guidelines, statistical classification models, and neural networks trained on populations. Also of use in the context of biomarkers are linear and non-linear equations and statistical classification analyses to determine the relationship between (a) levels of biomarkers detected in a subject sample and (b) the level of the respective subject's disease progression.

“ALLMRK” in the present teachings refers to a specific group, panel or set of biomarkers, as the term “biomarkers” is defined herein. Where the biomarkers of certain embodiments of the present teachings are proteins, the gene symbols and names used herein are to be understood to refer to the protein products of these genes, and the protein products of these genes are intended to include any protein isoforms of these genes, whether or not such isoform sequences are specifically described herein. Where the biomarkers are nucleic acids, the gene symbols and names used herein are to refer to the nucleic acids (DNA or RNA) of these genes, and the nucleic acids of these genes are intended to include any transcript variants of these genes, whether or not such transcript variants are specifically described herein. The ALLMRK group of the present teachings is the group of markers consisting of the following, where the name(s) or symbols in parentheses at the end of the marker name generally refers to the gene name, if known, or an alias: adiponectin, ClQ and collagen domain containing (ADIPOQ); adrenomedullin (ADM); alkaline phosphatase, liver/bone/kidney (ALPL); amyloid P component, serum (APCS); advanced glycosylation end product-specific receptor (AGER); apolipoprotein A-I (APOA1); apolipoprotein A-II (APOA2); apolipoprotein B (including Ag(x) antigen) (APOB); apolipoprotein C-II (APOC2); apolipoprotein C-III (APOC3); apolipoprotein E (APOE); bone gamma-carboxyglutamate (gla) protein (BGLAP, or osteocalcin); bone morphogenetic protein 6 (BMP6); calcitonin-related polypeptide beta (CALCB); calprotectin (dimer of S100A8 and S100A9 protein subunits); chemokine (C—C motif) ligand 22 (CCL22); CD40 ligand (CD40LG); chitinase 3-like 1 (cartilage glycoprotein-39) (CHI3L1, or YKL-40); cartilage oligomeric matrix protein (COMP); C-reactive protein, pentraxin-related (CRP); CS3B3 epitope, a cartilage fragment; colony stimulating factor 1 (macrophage) (CSF1, or MCSF); colony stimulating factor 2 (granulocyte-macrophage) (CSF2); colony stimulating factor 3 (granulocyte) (CSF3); cystatin C(CST3); chemokine (C—X—C motif) ligand 10 (CXCL10); epidermal growth factor (beta-urogastrone) (EGF); epidermal growth factor receptor (erythroblastic leukemia viral (v-erb-b) oncogene homolog, avian) (EGFR); erythropoietin (EPO); Fas (TNF receptor superfamily, member 6) (FAS); fibrinogen alpha chain (FGA); fibroblast growth factor 2 (basic) (FGF2); fibrinogen; fms-related tyrosine kinase 1 (vascular endothelial growth factor/vascular permeability factor receptor) (FLT 1); fms-related tyrosine kinase 3 ligand (FLT3LG); fms-related tyrosine kinase 4 (FLT4); follicle stimulating hormone; follicle stimulating hormone, beta polypeptide (FSHB); glial cell derived neurotrophic factor (GDNF); gastric inhibitory polypeptide (GIP); ghrelin; ghrelin/obestatin prepropeptide (GHRL); growth hormone 1 (GH1); GLP1; hepatocyte growth factor (HGF); haptoglobin (HP); intercellular adhesion molecule 1 (ICAM1); intercellular adhesion molecule 3 (ICAM3); ICTP; interferon, alpha 1 (IFNA1); interferon, alpha 2 (IFNA2); interferon, gamma (IFNG); insulin-like growth factor binding protein 1 (IGFBP1); interleukin 10 (IL10); interleukin 12; interleukin 12A (natural killer cell stimulatory factor 1, cytotoxic lymphocyte maturation factor 1, p35) (IL12A); interleukin 12B (natural killer cell stimulatory factor 2, cytotoxic lymphocyte maturation factor 2, p40) (IL12B); interleukin 13 (IL13); interleukin 15 (IL15); interleukin 17A (IL17A); interleukin 18 (interferon-gamma-inducing factor) (IL18); interleukin 1, alpha (IL1A); interleukin 1, beta (IL1B); interleukin 1 receptor, type I (IL1R1); interleukin 1 receptor, type II (IL1R2); interleukin 1 receptor antagonist (IL1RN, or IL1RA); interleukin 2 (IL2); interleukin 2 receptor; interleukin 2 receptor, alpha (IL2RA); interleukin 3 (colony-stimulating factor, multiple) (IL3); interleukin 4 (IL4); interleukin 4 receptor (IL4R); interleukin 5 (colony-stimulating factor, eosinophil) (IL5); interleukin 6 (interferon, beta 2) (IL6); interleukin 6 receptor (IL6R); interleukin 6 signal transducer (gp130, oncostatin M receptor) (IL6ST); interleukin 7 (IL7); interleukin 8 (IL8); insulin (INS); interleukin 9 (IL9); kinase insert domain receptor (a type III receptor tyrosine kinase) (KDR); v-kit Hardy-Zuckerman 4 feline sarcoma viral oncogene homolog (KIT); keratan sulfate, or KS; leptin (LEP); leukemia inhibitory factor (cholinergic differentiation factor) (LIF); lymphotoxin alpha (TNF superfamily, member 1) (LTA); lysozyme (renal amyloidosis) (LYZ); matrix metallopeptidase 1 (interstitial collagenase) (MMP1); matrix metallopeptidase 10 (stromelysin 2) (MMP10); matrix metallopeptidase 2 (gelatinase A, 72 kDa gelatinase, 72 kDa type IV collagenase) (MMP2); matrix metallopeptidase 3 (stromelysin 1, progelatinase) (MMP3); matrix metallopeptidase 9 (gelatinase B, 92 kDa gelatinase, 92 kDa type IV collagenase) (MMP9); myeloperoxidase (MPO); nerve growth factor (beta polypeptide) (NGF); natriuretic peptide precursor B (NPPB, or NT-proBNP); neurotrophin 4 (NTF4); platelet-derived growth factor alpha polypeptide (PDGFA); the dimer of two PDGFA subunits (or PDGF-AA); the dimer of one PDGFA subunit and one PDGFB subunit (or PDGF-AB); platelet-derived growth factor beta polypeptide (PDGFB); prostaglandin E2 (PGE2); phosphatidylinositol glycan anchor biosynthesis, class F (PIGF); proopiomelanocortin (POMC); pancreatic polypeptide (PPY); prolactin (PRL); pentraxin-related gene, rapidly induced by IL-1 beta (PTX3, or pentraxin 3); pyridinoline (PYD); peptide YY (PYY); resistin (RETN); serum amyloid A1 (SAA1); selectin E (SELE); selectin L (SELL); selectin P (granule membrane protein 140 kDa, antigen CD62) (SELP); serpin peptidase inhibitor, Glade E (nexin, plasminogen activator inhibitor type 1), member 1 (SERPINE1); secretory leukocyte peptidase inhibitor (SLPI); sclerostin (SOST); secreted protein, acidic, cysteine-rich (SPARC, or osteonectin); secreted phosphoprotein 1 (SPP 1, or osteopontin); transforming growth factor, alpha (TGFA); thrombomodulin (THBD); TIMP1 (TIMP metallopeptidase inhibitor); tumor necrosis factor (TNF superfamily, member 2; or TNF-alpha) (TNF); tumor necrosis factor receptor superfamily, member 11b (TNFRSF11B, or osteoprotegerin); tumor necrosis factor receptor superfamily, member 1A (TNFRSF1A); tumor necrosis factor receptor superfamily, member 1B (TNFRSF1B); tumor necrosis factor receptor superfamily, member 8 (TNFRSF8); tumor necrosis factor receptor superfamily, member 9 (TNFRSF9); tumor necrosis factor (ligand) superfamily, member 11 (TNFSF11, or RANKL); tumor necrosis factor (ligand) superfamily, member 12 (TNFSF12, or TWEAK); tumor necrosis factor (ligand) superfamily, member 13 (TNFSF13, or APRIL); tumor necrosis factor (ligand) superfamily, member 13b (TNFSF13B, or BAFF); tumor necrosis factor (ligand) superfamily, member 14 (TNFSF14, or LIGHT); tumor necrosis factor (ligand) superfamily, member 18 (TNFSF18); thyroid peroxidase (TPO); vascular cell adhesion molecule 1 (VCAM1); and, vascular endothelial growth factor A (VEGFA).

The term “analyte” in the context of the present teachings can mean any substance to be measured, and can encompass biomarkers, markers, nucleic acids, electrolytes, metabolites, proteins, sugars, carbohydrates, fats, lipids, cytokines, chemokines, growth factors, proteins, peptides, nucleic acids, oligonucleotides, metabolites, mutations, variants, polymorphisms, modifications, fragments, subunits, degradation products and other elements. For simplicity, standard gene symbols may be used throughout to refer not only to genes but also gene products/proteins, rather than using the standard protein symbol; e.g., APOA1 as used herein can refer to the gene APOA1 and also the protein ApoAI. In general, hyphens are dropped from analyte names and symbols herein (IL−6=IL6).

To “analyze” includes determining a value or set of values associated with a sample by measurement of analyte levels in the sample. “Analyze” may further comprise and comparing the levels against constituent levels in a sample or set of samples from the same subject or other subject(s). The biomarkers of the present teachings can be analyzed by any of various conventional methods known in the art. Some such methods include but are not limited to: measuring serum protein or sugar or metabolite or other analyte level, measuring enzymatic activity, and measuring gene expression.

The term “antibody” refers to any immunoglobulin-like molecule that reversibly binds to another with the required selectivity. Thus, the term includes any such molecule that is capable of selectively binding to a biomarker of the present teachings. The term includes an immunoglobulin molecule capable of binding an epitope present on an antigen. The term is intended to encompass not only intact immunoglobulin molecules, such as monoclonal and polyclonal antibodies, but also antibody isotypes, recombinant antibodies, bi-specific antibodies, humanized antibodies, chimeric antibodies, anti-idiopathic (anti-ID) antibodies, single-chain antibodies, Fab fragments, F(ab′) fragments, fusion protein antibody fragments, immunoglobulin fragments, Fᵥ fragments, single chain Fᵥ fragments, and chimeras comprising an immunoglobulin sequence and any modifications of the foregoing that comprise an antigen recognition site of the required selectivity.

“Autoimmune disease” encompasses any disease, as defined herein, resulting from an immune response against substances and tissues normally present in the body. Examples of suspected or known autoimmune diseases include rheumatoid arthritis, juvenile idiopathic arthritis, seronegative spondyloarthropathies, ankylosing spondylitis, psoriatic arthritis, antiphospholipid antibody syndrome, autoimmune hepatitis, Behçet's disease, bullous pemphigoid, coeliac disease, Crohn's disease, dermatomyositis, Goodpasture's syndrome, Graves' disease, Hashimoto's disease, idiopathic thrombocytopenic purpura, IgA nephropathy, Kawasaki disease, systemic lupus erythematosus, mixed connective tissue disease, multiple sclerosis, myasthenia gravis, polymyositis, primary biliary cirrhosis, psoriasis, scleroderma, Sjögren's syndrome, ulcerative colitis, vasculitis, Wegener's granulomatosis, temporal arteritis, Takayasu's arteritis, Henoch-Schonlein purpura, leucocytoclastic vasculitis, polyarteritis nodosa, Churg-Strauss Syndrome, and mixed cryoglobulinemic vasculitis.

“Biomarker,” “biomarkers,” “marker” or “markers” in the context of the present teachings encompasses, without limitation, cytokines, chemokines, growth factors, proteins, peptides, nucleic acids, oligonucleotides, and metabolites, together with their related metabolites, mutations, isoforms, variants, polymorphisms, modifications, fragments, subunits, degradation products, elements, and other analytes or sample-derived measures. Biomarkers can also include mutated proteins, mutated nucleic acids, variations in copy numbers and/or transcript variants. Biomarkers also encompass non-blood borne factors and non-analyte physiological markers of health status, and/or other factors or markers not measured from samples (e.g., biological samples such as bodily fluids), such as clinical parameters and traditional factors for clinical assessments. Biomarkers can also include any indices that are calculated and/or created mathematically. Biomarkers can also include combinations of any one or more of the foregoing measurements, including temporal trends and differences.

A “clinical assessment,” or “clinical datapoint” or “clinical endpoint,” in the context of the present teachings can refer to, for example, a measure of disease activity or severity, or can be a measure of disease progression, such as that related to joint tissue structural damage, or can be a measure of a subject's improvement in particular clinical parameters, such as percent improvement in TJC or SJC. A clinical assessment can include a score, a value, or a set of values that can be obtained from evaluation of a sample (or population of samples) from a subject or subjects under determined conditions. A clinical assessment can also be a questionnaire completed by a subject. A clinical assessment can also be predicted by biomarkers and/or other parameters. One of skill in the art will recognize that the clinical assessment for RA, as an example, can comprise, without limitation, one or more of the following: DAS, DAS28, DAS28-ESR, DAS28-CRP, HAQ, mHAQ, MDHAQ, physician global assessment VAS, patient global assessment VAS, pain VAS, fatigue VAS, overall VAS, sleep VAS, SDAI, CDAI, RAPID2, RAPID3, RAPID4, RAPID5, ACR20, ACR50, and ACR70, SF-36 (a well-validated measure of general health status), RAMRIS (a score derived from an RA MRI scoring system), an SF-36 (a well-validated measure of general health status), total Sharp score (TSS, or simply Sharp score), van der Heijde-modified TSS, van der Heijde-modified Sharp score (or Sharp-van der Heijde score (SHS)), Larsen score, tender joint count (TJC), swollen joint count (SJC), CRP titer (or level), and ESR. ACR20 et al. refer to the standard ACR criteria used particularly in RA clinical or other studies to compare, e.g., the effectiveness of different treatments or to compare studies, as a clinical assessment of efficacy.

ACR criteria measure improvement in the clinical parameters of TJC and SJC, plus three of the following: acute phase reactant such as CRP, patient global health assessment, physician global health assessment, pain VAS, and a health assessment questionnaire. The number x associated with the ACR20, then, means that x percent of subjects demonstrated a 20% improvement in TJC and SJC, plus three of the other clinical parameters.

RAPID is an acronym for Routine Assessment of Patient Index Data, an index of outcome measures that provides a disease activity score. RAPID3 comprises only the three patient-reported outcomes of physical function, pain and patient global health assessment. RAPID4 adds to this another outcome measure, whether TJC(RAPID4TJC), SJC(RAPID4SJC) or physician global health assessment (RAPID4MD). RAPID5 adds to RAPID3 both TJC and physician global health assessment. RAPID2 includes only physician global health assessment and patient global health assessment.

The term “clinical parameters” in the context of the present teachings encompasses all measures of the health status of a subject. A clinical parameter can be used to derive a clinical assessment of the subject's disease progression or disease activity. Clinical parameters can include, without limitation: therapeutic regimen (including but not limited to DMARDs, whether conventional or biologics, steroids, etc.), tender joint count (TJC), swollen joint count (SJC), morning stiffness, arthritis of three or more joint areas, arthritis of hand joints, symmetric arthritis, rheumatoid nodules, radiographic/ultrasonographic (US) changes and other imaging, gender/sex, age, race/ethnicity, disease duration, diastolic and systolic blood pressure, resting heart rate, height, weight, body-mass index, family history, CCP status (i.e., whether subject is positive or negative for anti-CCP antibody), CCP titer, RF status, RF titer, ESR, CRP titer, menopausal status, and smoker/non-smoker.

“Clinical assessment” and “clinical parameter” are not mutually exclusive terms. There may be overlap in members of the two categories. For example, CRP titer can be used as a clinical assessment of disease activity; or, it can be used as a measure of the health status of a subject, and thus serve as a clinical parameter.

The term “computer” carries the meaning that is generally known in the art; that is, a machine for manipulating data according to a set of instructions. For illustration purposes only, FIG. 16 is a high-level block diagram of a computer (1600). As is known in the art, a “computer” can have different and/or other components than those shown in FIG. 16. In addition, the computer 1600 can lack certain illustrated components. Moreover, the storage device (1608) can be local and/or remote from the computer (1600) (such as embodied within a storage area network (SAN)). As is known in the art, the computer (1600) is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device (1608) or another non-transitory computer readable medium, loaded into the memory (1606), and executed by the processor (1602). Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience. Certain aspects of the present invention include process steps and instructions described herein in the form of a method. It should be noted that the process steps and instructions of the present invention could be embodied in software, firmware or hardware, and when embodied in software, could be downloaded to reside on and be operated from different platforms used by real time network operating systems.

The term “cytokine” in the present teachings refers to any substance secreted by specific cells of the immune system that carries signals locally between cells and thus has an effect on other cells. The term “cytokines” encompasses “growth factors.” “Chemokines” are also cytokines. They are a subset of cytokines that are able to induce chemotaxis in cells; thus, they are also known as “chemotactic cytokines.”

“SDMRK” in the present teachings refers to a specific group, set or panel of biomarkers, as the term “biomarkers” is defined herein. Where the biomarkers of certain embodiments of the present teachings are proteins, the gene symbols and names used herein are to be understood to refer to the protein products of these genes, and the protein products of these genes are intended to include any protein isoforms of these genes, whether or not such isoform sequences are specifically described herein. Where the biomarkers are nucleic acids, the gene symbols and names used herein are to refer to the nucleic acids (DNA or RNA) of these genes, and the nucleic acids of these genes are intended to include any transcript variants of these genes, whether or not such transcript variants are specifically described herein. The SDMRK group of the present teachings is the group consisting of: chemokine (C—C motif) ligand 22 (CCL22); chitinase 3-like 1 (cartilage glycoprotein-39) (CHI3L1, or YKL-40); cartilage oligomeric matrix protein (COMP); C-reactive protein, pentraxin-related (CRP); colony stimulating factor 1 (macrophage) (CSF1, or MCSF); chemokine (C—X—C motif) ligand 10 (CXCL10); epidermal growth factor (beta-urogastrone) (EGF); intercellular adhesion molecule 1 (ICAM1); intercellular adhesion molecule 1 (ICAM3); ICTP; interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (cross-links formed in collagen, derived from three lysine residues) (PYD); resistin (RETN); serum amyloid A1 (SAA1); thrombomodulin (THBD); TIMP metallopeptidase inhibitor (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11, or RANKL); vascular cell adhesion molecule 1 (VCAM1); and, vascular endothelial growth factor A (VEGFA).

Calprotectin is a heteropolymer, comprising two protein subunits of gene symbols S100A8 and S100A9. ICTP is the carboxyterminal telopeptide region of type I collagen, and is liberated during the degradation of mature type I collagen. Type I collagen is present as fibers in tissue; in bone, the type I collagen molecules are crosslinked. The ICTP peptide is immunochemically intact in blood. (For the type I collagen gene, see official symbol COL1A1, HUGO Gene Nomenclature Committee; also known as 014; alpha 1 type I collagen; collagen alpha 1 chain type I; collagen of skin, tendon and bone, alpha-1 chain; and, pro-alpha-1 collagen type 1). Keratan sulfate (KS, or keratosulfate) is not the product of a discrete gene, but refers to any of several sulfated glycosaminoglycans. They are synthesized in the central nervous system, and are found especially in cartilage and bone. Keratan sulfates are large, highly hydrated molecules, which in joints can act as a cushion to absorb mechanical shock.

“DAS” refers to the Disease Activity Score, a measure of the activity of RA in a subject, well-known to those of skill in the art. See D. van der Heijde et al., Ann. Rheum. Dis. 1990, 49(11):916-920. “DAS” as used herein refers to this particular Disease Activity Score. The “DAS28” involves the evaluation of 28 specific joints. It is a current standard well-recognized in research and clinical practice. Because the DAS28 is a well-recognized standard, it is often simply referred to as “DAS.” Unless otherwise specified, “DAS” herein will encompass the DAS28. A DAS28 can be calculated for an RA subject according to the standard as outlined at the das-score.nl website, maintained by the Department of Rheumatology of the University Medical Centre in Nijmegen, the Netherlands. The number of swollen joints, or swollen joint count out of a total of 28 (SJC28), and tender joints, or tender joint count out of a total of 28 (TJC28) in each subject is assessed. In some DAS28 calculations the subject's general health (GH) is also a factor, and can be measured on a 100 mm Visual Analogue Scale (VAS). GH may also be referred to herein as PG or PGA, for “patient global health assessment” (or merely “patient global assessment”). A “patient global health assessment VAS,” then, is GH measured on a Visual Analogue Scale.

“DAS28-CRP” (or “DAS28CRP”) is a DAS28 assessment calculated using CRP in place of ESR (see below). CRP is produced in the liver. Normally there is little or no CRP circulating in an individual's blood serum—CRP is generally present in the body during episodes of acute inflammation or infection, so that a high or increasing amount of CRP in blood serum can be associated with acute infection or inflammation. A blood serum level of CRP greater than 1 mg/dL is usually considered high. Most inflammation and infections result in CRP levels greater than 10 mg/dL. The amount of CRP in subject sera can be quantified using, for example, the DSL-10-42100 ACTIVE® US C-Reactive Protein Enzyme-Linked Immunosorbent Assay (ELISA), developed by Diagnostics Systems Laboratories, Inc. (Webster, Tex.). CRP production is associated with radiological progression in RA. See M. Van Leeuwen et al., Br. J. Rheum. 1993, 32(suppl.):9-13). CRP is thus considered an appropriate alternative to ESR in measuring RA disease activity. See R. Mallya et al., J. Rheum. 1982, 9(2):224-228, and F. Wolfe, J. Rheum. 1997, 24:1477-1485.

The DAS28-CRP can be calculated according to either of the formulas below, with or without the GH factor, where “CRP” represents the amount of this protein present in a subject's blood serum in mg/L, “sqrt” represents the square root, and “ln” represents the natural logarithm:

DAS28-CRP with GH(or DAS28-CRP4)=(0.56*sqrt(TJC28)+0.28*sqrt(SJC28)+0.36*ln(CRP+1))+(0.014*GH)+0.96;or, (a)

DAS28-CRP without GH(or DAS28-CRP3)=(0.56*sqrt(TJC28)+0.28*sqrt(SJC28)+0.36*ln(CRP+1))*1.10+1.15.

The “DAS28-ESR” is a DAS28 assessment wherein the ESR for each subject is also measured (in mm/hour). The DAS28-ESR can be calculated according to the formula:

DAS28-ESR with GH(or DAS28-ESR4)=0.56*sqrt(TJC28)+0.28*sqrt(SJC28)+0.70*ln(ESR)+0.014*GH;or, (a)

DAS28-ESR without GH=0.56*sqrt(TJC28)+0.28*sqrt(SJC28)+0.70*ln(ESR)*1.08+0.16. (b)

Unless otherwise specified herein, the term “DAS28,” as used in the present teachings, can refer to a DAS28-ESR or DAS28-CRP, as obtained by any of the four formulas described above; or, DAS28 can refer to another reliable DAS28 formula as may be known in the art.

A “dataset” is a set of numerical values resulting from evaluation of a sample (or population of samples) under a desired condition. The values of the dataset can be obtained, for example, by experimentally obtaining measures from a sample and constructing a dataset from these measurements; or alternatively, by obtaining a dataset from a service provider such as a laboratory, or from a database or a server on which the dataset has been stored.

In certain embodiments of the present teachings, a dataset of values is determined by measuring at least two biomarkers from the SDMRK group. This dataset is used by an interpretation function according to the present teachings to derive an SDI score (see definition, “SDI score,” below), which provides a quantitative measure of inflammatory disease progression in a subject. In the context of RA, the SDI score thus derived from this dataset is also useful in predicting the rate of change in Sharp score, with a high degree of association, as is shown in the Examples below. The at least two markers can comprise (IL2RA and IL6), (IL2RA and SAA1), (IL6 and SAA1), (IL1B and IL2RA), (TNFRSF11B and IL6), (ICAM1 and IL6), (IL6 and PYD), (CCL22 and IL6), (CHI3L1 and IL6), (CRP and IL6), (IL6 and MMP3), (ICAM3 and IL2RA), (IL6 and VEGFA), (IL6 and RANKL), (ICAM3 and IL6), (IL6 and THBD), (IL6 and MCSF), (IL6 and TNFRSF1A), (IL6 and LEP), (IL6 and IL6R), (IL6 and VCAM1), (IL6 and IL8), (COMP and IL6), (IL2RA and RETN), (IL6 and RETN), (IL2RA and IL6R), (IL6 and MMP1), (TNFRSF11B and RETN), (COMP and IL2RA), (IL1B and IL6), (IL6 and TIMP1), (CHI3L1 and RETN), (IL2RA and LEP), (IL2RA and TIMP1), (CXCL10 and IL6), (EGF and IL6), (IL2RA and RANKL), (IL2RA and MMP3), (IL2RA and THBD), (IL1B and SAA1), (LEP and SAA1), (CRP and IL2RA), (ICTP and IL6), (IL2RA and MCSF) or (ICAM1 and IL2RA).

The term “disease” in the context of the present teachings encompasses any disorder, condition, sickness, ailment, etc. that manifests in, e.g., a disordered or incorrectly functioning organ, part, structure, or system of the body, and results from, e.g., genetic or developmental errors, infection, poisons, nutritional deficiency or imbalance, toxicity, or unfavorable environmental factors.

A “structural damage index score,” or “SDI score,” in the context of the present teachings, is a score that provides a quantitative measure of the rate of change in structural damage to tissue in a subject. In the example of RA, the SDI score relates to the rate of change in joint structural damage. “Joint structural damage” may be abbreviated herein to simply “joint damage” or “structural damage.” A set of data from particularly selected biomarkers, such as markers from the SDMRK or ALLMRK set, is input into an interpretation function according to the present teachings to derive the SDI score. The interpretation function, in some embodiments, can be created from predictive or multivariate modeling based on statistical algorithms. Input to the interpretation function can comprise the results of testing two or more of the SDMRK or ALLMRK set of biomarkers, alone or in combination with clinical parameters and/or clinical assessments, also described herein. In some embodiments, the SDI score is a quantitative measure of structural damage to joint tissue, including tissue erosion and joint space narrowing. In some embodiments, the SDI score relates to structural damage in a subject due to RA disease progression.

A DMARD can be conventional or biologic. Examples of DMARDs that are generally considered conventional include, but are not limited to, MTX, azathioprine (AZA), bucillamine (BUC), chloroquine (CQ), ciclosporin (CSA, or cyclosporine, or cyclosporin), doxycycline (DOXY), hydroxychloroquine (HCQ), intramuscular gold (IM gold), leflunomide (LEF), levofloxacin (LEV), and sulfasalazine (SSZ). Examples of other conventional DMARDs include, but are not limited to, folinic acid, D-penicillamine, gold auranofin, gold aurothioglucose, gold thiomalate, cyclophosphamide, and chlorambucil. Examples of biologic DMARDs (or biologic drugs) include but are not limited to biological agents that target the tumor necrosis factor (TNF)-alpha molecules and the TNF inhibitors, such as infliximab, adalimumab, etanercept and golimumab. Other classes of biologic DMARDs include IL1 inhibitors such as anakinra, T-cell modulators such as abatacept, B-cell modulators such as rituximab, and IL6 inhibitors such as tocilizumab.

“Inflammatory disease” in the context of the present teachings encompasses, without limitation, any disease, as defined herein, resulting from the biological response of vascular tissues to harmful stimuli, including but not limited to such stimuli as pathogens, damaged cells, irritants, antigens and, in the case of autoimmune disease, substances and tissues normally present in the body. Examples of inflammatory disease include RA, atherosclerosis, asthma, autoimmune diseases, chronic inflammation, chronic prostatitis, glomerulonephritis, hypersensitivities, inflammatory bowel diseases, pelvic inflammatory disease, reperfusion injury, transplant rejection, and vasculitis.

“Interpretation function,” as used herein, means the transformation of a set of observed data into a meaningful determination of particular interest; e.g., an interpretation function may be a predictive model that is created by utilizing one or more statistical algorithms to transform a dataset of observed biomarker data into a meaningful determination of disease progression or the disease stage of a subject.

“Measuring” or “measurement” in the context of the present teachings refers to determining the presence, absence, quantity, amount, or effective amount of a substance in a clinical or subject-derived sample, including the concentration levels of such substances, or evaluating the values or categorization of a subject's clinical parameters.

“Performance” in the context of the present teachings relates to the quality and overall usefulness of, e.g., a model, algorithm, or diagnostic or prognostic test. Factors to be considered in model or test performance include, but are not limited to, the clinical and analytical accuracy of the test, use characteristics such as stability of reagents and various components, ease of use of the model or test, health or economic value, and relative costs of various reagents and components of the test.

A “population” is any grouping of subjects of like specified characteristics. The grouping could be according to, for example but without limitation, clinical parameters, clinical assessments, therapeutic regimen, disease status (e.g. with disease or healthy), level of disease progression, etc. In the context of using the SDI score in comparing disease progression between populations, an aggregate value can be determined based on the observed SDI scores of the subjects of a population; e.g., at particular timepoints in a longitudinal study. The aggregate value can be based on, e.g., any mathematical or statistical formula useful and known in the art for arriving at a meaningful aggregate value from a collection of individual datapoints; e.g., mean, median, median of the mean, etc.

A “predictive model,” which term may be used synonymously herein with “multivariate model” or simply a “model,” is a mathematical construct developed using a statistical algorithm or algorithms for classifying sets of data. The term “predicting” refers to generating a value for a datapoint without actually performing the clinical diagnostic procedures normally or otherwise required to produce that datapoint; “predicting” as used in this modeling context should not be understood solely to refer to the power of a model to predict a particular outcome. Predictive models can provide an interpretation function; e.g., a predictive model can be created by utilizing one or more statistical algorithms or methods to transform a dataset of observed data into a meaningful determination of disease progression or the disease stage of a subject. See Calculation of the SDI score for some examples of statistical tools useful in model development.

A “prognosis” is a prediction as to the likely outcome of a disease. Prognostic estimates are useful in, e.g., determining an appropriate therapeutic regimen for a subject.

A “quantitative dataset,” as used in the present teachings, refers to the data derived from, e.g., detection and composite measurements of a plurality of biomarkers (i.e., two or more) in a subject sample. The quantitative dataset can be used in the identification, monitoring and treatment of disease states, and in characterizing the biological condition of a subject. It is possible that different biomarkers will be detected depending on the disease state or physiological condition of interest.

A “sample” in the context of the present teachings refers to any biological sample that is isolated from a subject. A sample can include, without limitation, a single cell or multiple cells, fragments of cells, an aliquot of body fluid, whole blood, platelets, serum, plasma, red blood cells, white blood cells or leucocytes, endothelial cells, tissue biopsies, synovial fluid, lymphatic fluid, ascites fluid, and interstitial or extracellular fluid. The term “sample” also encompasses the fluid in spaces between cells, including gingival crevicular fluid, bone marrow, cerebrospinal fluid (CSF), saliva, mucous, sputum, semen, sweat, urine, or any other bodily fluids. “Blood sample” can refer to whole blood or any fraction thereof, including blood cells, red blood cells, white blood cells or leucocytes, platelets, serum and plasma. Samples can be obtained from a subject by means including but not limited to venipuncture, excretion, ejaculation, massage, biopsy, needle aspirate, lavage, scraping, surgical incision, or intervention or other means known in the art.

A “score” is a value or set of values selected so as to provide a quantitative measure of a variable or characteristic of a subject's condition, and/or to discriminate, differentiate or otherwise characterize a subject's condition. The value(s) comprising the score can be based on, for example, a measured amount of one or more sample constituents obtained from the subject, or from clinical parameters, or from clinical assessments, or any combination thereof. In certain embodiments the score can be derived from a single constituent, parameter or assessment, while in other embodiments the score is derived from multiple constituents, parameters and/or assessments. The score can be based upon or derived from an interpretation function; e.g., an interpretation function derived from a particular predictive model using any of various statistical algorithms known in the art. A “change in score” can refer to the absolute change in score, e.g. from one timepoint to the next, or the percent change in score, or the change in the score per unit time (i.e., the rate of score change).

“Statistically significant” in the context of the present teachings means an observed alteration is greater than what would be expected to occur by chance alone (e.g., a “false positive”). Statistical significance can be determined by any of various methods well-known in the art. An example of a commonly used measure of statistical significance is the p-value. The p-value represents the probability of obtaining a datapoint equivalent to or more extreme than a given result, where the datapoint is the result of random chance alone. A result is often considered highly significant (not random chance) at a p-value less than or equal to 0.05.

A “subject” in the context of the present teachings is generally a mammal. The subject can be a patient. The term “mammal” as used herein includes but is not limited to a human, non-human primate, dog, cat, mouse, rat, cow, horse, and pig. Mammals other than humans can be advantageously used as subjects that represent animal models of inflammation. A subject can be male or female. A subject can be one who has been previously diagnosed or identified as having an inflammatory disease. A subject can be one who has already undergone, or is undergoing, a therapeutic intervention for an inflammatory disease. A subject can also be one who has not been previously diagnosed as having an inflammatory disease; e.g., a subject can be one who exhibits one or more symptoms or risk factors for an inflammatory condition, or a subject who does not exhibit symptoms or risk factors for an inflammatory condition, or a subject who is asymptomatic for inflammatory disease.

A “therapeutic regimen,” “therapy” or “treatment(s),” as described herein, includes all clinical management of a subject and interventions, whether biological, chemical, physical, or a combination thereof, intended to sustain, ameliorate, improve, or otherwise alter the condition of a subject. These terms may be used synonymously herein. Treatments include but are not limited to administration of prophylactics or therapeutic compounds (including conventional DMARDs, biologic DMARDs, non-steroidal anti-inflammatory drugs (NSAID's) such as COX-2 selective inhibitors, and corticosteroids), exercise regimens, physical therapy, dietary modification and/or supplementation, bariatric surgical intervention, administration of pharmaceuticals and/or anti-inflammatories (prescription or over-the-counter), and any other treatments known in the art as efficacious in preventing, delaying the onset of, or ameliorating disease. A “response to treatment” includes a subject's response to any of the above-described treatments, whether biological, chemical, physical, or a combination of the foregoing. A “treatment course” relates to the dosage, duration, extent, etc. of a particular treatment or therapeutic regimen.

### Use of the Present Teachings in the Diagnosis and Prognosis of Disease

In some embodiments of the present teachings, biomarkers selected from the SDMARK or ALLMRK group can be used in the derivation of an SDI score, as described herein, which SDI score can be used to provide improved diagnosis, prognosis and monitoring of disease stage and/or disease progression in inflammatory disease and in autoimmune disease. In certain embodiments, the SDI score can be used to provide improved diagnosis, prognosis and monitoring of disease stage and/or disease progression in RA.

Identifying the stage and/or rate of inflammatory disease progression in a subject can allow for a prognosis of the disease to be made, and thus for the informed selection of, the initiation of, or increasing various therapeutic regimens in order to delay, reduce or prevent the disease progressing to a more advanced disease state. In some embodiments, therefore, subjects can be classified as being at a particular stage in the progression of inflammatory disease, based on the determination of their SDI scores. Treatment can then be initiated or accelerated in order to prevent or delay the further progression of inflammatory disease. In other embodiments, subjects that are classified via their SDI scores as being at a particular stage of inflammatory disease progression, where improvement in the subject is seen, can then have their treatment decreased or discontinued.

Blood-based biomarkers that report on the current rate of joint structural damage processes could also present a powerful prognostic approach to identifying subjects at highest risk of accelerated bone and cartilage damage, whether due to erosion or joint space narrowing or another cause. In some embodiments of the present teachings, biomarkers from the SDMRK or ALLMRK group can be measured from subjects' or a subject's samples obtained at various timepoints (e.g., longitudinally), to obtain a series of SDI scores, and the scores can then be associated with radiological results (such as, e.g., those obtained by TSS) at various timepoints. See Example 2. The association of the SDI scores with, e.g., TSS results can be analyzed statistically for correlation (e.g., Spearman correlation) using multivariate analysis to create longitudinal hierarchical linear models and ensure accuracy. Serum biomarkers of the SDMRK or ALLMRK group can thus be used as an alternative to US/radiological results in arriving at a clinical assessment of disease progression, in estimating rates of progression of disease, and predicting joint damage in RA. Predictive models using biomarkers can thus identify subjects who may need more aggressive and/or earlier treatment, and can thereby improve subject outcomes. In other embodiments, the SDI scores obtained longitudinally (over time) from one subject can be compared with each other, for observations of longitudinal trending as an effect of, e.g., choice of therapeutic regimen or as a result of the subject's response to treatment.

The present teachings indicate that SDMRK- or ALLMRK-derived formulas developed in cross-sectional analysis are a strong predictor of inflammatory disease progression over time; e.g., longitudinally. See Example 2. This is a significant finding from a clinical care perspective, because currently no tests are available to accurately measure and track RA disease progression over time in the clinic. Several studies have demonstrated that optimal treatment intervention can dramatically improve clinical outcomes. See Y P M Goekoop-Ruiterman et al., Ann. Rheum. Dis. 2009 (Epublication Jan. 20, 2009); C. Grigor et al., Lancet 2004, 364:263-269; SMM Verstappen et al., Ann. Rheum. Dis. 2007, 66:1443-1449. In these studies disease activity levels are frequently monitored and treatment is increased in nonremission subjects. This concept of treating to remission has been denoted, “Tight Control.” Numbers of subjects achieving low disease activity and remission in disease activity in Tight Control trials is high. In addition, Tight Control cohorts achieve dramatically improved outcomes relative to cohorts receiving standard of care; indeed, in clinical practice remission is uncommon. This is in part due to a lack of specific and sensitive tools to quantitatively monitor disease activity in a real-world clinic. Monitoring in these controlled trials is via clinical trial measures that are unsuitable for a real-world clinic. The tests to monitor inflammatory disease progression that are developed from various embodiments of the present teachings will augment the monitoring of disease activity and enhance Tight Control practices, and result in improved control of disease activity and improved clinical outcomes.

In regards to the need for early and accurate diagnosis of RA, recent advances in RA treatment provide a means for more profound disease management and optimal treatment of RA within the first months of symptom onset, which in turn result in significantly improved outcomes. See F. Wolfe, Arth. Rheum. 2000, 43(12):2751-2761; M. Matucci-Cerinic, Clin. Exp. Rheum. 2002, 20(4):443-444; and, V. Nell et. al., Lancet 2005, 365(9455):199-200. Unfortunately, most subjects do not receive optimal treatment within this narrow window of opportunity, resulting in poorer outcomes and irreversible joint damage, in part because of the limits of current diagnostic laboratory tests. Numerous difficulties exist in diagnosing the RA subject. This is in part because, at the early stage of RA, symptoms may not be fully differentiated, and also because diagnostic tests for RA have traditionally been developed based on physical manifestations of the disease, and not on the biological basis of the disease per se. In various embodiments of the present teachings, multi-biomarker algorithms can be derived from biomarkers of the SDMRK set, which have diagnostic potential. See Example 4. This aspect of the present teachings has the potential to improve both the accuracy of RA diagnosis, and the speed of detection of RA.

In some embodiments of the present teachings, the SDI score, derived as described herein, can be used to rate inflammatory disease progression; e.g., as high or low. In some embodiments of the present teachings, autoimmune disease progression can be so rated. In other embodiments, RA disease progression can be so rated. Using RA disease as an example, because the SDI score correlates well and with high accuracy with clinical assessments of the rate of change in joint damage in RA (e.g., change in total Sharp scores), SDI cut-off scores can be set at predetermined levels to indicate levels of RA disease progression vis-à-vis joint damage, and to correlate with the cut-offs traditionally established for rating RA progression. See Example 3.

These properties of the SDMRK set of biomarkers in predicting rate of change in joint damage can be used for several purposes. On a subject-specific basis, they provide a context for understanding the relative level of disease progression. The SDMRK-based rating of disease progression can be used, e.g., to guide the clinician in determining treatment, in setting a treatment course, and/or to inform the clinician that the subject is in remission. Moreover, it provides a means to more accurately assess and document the quantitative level of disease progression in a subject. It is also useful from the perspective of assessing clinical differences among populations of subjects within a practice. For example, this tool can be used to assess the relative efficacy of different RA treatment modalities.

### Subject Screening

Certain embodiments of the present teachings can also be used to screen subject populations in any number of settings. For example, a health maintenance organization, public health entity or school health program can screen a group of subjects to identify those requiring interventions, as described above. Other embodiments of these teachings can be used to collect inflammatory disease progression data on one or more populations of subjects, to identify subject disease progression status in the aggregate in order to, e.g., determine effectiveness of the clinical management of a population, or determine gaps in clinical management. Insurance companies (e.g., health, life, or disability) may request the screening of applicants in the process of determining coverage or pricing, or existing clients for possible intervention. Data collected in such population screens, particularly when tied to clinical progression in conditions such as inflammatory and autoimmune diseases and, e.g., RA, will be of value in the operations of, for example, health maintenance organizations, public health programs and insurance companies.

Data arrays or collections of subject screening data can be stored in machine-readable media and used in any number of health-related data management systems to provide improved healthcare services, cost-effective healthcare, and improved insurance operation, among other things. See, e.g., U.S. Patent Application publication no. 2002/0038227; U.S. Patent Application publication no. 2004/0122296; U.S. Patent Application publication no. 2004/0122297; and U.S. Pat. No. 5,018,067. Such systems can access the data directly from internal data storage or remotely from one or more data storage sites as further detailed herein. Thus, in a health-related data management system, wherein it is important to manage inflammatory disease progression for a population in order to reduce disease-related disability and surgery, and thus reduce health costs in the aggregate, various embodiments of the present teachings provide an improvement comprising the use of a data array encompassing the biomarker measurements as defined herein, and/or the resulting evaluation of disease status, activity and progression from those biomarker measurements.

### Measuring Accuracy and Performance of the Present Teachings

The performance of embodiments of the present teachings can be assessed in any of various ways. Where the embodiment of the present teachings is a predictive model, or a test, assay, method or procedure (diagnostic, prognostic, or other), for example, the assessment of performance of that embodiment can relate to the ability of the predictive model or test to determine the inflammatory disease progression status of or rate of progression in a subject or population. In other embodiments, the performance assessment can relate to the accuracy of the predictive model or test in distinguishing between subjects at a particular stage of inflammatory disease progression or who exhibit different rates of disease progression. In other embodiments, the assessment relates to the accuracy of the predictive model or test in distinguishing between rates of inflammatory disease progression in one subject at different timepoints.

The ability of the predictive model or test in distinguishing between rates of progression can be based on whether the subject or subjects have a significant alteration in the levels of one or more biomarkers. In some embodiments, a significant alteration can mean that the composite measurement of the biomarkers, as represented by the SDI score (computed by the SDI formula that is generated by the predictive model) is different than some predetermined SDI cut-off point (or threshold value) for those biomarkers when input to the SDI formula as described herein. This significant alteration in biomarker levels as reflected in differing SDI scores can therefore indicate that the subject is at a particular stage in inflammatory disease progression, or the subject's disease is progressing at a particular rate. The difference in the composite levels of biomarkers between the subject and normal, as represented in each by the SDI score, in those embodiments where such comparisons are done, will be statistically significant, and can be an increase or a decrease in SDI score.

In some embodiments of the present teachings, an SDI score is derived from measuring the levels of one or more biomarkers, and this score alone, without comparison to some predetermined cut-off point (or threshold or normal value) for those biomarkers, indicates that the subject is experiencing a particular rate of change in joint damage. As noted below, achieving statistical significance and thus analytical and clinical accuracy for such measurements may require that combinations of two or more biomarkers be used together in panels, and combined with mathematical algorithms derived from predictive models, in order to obtain a statistically significant SDI score.

Use of statistical values such as the area under the curve (AUC), and specifically the AUC as it pertains to the area under the receiver operating characteristic (ROC) curve (AUROC curve), encompassing all potential threshold or cut-off point values, is generally used to quantify predictive model performance. As is known in the art, the ROC curve is a graphical plot of the sensitivity, or true positives, versus (1—specificity), or false positives, for a binary (yes/no) classifier as its discrimination threshold is varied. Acceptable degrees of accuracy can be defined accordingly. In certain embodiments of the present teachings, for example, an acceptable degree of accuracy for a binary classifier predictive model can be one in which the AUROC curve is 0.60 or higher.

In general, defining the degree of accuracy for the relevant predictive model or test (e.g., cut-off points on a ROC curve), defining an acceptable AUC value, and determining the acceptable ranges in relative concentration of what constitutes an effective amount of the biomarkers of the present teachings, allows one of skill in the art to use the biomarkers of the present teachings to identify the rate of change in joint damage in subjects or populations with a pre-determined level of predictability and performance.

In various embodiments of the present teachings, measurements from multiple biomarkers, such as those of the SDMRK set, can be combined into a single value, the SDI score, using various statistical analyses and modeling techniques as described herein. Because the SDI score demonstrates strong association with established RA disease progression assessments, such as the rate of change in total Sharp score, the SDI score can provide a quantitative measure for monitoring the subject's RA disease progression as evidenced by rate of change in joint damage, and, by extension in certain embodiments, the subject's response to treatment. Example 1, e.g., demonstrates that SDI scores are strongly associated with the rate of change in total Sharp score in RA subjects; thus, SDI provides an accurate quantitative measure of the rate of the RA subject's disease progression.

### Calculation of the SDI Score

In some embodiments of the present teachings, inflammatory disease progression in a subject is measured by: determining the levels in subject serum of two or more biomarkers selected from the SDMRK set, then applying an interpretation function to transform the biomarker levels into a single SDI score, which score provides a quantitative measure of inflammatory disease progression in the subject, correlating well with traditional clinical assessments of inflammatory disease progression (e.g., the rate of change in Sharp score for measuring structural damage in RA), as demonstrated in the Examples below. In some embodiments, the inflammatory disease progression so measured relates to an autoimmune disease. In some embodiments, the inflammatory disease progression so measured relates to RA. In some embodiments, the SDI score represents cartilage erosion and joint space narrowing.

In some embodiments, the interpretation function is based on a predictive model. Established statistical algorithms and methods well-known in the art, useful as models or useful in designing predictive models, can include but are not limited to: analysis of variants (ANOVA); Bayesian networks; boosting and Ada-boosting; bootstrap aggregating (or bagging) algorithms; decision trees classification techniques, such as Classification and Regression Trees (CART), boosted CART, Random Forest (RF), Recursive Partitioning Trees (RPART), and others; Curds and Whey (CW); Curds and Whey-Lasso; dimension reduction methods, such as principal component analysis (PCA) and factor rotation or factor analysis; discriminant analysis, including Linear Discriminant Analysis (LDA), Eigengene Linear Discriminant Analysis (ELDA), and quadratic discriminant analysis; Discriminant Function Analysis (DFA); factor rotation or factor analysis; genetic algorithms; Hidden Markov Models; kernel based machine algorithms such as kernel density estimation, kernel partial least squares algorithms, kernel matching pursuit algorithms, kernel Fisher's discriminate analysis algorithms, and kernel principal components analysis algorithms; linear regression and generalized linear models, including or utilizing Forward Linear Stepwise Regression, Lasso (or LASSO) shrinkage and selection method, and Elastic Net regularization and selection method; glmnet (Lasso and Elastic Net-regularized generalized linear model); Logistic Regression (LogReg); meta-learner algorithms; nearest neighbor methods for classification or regression, e.g. Kth-nearest neighbor (KNN); non-linear regression or classification algorithms; neural networks; partial least square; rules based classifiers; shrunken centroids (SC); sliced inverse regression; Standard for the Exchange of Product model data, Application Interpreted Constructs (StepAIC); super principal component (SPC) regression; and, Support Vector Machines (SVM) and Recursive Support Vector Machines (RSVM), among others. Additionally, clustering algorithms as are known in the art can be useful in determining subject sub-groups.

Logistic Regression is the traditional predictive modeling method of choice for dichotomous response variables; e.g., treatment 1 versus treatment 2. It can be used to model both linear and non-linear aspects of the data variables and provides easily interpretable odds ratios.

Discriminant Function Analysis (DFA) uses a set of analytes as variables (roots) to discriminate between two or more naturally occurring groups. DFA is used to test analytes that are significantly different between groups. A forward step-wise DFA can be used to select a set of analytes that maximally discriminate among the groups studied. Specifically, at each step all variables can be reviewed to determine which will maximally discriminate among groups. This information is then included in a discriminative function, denoted a root, which is an equation consisting of linear combinations of analyte concentrations for the prediction of group membership. The discriminatory potential of the final equation can be observed as a line plot of the root values obtained for each group. This approach identifies groups of analytes whose changes in concentration levels can be used to delineate profiles, diagnose and assess therapeutic efficacy. The DFA model can also create an arbitrary score by which new subjects can be classified as either “healthy” or “diseased.” To facilitate the use of this score for the medical community the score can be rescaled so a value of 0 indicates a healthy individual and scores greater than 0 indicate increasing disease progression.

Classification and regression trees (CART) perform logical splits (if/then) of data to create a decision tree. All observations that fall in a given node are classified according to the most common outcome in that node. CART results are easily interpretable—one follows a series of if/then tree branches until a classification results.

Support vector machines (SVM) classify objects into two or more classes. Examples of classes include sets of treatment alternatives, sets of diagnostic alternatives, or sets of prognostic alternatives. Each object is assigned to a class based on its similarity to (or distance from) objects in the training data set in which the correct class assignment of each object is known. The measure of similarity of a new object to the known objects is determined using support vectors, which define a region in a potentially high dimensional space.

The process of bootstrap aggregating, or “bagging,” is computationally simple. In the first step, a given dataset is randomly resampled a specified number of times (e.g., thousands), effectively providing that number of new datasets, which are referred to as “bootstrapped resamples” of data, each of which can then be used to build a model. Then, in the example of classification models, the class of every new observation is predicted by the number of classification models created in the first step. The final class decision is based upon a “majority vote” of the classification models; i.e., a final classification call is determined by counting the number of times a new observation is classified into a given group, and taking the majority classification (33%+ for a three-class system). In the example of logistical regression models, if a logistical regression is bagged 1000 times, there will be 1000 logistical models, and each will provide the probability of a sample belonging to class 1 or 2.

Curds and Whey (CW) using ordinary least squares (OLS) is another predictive modeling method. See L. Breiman and JH Friedman, J. Royal. Stat. Soc. B 1997, 59(1):3-54. This method takes advantage of the correlations between response variables to improve predictive accuracy, compared with the usual procedure of performing an individual regression of each response variable on the common set of predictor variables X. In CW, Y=XB*S, where Y=(yₖⱼ) with k for the k^{th} subject and j for j^{th} response (j=1 for TJC, j=2 for SJC, etc.), B is obtained using OLS, and S is the shrinkage matrix computed from the canonical coordinate system. Another method is Curds and Whey and Lasso in combination (CW-Lasso). Instead of using OLS to obtain B, as in CW, here Lasso is used, and parameters are adjusted accordingly for the Lasso approach.

Many of these techniques are useful either combined with a biomarker selection technique (such as, for example, forward selection, backwards selection, or stepwise selection), or for complete enumeration of all potential panels of a given size, or genetic algorithms, or they can themselves include biomarker selection methodologies in their own techniques. These techniques can be coupled with information criteria, such as Akaike's Information Criterion (AIC), Bayes Information Criterion (BIC), or cross-validation, to quantify the tradeoff between the inclusion of additional biomarkers and model improvement, and to minimize overfit. The resulting predictive models can be validated in other studies, or cross-validated in the study they were originally trained in, using such techniques as, for example, Leave-One-Out (LOO) and 10-fold cross-validation (10-fold CV).

One example of an interpretation function derived from a statistical modeling method such as those described above, providing an SDI score, is given as follows. For subject k, SDI represents the rate of change in total Sharp score (ATSS) over a particular time interval, e.g. years or weeks: ΔTSSₖ/ΔTₖ. An example of such a model using biomarker concentrations to supply this SDI would be: SDIₖ=β₀+Σᵢ₌₁ⁿβᵢXᵢₖ+eₖ, in which X is the serum biomarker concentration, i is the biomarker, n is the number of X biomarkers, β is the coefficient for the ith marker, and e is the error prediction for the kth subject. Marker data can be taken from different time points. See Example 4. SDI scores thus obtained for RA subjects with a known clinical assessments, such as the total Sharp score, can then be compared to those known assessments to determine the level of correlation between the two assessments, and hence determine the accuracy of the SDI score and its underlying predictive model. See Examples below (e.g., Example 1) for examples of such correlations, specific formulas and constants, and the derivations thereof.

In some embodiments of the present teachings, it is not required that the SDI score be compared to any pre-determined “reference,” “normal,” “control,” “standard,” “healthy,” “pre-disease” or other like index or reference value, in order for the SDI score to provide a quantitative measure of the rate of change in joint damage in the subject, and thus the rate of inflammatory disease progression.

In other embodiments of the present teachings, the amount of the biomarker(s) can be measured in a sample and used to derive an SDI score, which SDI score is then compared to a “normal” or “control” level or value, utilizing techniques such as, e.g., reference or discrimination limits or risk defining thresholds, in order to define cut-off points and/or abnormal values for the rate of inflammatory disease progression. The normal level then is the level of one or more biomarkers or combined biomarker indices typically found in a subject who is not suffering from the inflammatory disease under evaluation. Other terms for “normal” or “control” are, e.g., “reference,” “index,” “baseline,” “standard,” “healthy,” “pre-disease,” etc. Such normal levels can vary, based on whether a biomarker is used alone or in a formula combined with other biomarkers to output a score. Alternatively, the normal level can be a database of biomarker patterns from previously tested subjects who did not convert to the inflammatory disease under evaluation over a clinically relevant time period. Reference (normal, control) values can also be derived from, e.g., a control subject or population whose rate of inflammatory disease progression is known. In some embodiments of the present teachings, the reference value can be derived from one or more subjects who have been exposed to treatment for inflammatory disease, or from one or more subjects who are at low risk of developing inflammatory disease, or from subjects who have shown improvements in inflammatory disease progression factors (such as, e.g., clinical parameters as defined herein) as a result of exposure to treatment. In some embodiments the reference value can be derived from one or more subjects who have not been exposed to treatment; for example, samples can be collected from (a) subjects who have received initial treatment for inflammatory disease, and (b) subjects who have received subsequent treatment for inflammatory disease, to monitor the efficacy of the treatment in reducing the rate of disease progression. A reference value can also be derived from algorithms or computed indices from population studies.

### Systems for Implementing Disease Progression Tests

Tests for measuring the rate of disease progression according to various embodiments of the present teachings can be implemented on a variety of systems typically used for obtaining test results, such as results from immunological or nucleic acid detection assays. Such systems may comprise modules that automate sample preparation, that automate testing such as measuring biomarker levels, that facilitate testing of multiple samples, and/or are programmed to assay the same test or different tests on each sample. In some embodiments, the testing system comprises one or more of a sample preparation module, a clinical chemistry module, and an immunoassay module on one platform. Testing systems are typically designed such that they also comprise modules to collect, store, and track results, such as by connecting to and utilizing a database residing on hardware. Examples of these modules include physical and electronic data storage devices as are well-known in the art, such as a hard drive, flash memory, and magnetic tape. Test systems also generally comprise a module for reporting and/or visualizing results. Some examples of reporting modules include a visible display or graphical user interface, links to a database, a printer, etc. See section Machine-readable storage medium, below.

One embodiment of the present invention comprises a system for determining the rate of inflammatory disease progression of a subject. In some embodiments, the system employs a module for applying an SDMRK or ALLMRK formula to an input comprising the measured levels of biomarkers in a panel, as described herein, and outputting a rate of disease progression index score. In some embodiments, the measured biomarker levels are test results, which serve as inputs to a computer that is programmed to apply the SDMRK or ALLMRK formula. The system may comprise other inputs in addition to or in combination with biomarker results in order to derive an output rate of disease progression index; e.g., one or more clinical parameters such as therapeutic regimen, TJC, SJC, morning stiffness, arthritis of three or more joint areas, arthritis of hand joints, symmetric arthritis, rheumatoid nodules, radiographic changes and other imaging, gender/sex, age, race/ethnicity, disease duration, height, weight, body-mass index, family history, CCP status, RF status, ESR, smoker/non-smoker, etc. In some embodiments the system can apply the SDMRK/ALLMRK formula to biomarker level inputs, and then output a disease activity score that can then be analyzed in conjunction with other inputs such as other clinical parameters. In other embodiments, the system is designed to apply the SDMRK/ALLMRK formula to the biomarker and non-biomarker inputs (such as clinical parameters) together, and then report a composite output a rate of disease progression index.

A number of testing systems are presently available that could be used to implement various embodiments of the present teachings. See, for example, the ARCHITECT series of integrated immunochemistry systems—high-throughput, automated, clinical chemistry analyzers (ARCHITECT is a registered trademark of Abbott Laboratories, Abbott Park, Ill. 60064). See C. Wilson et al., “Clinical Chemistry Analyzer Sub-System Level Performance,” American Association for Clinical Chemistry Annual Meeting, Chicago, Ill., Jul. 23-27, 2006; and, H J Kisner, “Product development: the making of the Abbott ARCHITECT,” Clin. Lab. Manage. Rev. 1997 Nov.-Dec., 11(6):419-21; A. Ognibene et al., “A new modular chemiluminescence immunoassay analyser evaluated,” Clin. Chem. Lab. Med. 2000 March, 38(3):251-60; J W Park et al., “Three-year experience in using total laboratory automation system,” Southeast Asian J. Trop. Med. Public Health 2002, 33 Suppl 2:68-73; D. Pauli et al., “The Abbott Architect c8000: analytical performance and productivity characteristics of a new analyzer applied to general chemistry testing,” Clin. Lab. 2005, 51(1-2):31-41.

Another testing system useful for embodiments of the present teachings is the VITROS system (VITROS is a registered trademark of Johnson & Johnson Corp., New Brunswick, N.J.)—an apparatus for chemistry analysis that is used to generate test results from blood and other body fluids for laboratories and clinics. Another testing system is the DIMENSION system (DIMENSION is a registered trademark of Dade Behring Inc., Deerfield Ill.)—a system for the analysis of body fluids, comprising computer software and hardware for operating the analyzers, and analyzing the data generated by the analyzers.

The testing required for various embodiments of the present teachings, e.g. measuring biomarker levels, can be performed by laboratories such as those certified under the Clinical Laboratory Improvement Amendments (42 U.S.C. Section 263(a)), or by laboratories certified under any other federal or state law, or the law of any other country, state or province that governs the operation of laboratories that analyze samples for clinical purposes. Such laboratories include, for example, Laboratory Corporation of America, 358 South Main Street, Burlington, N.C. 27215 (corporate headquarters); Quest Diagnostics, 3 Giralda Farms, Madison, N.J. 07940 (corporate headquarters); and other reference and clinical chemistry laboratories.

### Biomarker Selection

The biomarkers and methods of the present teachings allow one of skill in the art to quantitatively measure, and thus monitor or assess, inflammatory and/or autoimmune disease progression in a subject with a high degree of accuracy. In RA, for example, disease progression is determined as the rate of change in joint damage. Approximately 100 markers were initially identified as being associated with the biology of disease. For the initial comparison of observed biomarkers with RA disease progression, biomarker levels were determined from RA subjects at different stages of disease, or the subjects themselves at different timepoints in the evaluation of disease. For example, the rate of change in joint damage for each subject was first determined based upon traditional clinical parameters, such as X-ray, ultrasound or MRI, which either measure the cumulative or current level of joint damage of each subject.

SDMRK Group of Markers

Analyte biomarkers can be selected for use in the present teachings to form a panel or group of markers. Table 1 describes several specific biomarkers, collectively referred to as the SDMRK group of biomarkers. The present teachings describe the SDMRK set of biomarkers as one set or panel of markers that is strongly associated with the progression of inflammatory disease, and especially RA, when used in particular combinations to derive an SDI score. See Example 1. As an example, one embodiment of the present teachings comprises a method of determining the rate of change in joint damage in a subject comprising measuring the levels of at least two biomarkers from Table 1, wherein the at least two biomarkers are selected from the group consisting of chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); then, using these observed biomarker levels to derive a structural damage index score for the subject via an interpretation function, which score provides a quantitative measure of RA disease activity in that subject.

One skilled in the art will recognize that the SDMRK biomarkers presented herein encompass all forms and variants of these biomarkers, including but not limited to polymorphisms, isoforms, mutants, derivatives, transcript variants, precursors (including nucleic acids and pre- or pro-proteins), cleavage products, receptors (including soluble and transmembrane receptors), ligands, protein-ligand complexes, protein-protein homo- or heteropolymers, post-translationally modified variants (such as, e.g., via cross-linking or glycosylation), fragments, and degradation products, as well as any multi-unit nucleic acid, protein, and glycoprotein structures comprising any of the SDMRK biomarkers as constituent subunits of the fully assembled structure.

TABLE 1

| SDMRK | Official | Official | Other | NCBI | Entrez |
|---|---|---|---|---|---|
| No. | Symbol* | Name* | Name(s) | RefSeq | Gene ID |
| 1 | CCL22 | Chemokine | MDC; A-152E5.1; | NP_002981.2 | 6367 |
| | | (C-C motif) | ABCD-1; DC/B-CK; | | |
| | | ligand 22 | MGC34554; | | |
| | | | SCYA22; STCP-1; | | |
| | | | CC chemokine | | |
| | | | STCP-1; | | |
| | | | macrophage-derived | | |
| | | | chemokine; small | | |
| | | | inducible cytokine | | |
| | | | A22; small inducible | | |
| | | | cytokine subfamily A | | |
| | | | (Cys-Cys), member | | |
| | | | 22; stimulated T cell | | |
| | | | chemotactic protein 1 | | |
| 2 | CHI3L1 | Chitinase 3- | YKL-40; ASRT7; | NP_001267.2 | 1116 |
| | | like | DKFZp686N19119; | | |
| | | 1 (cartilage | FLJ38139; GP39; | | |
| | | glycoprotein- | HC-gp39; HCGP-3P; | | |
| | | 39) | YYL-40; cartilage | | |
| | | | glycoprotein-39; | | |
| | | | chitinase 3-like 1 | | |
| 3 | COMP | Cartilage | MED; EDM1; EPD1; | | |
| | | oligomeric | PSACH; THBS5; | | |
| | | matrix | MGC131819; | | |
| | | protein | MGC149768; TSP5; | | |
| | | | thrombospondin-5 | | |
| | | | pseudoachondroplasia | | |
| | | | (epiphyseal | | |
| | | | dysplasia 1, | | |
| | | | multiple); | | |
| | | | cartilage oligomeric | | |
| | | | matrix protein | | |
| | | | (pseudoachondroplasia, | | |
| | | | epiphyseal | | |
| | | | dysplasia 1, multiple) | | |
| 4 | CRP | C-reactive | MGC149895; | NP_000558.2 | 1401 |
| | | protein, | MGC88244; PTX1 | | |
| | | pentraxin- | | | |
| | | related | | | |
| 5 | CSF1 | Colony | RP11-195M16.2; | NP_000748.3 | 1435 |
| | | stimulating | MCSF; MGC31930; | NP_757349.1 | |
| | | factor 1 | OTTHUMP00000013364; | NP_757350.1 | |
| | | (macrophage) | OTTHUMP00000013365; | NP_757351.1 | |
| | | | lanimostim; | | |
| | | | macrophage colony | | |
| | | | stimulating factor; | | |
| | | | macrophage colony- | | |
| | | | stimulating factor 1 | | |
| 6 | CXCL10 | Chemokine | C7; IFI10; INP10; | NP_001556.2 | 3627 |
| | | (C—X—C | SCYB10; crg-2; gIP- | | |
| | | motif) ligand | 10; mob-1; 10 kDa | | |
| | | 10 | interferon gamma- | | |
| | | | induced protein; C-X- | | |
| | | | C motif chemokine | | |
| | | | 10; gamma-IP10; | | |
| | | | interferon-inducible | | |
| | | | cytokine IP-10; | | |
| | | | protein 10 from | | |
| | | | interferon (gamma)- | | |
| | | | induced cell line; | | |
| | | | small inducible | | |
| | | | cytokine subfamily B | | |
| | | | (Cys-X-Cys), | | |
| | | | member 10; small- | | |
| | | | inducible cytokine | | |
| | | | B10 | | |
| 7 | EGF | Epidermal | HOMG4; URG; beta- | NP_001954.2 | 1950 |
| | | growth factor | urogastrone; | | |
| | | (beta- | epidermal growth | | |
| | | urogastrone) | factor | | |
| 8 | ICAM1 | Intercellular | intercellular adhesion | NP_000192.2 | 3383 |
| | | adhesion | molecule 1 (CD54); | | |
| | | molecule 1 | human rhinovirus | | |
| | | | receptor; ICAM-1 | | |
| 9 | ICAM3 | Intercellular | CD50; CDW50; | NP_002153.2 | 3385 |
| | | adhesion | ICAM-R | | |
| | | molecule 3 | | | |
| 10 | N/A | N/A | ICTP; C-telopeptide | N/A | N/A |
| | | | pyridinoline | | |
| | | | crosslinks of Type I | | |
| | | | collagen | | |
| 11 | IL1B | Interleukin 1, | IL-1; IL1-BETA; | NP_000567.1 | 3553 |
| | | Beta | IL1β; IL1F2; | | |
| | | | catabolin; | | |
| | | | preinterleukin 1 beta; | | |
| | | | pro-interleukin-1-beta | | |
| 12 | IL2RA | Interleukin 2 | RP11-536K7.1; | NP_000408.1 | 3559 |
| | | receptor, | CD25; IDDM10; | | |
| | | alpha | IL2R; TCGFR; | | |
| | | | IL-2 receptor subunit | | |
| | | | alpha; IL-2R subunit | | |
| | | | alpha; | | |
| | | | OTTHUMP00000019031; | | |
| | | | TAC antigen; | | |
| | | | interleukin-2 receptor | | |
| | | | subunit alpha; p55 | | |
| 13 | IL6 | Interleukin 6 | IL-6; BSF2; HGF; | NP_000591.1 | 3569 |
| | | (interferon, | HSF; IFNB2; B cell | | |
| | | beta 2) | stimulatory factor-2; | | |
| | | | B-cell differentiation | | |
| | | | factor; CTL | | |
| | | | differentiation factor; | | |
| | | | OTTHUMP00000158544; | | |
| | | | hybridoma | | |
| | | | growth factor; | | |
| | | | interleukin BSF-2 | | |
| 14 | IL6R | Interleukin 6 | IL-6R; CD126; IL- | NP_000556.1 | 3570 |
| | | receptor | 6R-alpha; IL6RA; | | |
| | | | MGC104991; CD126 | | |
| | | | antigen; interleukin 6 | | |
| | | | receptor alpha | | |
| | | | subunit | | |
| 15 | IL8 | Interleukin 8 | IL-8; CXCL8; GCP1; | NP_000575.1 | 3576 |
| | | | LECT; LUCT; | | |
| | | | LYNAP; MDNCF; | | |
| | | | MONAP; NAF; | | |
| | | | NAP-1; T cell | | |
| | | | chemotactic factor; | | |
| | | | beta- | | |
| | | | thromboglobulin-like | | |
| | | | protein; chemokine | | |
| | | | (C—X—C motif) ligand | | |
| | | | 8; emoctakin; | | |
| | | | granulocyte | | |
| | | | chemotactic protein 1 | | |
| | | | 1; lymphocyte- | | |
| | | | derived neutrophil- | | |
| | | | activating factor; | | |
| | | | monocyte-derived | | |
| | | | neutrophil | | |
| | | | chemotactic factor; | | |
| | | | neutrophil-activating | | |
| | | | peptide 1; small | | |
| | | | inducible cytokine | | |
| | | | subfamily B, member 8 | | |
| 16 | LEP | Leptin | FLJ94114; OB; OBS; | NP_000221.1 | 3952 |
| | | | leptin (murine obesity | | |
| | | | homolog); leptin | | |
| | | | (obesity homolog, | | |
| | | | mouse); obese, | | |
| | | | mouse, homolog of; | | |
| | | | obesity factor | | |
| 17 | MMP1 | Matrix | MMP-1; CLG; | NP_002412.1 | 4312 |
| | | metallopeptidase | CLGN; fibroblast | | |
| | | 1 (interstitial | collagenase; matrix | | |
| | | collagenase) | metalloprotease 1 | | |
| 18 | MMP3 | Matrix | MMP-3; CHDS6; | NP_002413.1 | 4314 |
| | | metallopeptidase 3 | MGC126102; | | |
| | | (stromelysin | MGC126103; | | |
| | | 1, | MGC126104; SL-1; | | |
| | | progelatinase) | STMY; STMY1; | | |
| | | | STR1; | | |
| | | | proteoglycanase; | | |
| | | | transin-1 | | |
| 19 | N/A | N/A | PYD, pyridinoline | N/A | N/A |
| 20 | RETN | Resistin | ADSF; FIZZ3; | NP_065148.1 | 56729 |
| | | | MGC126603; | | |
| | | | MGC126609; | | |
| | | | RETN1; RSTN; | | |
| | | | XCP1; C/EBP- | | |
| | | | epsilon regulated | | |
| | | | myeloid-specific | | |
| | | | secreted cysteine-rich | | |
| | | | protein precursor 1; | | |
| | | | found in | | |
| | | | inflammatory zone 3 | | |
| 21 | SAA1 | Serum | MGC111216; PIG4; | NP_000322.2 | 6288 |
| | | amyloid | SAA; TP53I4; tumor | | |
| | | A1 | protein p53 inducible | | |
| | | | protein 4 | | |
| 22 | THBD | Thrombomodulin | AHUS6; CD141; | NP_000352.1 | 7056 |
| | | | THRM; TM; CD141 | | |
| | | | antigen; fetomodulin | | |
| 23 | TIMP1 | TIMP | RP1-230G1.3; CLGI; | NP_003245.1 | 7076 |
| | | metallopeptidase | EPA; EPO; | | |
| | | inhibitor | FLJ90373; HCI; | | |
| | | | TIMP; | | |
| | | | OTTHUMP00000023216; | | |
| | | | collagenase | | |
| | | | inhibitor; erythroid | | |
| | | | potentiating activity; | | |
| | | | fibroblast collagenase | | |
| | | | inhibitor; | | |
| | | | metalloproteinase | | |
| | | | inhibitor 1; tissue | | |
| | | | inhibitor of | | |
| | | | metalloproteinases 1 | | |
| 24 | TNFRSF11B | Tumor | MGC29565; OCIF; | NP_002537.3 | 4982 |
| | | necrosis | OPG; TR1; | | |
| | | factor | osteoclastogenesis | | |
| | | receptor | inhibitory factor; | | |
| | | superfamily, | osteoprotegerin | | |
| | | member 11b | | | |
| 25 | TNFRSF1A | Tumor | TNFR1; CD120a; | NP_001056.1 | 7132 |
| | | necrosis | FPF; MGC19588; | | |
| | | factor | TBP1; TNF-R; TNF- | | |
| | | receptor | R55; TNFAR; | | |
| | | superfamily, | TNFR55; TNFR60; | | |
| | | member 1A | p55; p55-R; p60; | | |
| | | | tumor necrosis factor | | |
| | | | binding protein 1; | | |
| | | | tumor necrosis factor | | |
| | | | receptor 1; tumor | | |
| | | | necrosis factor | | |
| | | | receptor type 1; | | |
| | | | tumor necrosis factor- | | |
| | | | alpha receptor | | |
| 26 | TNFSF11 | Tumor | RP11-86N24.2; | | |
| | | necrosis | CD254; ODF; OPGL; | | |
| | | factor | OPTB2; RANKL; | | |
| | | (ligand) | TRANCE; | | |
| | | superfamily, | hRANKL2; sOdf; | | |
| | | member 11 | OTTHUMP00000178585; | | |
| | | | TNF-related | | |
| | | | activation-induced | | |
| | | | cytokine; osteoclast | | |
| | | | differentiation factor; | | |
| | | | osteoprotegerin | | |
| | | | ligand; receptor | | |
| | | | activator of nuclear | | |
| | | | factor kappa B ligand | | |
| 27 | VCAM1 | Vascular cell | VCAM-1; CD106; | NP_001069.1 | 7412 |
| | | adhesion | DKFZp779G2333; | | |
| | | molecule 1 | INCAM-100; | | |
| | | | MGC99561; CD106 | | |
| | | | antigen | | |
| 28 | VEGFA | Vascular | RP1-261G23.1; | NP_001020539.2 | 7422 |
| | | endothelial | MGC70609; | | |
| | | growth factor A | MVCD1; VEGF; | | |
| | | | VPF; vascular | | |
| | | | endothelial growth | | |
| | | | factor isoform | | |
| | | | VEGF165; vascular | | |
| | | | permeability factor | | |

*HUGO Gene Nomenclature Committee, as of Sep. 25, 2009; accession numbers refer to sequence versions in NCBI database as of Jul. 28, 2010.
N/A = Not applicable to this analyte

### Biological Significance of the SDMRK Group of Markers

The present teachings describe a robust, stepwise development process for identifying a panel or panels of biomarkers that are strongly predictive of structural damage progression due to autoimmune/inflammatory disease. Multivariate algorithmic combinations of specific biomarkers as described herein exceed the prognostic and predictive power of individual biomarkers known in the art, because the combinations comprise biomarkers that represent a broad range of disease mechanisms and critical features of autoimmune/inflammatory disease, which no individual biomarker does. As a consequence of the diversity of pathways represented by the combinations as taught herein, the methods of the present teachings are useful in the clinical assessment of individual subjects, despite the heterogeneity of the pathology of the disease assessed.

The group of biomarkers comprising the SDMRK set, as an example, was identified through a selection process comprising rigorous correlation studies of an initial large, comprehensive set of candidate protein biomarkers. See Example 1. All of the biomarkers that resulted from these correlation studies and that make up the SDMRK set are known in the art to correspond to critical features of structural damage progression due to RA disease, including synovial angiogenesis, leukocyte recruitment, innate and adaptive immune-driven synovial inflammation, fibroblast hyperplasia and ultimately, cartilage and bone destruction. See FIG. 8.

Angiogenesis and vascularization are linked to the progression of skeletal damage in RA, and these processes are reflected in several of the SDMRK markers, including: the growth factor VEGFA; chemokines CXCL10 and IL8; and, the acute phase proteins SAA1. See Example 1 (correlation of SDMRK markers with TSS).

Recruitment and activation of leukocytes in the synovial tissue are critical drivers of synovial inflammation, synovial thickening and, ultimately, damage progression in RA. Chemokines CXCL10 and IL8, which attract leukocytes to the synovial tissue, are associated with skeletal damage progression, and in some cases CXCL10 and IL8 are associated with synovial thickening.

The role in structural damage progression of innate cells, such as macrophages, and the cytokines they produce, especially IL1B and IL6, is evidenced by the improvement seen in subjects treated with the corresponding cytokine-targeted therapies. Furthermore, these cytokines are key regulators of the hepatic acute phase response, responsible for the production of CRP and SAA1. Notably, CRP, IL1B, IL6 and TNFRSF1A are each correlated individually with both synovial thickening and structural damage progression (change in TSS), and are also prioritized by multivariate serum-marker models as described herein.

The adaptive immune response also critically contributes to skeletal damage progression. Positivity for rheumatoid factor (RF) and/or antibodies to citrullinated proteins is associated with more aggressive disease progression, and reducing lymphocyte activity via costimulatory blockade with abatacept, or through B cell depletion with rituximab, affords skeletal benefit.

Tissue fibroblasts also contribute to synovial inflammation and hyperplasia, and directly drive cartilage degradation through production of MMP1 and MMP3. These fibroblasts are major producers of IL6 and growth factors such as VEGFA and possibly EGF, which in turn affect the proliferation and tissue remodeling activity of fibroblasts. The association of SDMRK markers with synovial thickening and skeletal damage progression also reflects the role of fibroblast activity in structural damage progression.

IL1B and IL6 stimulate chondrocyte production of MMPs and TIMPs, which influence cartilage degradation and the release of matrix molecules and collagen degradation products such as pyridinoline (PYD). Cytokines and growth factors including CSF1, IL1B, IL6 and VEGFA also promote differentiation and activation of osteoclasts, and thereby bone erosion, and the release of collagen peptides such as ICTP and PYD. Thus, markers directly driving or derived from skeletal damage also correlate with TSS.

Accordingly, the methodology employed in selecting the SDMRK biomarkers resulted in a set of markers especially useful in quantifying structural damage progression, and which provide the clinician with a unique and broad look at RA disease biology. The SDMRK set of biomarkers of the present teachings are thus more effective in quantifying disease activity than single biomarkers or randomly selected groupings of biomarkers.

By further demonstration of the key roles of the SDMRK markers in RA pathology, the SDMRK set comprises: CCL22, a key modulator of humoral immunity and B cell activation, and which recruits T cells to the rheumatoid synovium; CHI3L1, which is highly elevated in RA joints and thought to modulate intra-articular matrix; two key acute phase proteins, CRP and SAA1, which reflect the role of RA inflammation in inducing the hepatic acute phase response; markers derived in large part from fibroblasts, including EGF, IL6, IL8, MMP1, MMP3 and VEGFA; the endothelial adhesion and activation biomarkers ICAM1 and VCAM1; bone and cartilage matrix breakdown products of RA joints, including ICTP and PYD; IL1B, an inflammatory mediator and key pathologic regulator in RA, and the target of the recombinant molecule anakinra, an FDA-approved biologic therapy for RA; key mediators of the IL6 pathway (IL6 and IL6R) and the TNF pathway (TNFRSF1A), which are also targets of biologic therapies in RA; IL8, which modulates neutrophil migration and activation, neutrophils having a key role in RA disease, as they comprise the majority of infiltrating inflammatory cells in RA synovial fluid and release a variety of disease mediators; the pro-angiogenic proteins IL8 and VEGFA, which also attract leukocytes to the RA joint; and, the lipid-associated proteins LEP and RETN.

### Model Development Process

An exemplary method for developing predictive models to determine the inflammatory disease progression of a subject or population is shown by the flow diagram of FIG. 6 (200). Biomarker data from a representative population, as described herein, is obtained (202). This biomarker data can be derived through a variety of methods, including prospective, retrospective, cross-sectional, or longitudinal studies, that involve interventions or observations of the representative subjects or populations from one or more timepoints. The biomarker data can be obtained from a single study or multiple studies. Subject and population data can generally include data pertaining to the subjects' disease status and/or clinical assessments, which can be used for training and validating the algorithms for use in the present teachings, wherein the values of the biomarkers described herein are correlated to the desired clinical measurements.

Data within the representative population dataset is then prepared (204) so as to fit the requirements of the model that will be used for biomarker selection, described below. A variety of methods of data preparation can be used, such as transformations, normalizations, and gap-fill techniques including nearest neighbor interpolation or other pattern recognition techniques. The data preparation techniques that are useful for different model types are well-known in the art. See Examples, below.

Biomarkers are then selected for use in the training of the model to determine inflammatory disease progression (206). Various models can be used to inform this selection, and biomarker data are chosen from the dataset providing the most reproducible results. Methods to evaluate biomarker performance can include, e.g., bootstrapping and cross-validation.

After the biomarkers are selected, the model to be used to determine inflammatory disease progression can be selected. For specific examples of statistical methods useful in designing predictive models, see Calculation of the SDI score.

For the particular selection model used with a dataset, biomarkers can be selected based on such criteria as the biomarker's ranking among all candidate markers, the biomarker's statistical significance in the model, and any improvement in model performance when the biomarker is added to the model. Tests for statistical significance can include, for example, correlation tests, t-tests, and analysis of variance (ANOVA). Models can include, for example, regression models such as regression trees and linear models, and classification models such as logistic regression, Random Forest, SVM, tree models, and LDA. Examples of these are described herein.

In those cases where individual biomarkers are not alone indicative of inflammatory disease progression, biomarker combinations can be applied to the selection model. Instead of univariate biomarker selection, for example, multivariate biomarker selection can be used. One example of an algorithm useful in multivariate biomarker selection is a recursive feature selection algorithm. Biomarkers that are not alone good indicators of inflammatory disease progression may still be useful as indicators when in combination with other biomarkers, in a multivariate input to the model, because each biomarker may bring additional information to the combination that would not be informative where taken alone.

Next, selection, training and validation is performed on the model for assessing disease progression (208). Models can be selected based on various performance and/or accuracy criteria, such as are described herein. By applying datasets to different models, the results can be used to select the best models, while at the same time the models can be used to determine which biomarkers are statistically significant for inflammatory disease progression. Combinations of models and biomarkers can be compared and validated in different datasets. The comparisons and validations can be repeated in order to train and/or choose a particular model.

FIG. 7 is a flow diagram of an exemplary method (250) of using a model as developed above to determine the inflammatory disease progression of a subject or a population. Biomarker data is obtained from the subject at (252). This data can be obtained by a variety of means, including but not limited to physical examinations, self-reports by the subject, laboratory testing, medical records and charts. Subject data can then be prepared (254) via transformations, logs, normalizations, and so forth, based on the particular model selected and trained in FIG. 6. The data is then input into the model for evaluation (256), which outputs an index value (258); e.g., an SDI score. Examples as to are how a model can be used to evaluate a subject's biomarkers and output an SDI value are provided herein.

### Modifications for Response to Treatment

In certain embodiments of the present teachings, biomarkers from the SDMRK group can be used to determine a subject's response to treatment for inflammatory disease. Measuring levels of an effective amount of biomarkers also allows for the course of treatment of inflammatory disease to be monitored. In these embodiments, a biological sample can be provided from a subject undergoing therapeutic regimens for inflammatory disease. If desired, biological samples are obtained from the subject at various timepoints before, during, or after treatment.

Various embodiments of the present teachings can be used to provide a guide to the selection of a therapeutic regimen for a subject; meaning, e.g., that treatment may need to be more or less aggressive, or a subject may need a different therapeutic regimen, or the subject's current therapeutic regimen may need to be changed or stopped, or a new therapeutic regimen may need to be adopted, etc.

Treatment strategies are confounded by the fact that RA is a classification given to a group of subjects with a diverse array of related symptoms. This suggests that certain subtypes of RA are driven by specific cell type or cytokine. As a likely consequence, no single therapy has proven optimal for treatment. Given the increasing numbers of therapeutic options available for RA, the need for an individually tailored treatment directed by immunological prognostic factors of treatment outcome is imperative. In various embodiments of the present teachings, a SDMRK biomarker-derived algorithm can be used to quantify therapy response in RA subjects. See Example 5. Measuring SDMRK biomarker levels over a period time can provide the clinician with a dynamic picture of the subject's biological state, and the SDI scores reflect the rate of joint damage progression. Overlaying the DAS28 score with the SDI score can provide a deeper understanding of how a subject is responding to therapy. These embodiments of the present teachings thus will provide subject-specific biological information, which will be informative for therapy decision and will facilitate therapy response monitoring, and should result in more rapid and more optimized treatment, better control of disease activity and/or progression, and an increase in the proportion of subjects achieving remission.

Differences in the genetic makeup of subjects can result in differences in their relative abilities to metabolize various drugs, which may modulate the symptoms or stage of inflammatory disease. Subjects that have inflammatory disease can vary in age, ethnicity, body mass index (BMI), total cholesterol levels, blood glucose levels, blood pressure, LDL and HDL levels, and other parameters. Accordingly, use of the biomarkers disclosed herein, both alone and together in combination with known genetic factors for drug metabolism, allow for a pre-determined level of predictability that a putative therapeutic or prophylactic to be tested in a selected subject will be suitable for treating or preventing inflammatory disease in the subject.

To identify therapeutics or drugs that are appropriate for a specific subject, a test sample from the subject can also be exposed to a therapeutic agent or a drug, and the level of one or more biomarkers can be determined. The level of one or more biomarkers can be compared to sample derived from the subject before and after treatment or exposure to a therapeutic agent or a drug, or can be compared to samples derived from one or more subjects who have shown improvements in inflammatory disease stage or activity (e.g., clinical parameters or traditional laboratory risk factors) as a result of such treatment or exposure.

Combination with Clinical Parameters

Any of the aforementioned clinical parameters can also be used in the practice of the present teachings, as input to the SDMRK formula or as a pre-selection criteria defining a relevant population to be measured using a particular SDMRK panel and formula. As noted above, clinical parameters can also be useful in the biomarker normalization and pre-processing, or in selecting particular biomarkers from SDMRK, panel construction, formula type selection and derivation, and formula result post-processing.

### Clinical Assessments of the Present Teachings

In some embodiments of the present teachings, panels of SDMRK biomarkers and formulas are tailored to the population, endpoints or clinical assessment, and/or use that is intended. For example, the SDMRK panels and formulas can used to assess subjects for primary prevention and diagnosis, and for secondary prevention and management. For the primary assessment, the SDMRK panels and formulas can be used for prediction and risk stratification for future conditions or disease sequelae, for the diagnosis of inflammatory disease, for the prognosis of disease activity and rate of change, and for indications for future diagnosis and therapeutic regimens. For secondary prevention and clinical management, the SDMRK panels and formulas can be used for prognosis and risk stratification. The SDMRK panels and formulas can be used for clinical decision support, such as determining whether to defer intervention or treatment, to recommend normal preventive check-ups, to recommend increased visit frequency, to recommend increased testing, and to recommend intervention. The SDMRK panels and formulas can also be useful for therapeutic selection, determining response to treatment, adjustment and dosing of treatment, monitoring ongoing therapeutic efficiency, and indication for change in therapeutic regimen.

In some embodiments of the present teachings, the SDMRK panels and formulas can be used to aid in the diagnosis of inflammatory disease, and in the determination of the severity of inflammatory disease. The SDMRK panels and formulas can also be used for determining the future status of intervention such as, for example in RA, determining the prognosis of future joint erosion with or without treatment. Certain embodiments of the present teachings can be tailored to a specific treatment or a combination of treatments. X-ray is currently considered the gold standard for assessment of disease progression, but it has limited capabilities since subjects may have long periods of active symptomatic disease while radiographs remain normal or show only nonspecific changes. Conversely, subjects who seem to have quiescent disease may slowly progress over time, undiagnosed by radiograph until significant progression has occurred. If subjects with a high likelihood of disabling progression could be identified in advance, the opportunity for early aggressive treatment could result in much more effective disease outcomes. See, e.g., M. Weinblatt et al., N. Engl. J. Med. 1999, 340:253-259. In certain embodiments of the present teachings, an algorithm developed from the SDMRK set of biomarkers can be used, with significant power, to characterize the level of erosive activity in RA subjects. In other embodiments, an algorithm developed from the SDMRK set of biomarkers can be used, with significant power, to prognose joint destruction over time. In other embodiments, the SDI score can be used as a strong predictor of radiographic progression, giving the clinician a novel way to identify subjects at risk of RA-induced joint damage and allowing for early prescription of joint-sparing agents, prophylactically.

In some embodiments of the present teachings, the SDMRK panels and formulas can be used as surrogate markers of clinical events necessary for the development of inflammatory disease-specific agents; e.g., pharmaceutical agents. That is, the SDI surrogate marker, derived from a SDMRK panel, can be used in the place of clinical events in a clinical trial for an experimental RA treatment. SDMRK panels and formulas can thus be used to derive an inflammatory disease surrogate endpoint to assist in the design of experimental treatments for RA.

### Measurement of Biomarkers

The quantity of one or more biomarkers of the present teachings can be indicated as a value. The value can be one or more numerical values resulting from the evaluation of a sample, and can be derived, e.g., by measuring level(s) of the biomarker(s) in a sample by an assay performed in a laboratory, or from dataset obtained from a provider such as a laboratory, or from a dataset stored on a server. Biomarker levels can be measured using any of several techniques known in the art. The present teachings encompass such techniques, and further include all subject fasting and/or temporal-based sampling procedures for measuring biomarkers.

The actual measurement of levels of the biomarkers can be determined at the protein or nucleic acid level using any method known in the art. “Protein” detection comprises detection of full-length proteins, mature proteins, pre-proteins, polypeptides, isoforms, mutations, variants, and polymorphisms thereof, and can be detected in any suitable manner. Levels of biomarkers can be determined at the protein level, e.g., by measuring the serum levels of peptides encoded by the gene products described herein, or by measuring the enzymatic activities of these protein biomarkers. Such methods are well-known in the art and include, e.g., immunoassays based on antibodies to proteins encoded by the genes, aptamers or molecular imprints. Any biological material can be used for the detection/quantification of the protein or its activity. Alternatively, a suitable method can be selected to determine the activity of proteins encoded by the biomarker genes according to the activity of each protein analyzed. For biomarker proteins, polypeptides, isoforms, mutations, and polymorphisms known to have enzymatic activity, the activities can be determined in vitro using enzyme assays known in the art. Such assays include, without limitation, kinase assays, phosphatase assays, reductase assays, among many others. Modulation of the kinetics of enzyme activities can be determined by measuring the rate constant KM using known algorithms, such as the Hill plot, Michaelis-Menten equation, linear regression plots such as Lineweaver-Burk analysis, and Scatchard plot.

Using sequence information provided by the public database entries for the biomarker, expression of the biomarker can be detected and measured using techniques well-known to those of skill in the art. For example, nucleic acid sequences in the sequence databases that correspond to nucleic acids of biomarkers can be used to construct primers and probes for detecting and/or measuring biomarker nucleic acids. These probes can be used in, e.g., Northern or Southern blot hybridization analyses, ribonuclease protection assays, and/or methods that quantitatively amplify specific nucleic acid sequences. As another example, sequences from sequence databases can be used to construct primers for specifically amplifying biomarker sequences in, e.g., amplification-based detection and quantization methods such as reverse-transcription based polymerase chain reaction (RT-PCR) and PCR. When alterations in gene expression are associated with gene amplification, nucleotide deletions, polymorphisms, and/or mutations, sequence comparisons in test and reference populations can be made by comparing relative amounts of the examined DNA sequences in the test and reference populations.

As an example, Northern hybridization analysis using probes which specifically recognize one or more of these sequences can be used to determine gene expression. Alternatively, expression can be measured using RT-PCR; e.g., polynucleotide primers specific for the differentially expressed biomarker mRNA sequences reverse-transcribe the mRNA into DNA, which is then amplified in PCR and can be visualized and quantified. Biomarker RNA can also be quantified using, for example, other target amplification methods, such as TMA, SDA, and NASBA, or signal amplification methods (e.g., bDNA), and the like. Ribonuclease protection assays can also be used, using probes that specifically recognize one or more biomarker mRNA sequences, to determine gene expression.

Alternatively, biomarker protein and nucleic acid metabolites can be measured. The term “metabolite” includes any chemical or biochemical product of a metabolic process, such as any compound produced by the processing, cleavage or consumption of a biological molecule (e.g., a protein, nucleic acid, carbohydrate, or lipid). Metabolites can be detected in a variety of ways known to one of skill in the art, including the refractive index spectroscopy (RI), ultra-violet spectroscopy (UV), fluorescence analysis, radiochemical analysis, near-infrared spectroscopy (near-IR), nuclear magnetic resonance spectroscopy (NMR), light scattering analysis (LS), mass spectrometry, pyrolysis mass spectrometry, nephelometry, dispersive Raman spectroscopy, gas chromatography combined with mass spectrometry, liquid chromatography combined with mass spectrometry, matrix-assisted laser desorption ionization-time of flight (MALDI-TOF) combined with mass spectrometry, ion spray spectroscopy combined with mass spectrometry, capillary electrophoresis, NMR and IR detection. See WO 04/056456 and WO 04/088309, each of which is hereby incorporated by reference in its entirety. In this regard, other biomarker analytes can be measured using the above-mentioned detection methods, or other methods known to the skilled artisan. For example, circulating calcium ions (Ca²⁺) can be detected in a sample using fluorescent dyes such as the Fluo series, Fura-2A, Rhod-2, among others. Other biomarker metabolites can be similarly detected using reagents that are specifically designed or tailored to detect such metabolites.

In some embodiments, a biomarker is detected by contacting a subject sample with reagents, generating complexes of reagent and analyte, and detecting the complexes. Examples of “reagents” include but are not limited to nucleic acid primers and antibodies.

In some embodiments of the present teachings an antibody binding assay is used to detect a biomarker; e.g., a sample from the subject is contacted with an antibody reagent that binds the biomarker analyte, a reaction product (or complex) comprising the antibody reagent and analyte is generated, and the presence (or absence) or amount of the complex is determined. The antibody reagent useful in detecting biomarker analytes can be monoclonal, polyclonal, chimeric, recombinant, or a fragment of the foregoing, as discussed in detail above, and the step of detecting the reaction product can be carried out with any suitable immunoassay. The sample from the subject is typically a biological fluid as described above, and can be the same sample of biological fluid as is used to conduct the method described above.

Immunoassays carried out in accordance with the present teachings can be homogeneous assays or heterogeneous assays. In a homogeneous assay the immunological reaction can involve the specific antibody (e.g., anti-biomarker protein antibody), a labeled analyte, and the sample of interest. The label produces a signal, and the signal arising from the label becomes modified, directly or indirectly, upon binding of the labeled analyte to the antibody. Both the immunological reaction of binding, and detection of the extent of binding, can be carried out in a homogeneous solution. Immunochemical labels which can be employed include but are not limited to free radicals, radioisotopes, fluorescent dyes, enzymes, bacteriophages, and coenzymes.

In a heterogeneous assay approach, the reagents can be the sample of interest, an antibody, and a reagent for producing a detectable signal. Samples as described above can be used. The antibody can be immobilized on a support, such as a bead (such as protein A and protein G agarose beads), plate or slide, and contacted with the sample suspected of containing the biomarker in liquid phase. The support is separated from the liquid phase, and either the support phase or the liquid phase is examined using methods known in the art for detecting signal. The signal is related to the presence of the analyte in the sample. Methods for producing a detectable signal include but are not limited to the use of radioactive labels, fluorescent labels, or enzyme labels. For example, if the antigen to be detected contains a second binding site, an antibody which binds to that site can be conjugated to a detectable (signal-generating) group and added to the liquid phase reaction solution before the separation step. The presence of the detectable group on the solid support indicates the presence of the biomarker in the test sample. Examples of suitable immunoassays include but are not limited to oligonucleotides, immunoblotting, immunoprecipitation, immunofluorescence methods, chemiluminescence methods, electrochemiluminescence (ECL), and/or enzyme-linked immunoassays (ELISA).

Those skilled in the art will be familiar with numerous specific immunoassay formats and variations thereof which can be useful for carrying out the method disclosed herein. See, e.g., E. Maggio, Enzyme-Immunoassay (1980), CRC Press, Inc., Boca Raton, Fla. See also U.S. Pat. No. 4,727,022 to C. Skold et al., titled “Novel Methods for Modulating Ligand-Receptor Interactions and their Application”; U.S. Pat. No. 4,659,678 to GC Forrest et al., titled “Immunoassay of Antigens”; U.S. Pat. No. 4,376,110 to GS David et al., titled “Immunometric Assays Using Monoclonal Antibodies”; U.S. Pat. No. 4,275,149 to D. Litman et al., titled “Macromolecular Environment Control in Specific Receptor Assays”; U.S. Pat. No. 4,233,402 to E. Maggio et al., titled “Reagents and Method Employing Channeling”; and, U.S. Pat. No. 4,230,797 to R. Boguslaski et al., titled “Heterogenous Specific Binding Assay Employing a Coenzyme as Label.”

Antibodies can be conjugated to a solid support suitable for a diagnostic assay (e.g., beads such as protein A or protein G agarose, microspheres, plates, slides or wells formed from materials such as latex or polystyrene) in accordance with known techniques, such as passive binding. Antibodies as described herein can likewise be conjugated to detectable labels or groups such as radiolabels (e.g., ³⁵S, ¹²⁵I, ¹³¹I), enzyme labels (e.g., horseradish peroxidase, alkaline phosphatase), and fluorescent labels (e.g., fluorescein, Alexa, green fluorescent protein, rhodamine) in accordance with known techniques.

Antibodies may also be useful for detecting post-translational modifications of biomarkers, such as tyrosine phosphorylation, threonine phosphorylation, serine phosphorylation, and glycosylation (e.g., O-GlcNAc). Such antibodies specifically detect the phosphorylated amino acids in a protein or proteins of interest, and can be used in the immunoblotting, immunofluorescence, and ELISA assays described herein. These antibodies are well-known to those skilled in the art, and commercially available. Post-translational modifications can also be determined using metastable ions in reflector matrix-assisted laser desorption ionization-time of flight mass spectrometry (MALDI-TOF). See U. Wirth et al., Proteomics 2002, 2(10):1445-1451.

### Kits

Other embodiments of the present teachings comprise biomarker detection reagents packaged together in the form of a kit for conducting any of the assays of the present teachings. In certain embodiments, the kits comprise oligonucleotides that specifically identify one or more biomarker nucleic acids based on homology and/or complementarity with biomarker nucleic acids. The oligonucleotide sequences may correspond to fragments of the biomarker nucleic acids. For example, the oligonucleotides can be more than 200, 200, 150, 100, 50, 25, 10, or fewer than 10 nucleotides in length. In other embodiments, the kits comprise antibodies to proteins encoded by the biomarker nucleic acids. The kits of the present teachings can also comprise aptamers. The kit can contain in separate containers a nucleic acid or antibody (the antibody either bound to a solid matrix, or packaged separately with reagents for binding to a matrix), control formulations (positive and/or negative), and/or a detectable label, such as but not limited to fluorescein, green fluorescent protein, rhodamine, cyanine dyes, Alexa dyes, luciferase, and radiolabels, among others. Instructions for carrying out the assay, including, optionally, instructions for generating an SDI, a disease activity score or both, can be included in the kit; e.g., written, tape, VCR, or CD-ROM. The assay can for example be in the form of a Northern hybridization or a sandwich ELISA as known in the art.

In some embodiments of the present teachings, biomarker detection reagents can be immobilized on a solid matrix, such as a porous strip, to form at least one biomarker detection site. In some embodiments, the measurement or detection region of the porous strip can include a plurality of sites containing a nucleic acid. In some embodiments, the test strip can also contain sites for negative and/or positive controls. Alternatively, control sites can be located on a separate strip from the test strip. Optionally, the different detection sites can contain different amounts of immobilized nucleic acids, e.g., a higher amount in the first detection site and lesser amounts in subsequent sites. Upon the addition of test sample, the number of sites displaying a detectable signal provides a quantitative indication of the amount of biomarker present in the sample. The detection sites can be configured in any suitably detectable shape and can be, e.g., in the shape of a bar or dot spanning the width of a test strip.

In other embodiments of the present teachings, the kit can contain a nucleic acid substrate array comprising one or more nucleic acid sequences. The nucleic acids on the array specifically identify one or more nucleic acid sequences represented by SDMRK biomarker Nos. 1-25. In various embodiments, the expression of one or more of the sequences represented by SDMRK Nos. 1-25 can be identified by virtue of binding to the array. In some embodiments the substrate array can be on a solid substrate, such as what is known as a “chip.” See, e.g., U.S. Pat. No. 5,744,305. In some embodiments the substrate array can be a solution array; e.g., xMAP (Luminex, Austin, Tex.), Cyvera (Illumina, San Diego, Calif.), RayBio Antibody Arrays (RayBiotech, Inc., Norcross, Ga.), CellCard (Vitra Bioscience, Mountain View, Calif.) and Quantum Dots' Mosaic (Invitrogen, Carlsbad, Calif.).

### Machine-Readable Storage Medium

A machine-readable storage medium can comprise, for example, a data storage material that is encoded with machine-readable data or data arrays. The data and machine-readable storage medium are capable of being used for a variety of purposes, when using a machine programmed with instructions for using said data. Such purposes include, without limitation, storing, accessing and manipulating information relating to the inflammatory disease activity of a subject or population over time, or disease progression in response to inflammatory disease treatment, or for drug discovery for inflammatory disease, etc. Data comprising measurements of the biomarkers of the present teachings, and/or the evaluation of disease activity or disease stage from these biomarkers, can be implemented in computer programs that are executing on programmable computers, which comprise a processor, a data storage system, one or more input devices, one or more output devices, etc. Program code can be applied to the input data to perform the functions described herein, and to generate output information. This output information can then be applied to one or more output devices, according to methods well-known in the art. The computer can be, for example, a personal computer, a microcomputer, or a workstation of conventional design.

The computer programs can be implemented in a high-level procedural or object-oriented programming language, to communicate with a computer system such as for example, the computer system illustrated in FIG. 16. The programs can also be implemented in machine or assembly language. The programming language can also be a compiled or interpreted language. Each computer program can be stored on storage media or a device such as ROM, magnetic diskette, etc., and can be readable by a programmable computer for configuring and operating the computer when the storage media or device is read by the computer to perform the described procedures. Any health-related data management systems of the present teachings can be considered to be implemented as a computer-readable storage medium, configured with a computer program, where the storage medium causes a computer to operate in a specific manner to perform various functions, as described herein.

The biomarkers disclosed herein can be used to generate a “subject biomarker profile” taken from subjects who have inflammatory disease. The subject biomarker profiles can then be compared to a reference biomarker profile, in order to diagnose or identify subjects with inflammatory disease, to monitor the progression or rate of progression of inflammatory disease, or to monitor the effectiveness of treatment for inflammatory disease. The biomarker profiles, reference and subject, of embodiments of the present teachings can be contained in a machine-readable medium, such as analog tapes like those readable by a CD-ROM or USB flash media, among others. Such machine-readable media can also contain additional test results, such as measurements of clinical parameters and clinical assessments. The machine-readable media can also comprise subject information; e.g., the subject's medical or family history. The machine-readable media can also contain information relating to other disease activity and/or disease progression algorithms and computed scores or indices, such as those described herein.

### EXAMPLES

Aspects of the present teachings can be further understood in light of the following examples, which should not be construed as limiting the scope of the present teachings in any way.

The practice of the present teachings employ, unless otherwise indicated, conventional methods of protein chemistry, biochemistry, recombinant DNA techniques and pharmacology, within the skill of the art. Such techniques are explained fully in the literature. See, e.g., T. Creighton, Proteins: Structures and Molecular Properties, 1993, W. Freeman and Co.; A. Lehninger, Biochemistry, Worth Publishers, Inc. (current addition); J. Sambrook et al., Molecular Cloning: A Laboratory Manual, 2nd Edition, 1989; Methods In Enzymology, S. Colowick and N. Kaplan, eds., Academic Press, Inc.; Remington's Pharmaceutical Sciences, 18th Edition, 1990, Mack Publishing Company, Easton, Pa.; Carey and Sundberg, Advanced Organic Chemistry, Vols. A and B, 3rd Edition, 1992, Plenum Press.

The practice of the present teachings also employ, unless otherwise indicated, conventional methods of statistical analysis, within the skill of the art. Such techniques are explained fully in the literature. See, e.g., J. Little and D. Rubin, Statistical Analysis with Missing Data, 2nd Edition 2002, John Wiley and Sons, Inc., NJ; M. Pepe, The Statistical Evaluation of Medical Tests for Classification and Prediction (Oxford Statistical Science Series) 2003, Oxford University Press, Oxford, UK; X. Zhoue et al., Statistical Methods in Diagnostic Medicine 2002, John Wiley and Sons, Inc., NJ; T. Hastie et. al, The Elements of Statistical Learning Data Mining, Inference, and Prediction, Second Edition 2009, Springer, NY; W. Cooley and P. Lohnes, Multivariate procedures for the behavioral science 1962, John Wiley and Sons, Inc. NY; E. Jackson, A User's Guide to Principal Components 2003, John Wiley and Sons, Inc., NY.

### Example 1

Example 1 demonstrates the use of multivariate modeling to transform observed serum biomarker levels into an SDI score useful in predicting the rate of change in total Sharp score (TSS, which is synonymous with and may also be referred to throughout as mSS), and thus predicting radiographic progression in the RA subject. Certain embodiments of the present teachings comprise utilizing the SDMRK set of biomarkers to determine an SDI score that can be used to estimate rates of progression of inflammatory disease and, specifically, predict joint damage in the RA subject.

Biomarkers were analyzed in samples from 24 subjects with early aggressive RA who participated in a two-year blinded study comparing MTX+infliximab treatment with MTX alone. Subjects were evaluated by ultrasound (US) power Doppler at 0, 18, 54 and 110 weeks, and scored for synovial thickening (ST) and vascularity by power Doppler area (PDA). Joint damage was assessed by radiographic examination and determination of van der Heijde modified total Sharp scores (TSS) at 0, 54 and 110 weeks. A total of 90 candidate serum proteins associated with biological processes underlying joint damage were measured quantitatively in serum samples from 0, 6, 18, 54 and 110 weeks. See Table 2.

TABLE 2

| CATEGORY | MARKER |
|---|---|
| antigen, antibody, complement | C5a |
| | complement factor D adipsin |
| | HSP90AA1 |
| | kappa free light chains |
| apolipoproteins | apo AI |
| | apo AII |
| | apo CIII |
| | apo E |
| cell adhesion molecules | CD40L |
| | ICAM-1 |
| | ICAM-3 |
| | PECAM1 |
| | E-selectin |
| | P-selectin |
| | VCAM-1 |
| chemokines/receptors | CCL11 |
| | CCL13 |
| | CCL17 |
| | CCL2 (MCP-1) |
| | CCL4 |
| | CCL5 |
| | IL8 |
| | CXCL1.3 |
| | CXCL10 |
| | CXCL5 |
| cytokines/receptors | calprotectin |
| | gp130 |
| | IL12 |
| | IL18 |
| | IL1B |
| | IL1Ra |
| | IL1R-type II |
| | IL2R alpha |
| | IL4R |
| | IL5 |
| | IL6 |
| | IL6R |
| | M-CSF |
| | OPG |
| | TNF-alpha |
| | TNFRSF1A |
| | TNFRSF1B |
| | TWEAK |
| enzymes | alkaline phosphatase |
| | thyroid peroxidase |
| | TRAP5b |
| growth factors/receptors | FGF-2 |
| | EGF |
| | EGFR |
| | HGF |
| | VEGF-A |
| hormones | adiponectin |
| | leptin |
| | parathyroid hormone |
| | resistin |
| other | DKK1 |
| | LTB4 |
| | macrophage migration inhibitory |
| | factor |
| | thrombomodulin |
| plasma and acute phase | CRP |
| proteins | |
| | SAA1 |
| proteases/inhibitors | MMP-1 |
| | MMP-10 |
| | MMP-2 |
| | MMP-3 |
| | MMP-7 |
| | MMP-8 |
| | MMP-9 |
| | SERPINE1 |
| | TIMP-1 |
| | TIMP-2 |
| | TIMP-3 |
| | TIMP-4 |
| skeletal | aggrecan |
| | C12C |
| | C2C |
| | COMP |
| | CS846 |
| | CTX I |
| | HCgp39 |
| | hyaluronan |
| | ICTP |
| | Keratan |
| | NTX I |
| | osteocalcin |
| | osteonectin |
| | osteopontin |
| | PICP |
| | PIIANP |
| | pyridinoline |

The concentrations of individual biomarkers were assessed for their association with change in TSS, US measurements, and DAS28-CRP. Multivariate statistical models were built using longitudinal hierarchical methods to predict the rate of change in TSS based on biomarkers, US, or DAS28-CRP. The performance of the models was evaluated by Spearman correlation coefficients between actual and predicted rate of change using Leave One Out cross-validation.

Subjects all had erosions at baseline and experienced a wide range of changes in total Sharp scores over the 2 year study period (TSS; median change 6.25, inter-quartile range 4-14.5). Thirteen serum biomarkers were correlated with change in TSS when any individual biomarker timepoint was considered (FDR<0.2). The serum biomarkers represented diverse biological processes including inflammatory regulation, ECM degradation and collagen metabolism. The multivariate models based on serum biomarkers performed well at predicting rate of change in TSS (correlation 0.58-0.87 between predicted and observed).

A large-scale quantitative assessment of serum biomarkers identified proteins correlated to joint damage progression. Correlations were highest six weeks after therapy initiation, suggesting effects of therapy on long-term outcome can be evaluated early in the treatment course. Quantitative serum protein biomarkers can be used to estimate rates of progression and predict joint damage in RA.

### Methods

The study design and data overview for this example is illustrated in FIG. 8. Associations were examined between both individual biomarkers and combinations of multiple biomarkers and change in Total Sharp Score (TSS). The primary outcome in this Example was the rate of change in TSS(RSS), defined as the change of TSS units per week.

### Data Description and Processing

Twelve of the 24 subjects studied were randomized to the Treatment Arm, and received 5 mg/kg infusions of treatment at weeks 0, 2, and 6, and then every 8 weeks through week 46, while the remaining 12 subjects received “placebo” infusions (i.e., MTX alone) at the same timepoints. Beginning at week 54, all subjects received Infliximab 5 mg/kg in combination with methotrexate. Treatment arm subjects continued on the existing regimen. Placebo arm subjects received loading doses of infliximab at 54, 56, and 60 weeks, followed by regular doses every eight weeks. Subjects were evaluated by US at 0, 18, 54 and 110 weeks, and scored for synovial thickening and for vascularity by power Doppler area (PDA). Radiographic examination and determination of van der Heijde modified total Sharp scores was carried out at 0, 30, 54 and 110 weeks.

Candidate serum proteins (see Table 1) were selected based on known association with joint damage, mechanistic relation to damage progression, and assay availability. The 90 resulting proteins were measured in serum samples at weeks 0, 6, 18, 54 and 100. Serum samples were stored at −80° C. Biomarkers were measured at a central laboratory (Crescendo Bioscience, Inc., South San Francisco, Calif.) with immunoassays using Luminex, Meso Scale Discovery and individual ELISA platforms. Concentrations were calculated using standard curves with four parameter logistic fits. Serum protein concentrations were log transformed prior to statistical analysis. Biomarker values outside the detectable range were imputed by the highest or lowest detectable values for the given biomarker. Biomarker profiles with more than 20% imputed values were not considered in the analyses. Remaining missing values were imputed by K-Nearest Neighbors. See O. Troyanskaya et al., Bioinformatics 2001, 17(6):520-525. For clinical data, subject samples were excluded when missing Sharp score data precluded the calculation of the rate of change of total Sharp score (RSS).

### Statistical Analysis

Individual biomarker associations with RSS were examined by Spearman correlation. The False Discovery Rate (FDR) method was used to correct for multiple testing. Additional individual biomarker analyses included employing linear regression models to predict the effect of therapy on RSS for each combination of biomarker and therapy group.

Multivariate analysis used longitudinal hierarchical linear models, where predictors were serum biomarkers, ultrasound measures (PDA and synovial thickening) or DAS28-CRP with measurement time in weeks, and therapy group. The full model for the predicted total Sharp score in subject k at radiographic timepoint t is shown by the following Equation 1:

[symbol]

ₜₖ=β₀ₖΣᵢ₌₁ⁿβᵢₖXᵢₗₖ+(β_{2n+1,k}+Σᵢ₌₁ⁿβ_{i+n,k}Xᵢₗₖ)timeₜₖ+β_{2n+2,k}therapyₜₖ+eₜₖ+Uₒₖ,

where β is the biomarker coefficient (the measured biomarker concentration is multiplied by this value), e is the error prediction for subject k at timepoint t, X is the serum biomarker concentration (or urine biomarker concentration, or can be another clinical predictor of interest), i is the specific biomarker indicator (biomarker number 1, 2, 3, etc.), n is the total number of X biomarker concentrations analyzed, l is the lth biomarker concentration collection timepoint, time is the number of weeks from baseline to final timepoint t, and therapy is the therapy indicator, methotrexate or infliximab. In this example, time=0 and 110 weeks wherever possible, and l=0, 6, 18 (biomarker concentrations determined at 0, 6, and 18 weeks, whenever available). Both random intercept and random slope models were evaluated, and only random intercept was included in the final models after evaluation.

Biomarkers were chosen in a forward stepwise procedure. One of the features of the serum model will be demonstrated by its ability to distinguish responses between therapies. Since subjects in the trial were assigned to two treatment arms, efficacy between treatment arms using predicted current rate of progression as an outcome measure could be tested. Specifically, the current progression rate in units per week for 0, 18, 54, and 110 weeks across two treatment arms was compared by using the model built with week 6 serum markers. Two-sample Wilcoxon rank test was applied for each timepoint, and corresponding p-values were reported.

### Results

### Clinical Trial Results

Detailed clinical outcomes of this study were previously reported. See PC Taylor et al., Arth. Rheum. 2004, 50:1107-1116; and, 2006, 54:47-53. In this study, US imaging measures (synovial thickness and PDA), serum biomarker levels, and disease activity were examined for ability to predict skeletal damage progression as measured by change in TSS. All subjects displayed erosions at baseline, but the change in TSS over the course of the study varied widely among subjects (median change of 6.25; interquartile range of 4-14.5). The diversity of radiographic outcomes in this study makes it well suited for the identification of biomarkers predictive of joint damage.

### Individual (Univariate) Biomarker Analysis

In order to identify biomarkers associated with joint damage progression, correlations were examined between individual biomarker concentrations during the course of the study. and the subsequent change in TSS. Biomarker data from single timepoints or combined from multiple timepoints were compared to the change in TSS from 0-54 weeks and 0-110 weeks. See Methods, above, for details.

Of the 90 candidate serum markers examined, 26 were significantly correlated with the 54 and 110 week changes in TSS when biomarker data from all timepoints were combined (FDR<0.05). The best performing markers represent diverse biological processes, including angiogenesis and leukocyte recruitment, synovial tissue inflammation and hyperplasia, and cartilage and bone metabolism. The highest correlations for serum markers were observed at 6 weeks after therapy initiation.

Of the 24 markers individually correlated to change in TSS, 20 were correlated with DAS28, 18 with PDA and 17 with synovial thickening. See FIG. 9. The majority of TSS-associated markers correlated with all 3 of these measures, and only two (FGF-2 and CCL2) were associated with none of them. However, while most markers of TSS progression were also associated with US and/or DAS28, many serum markers associated with synovial thickening (11/29), PDA (14/30) or DAS28 (16/36) were not associated with change in TSS. These findings suggest that Sharp score progression is primarily driven by, or associated with, the inflammatory processes reflected by US and DAS, but that various other inflammatory processes associated with US and DAS may not contribute to Sharp score. Markers associated with each of the measures spanned a broad range of marker types.

### Multivariate Models Based on Biomarkers, US, and DAS

Biomarker concentrations, US measurements, and DAS were evaluated and compared for their ability to predict joint damage progression. For each timepoint, models based on (1) combinations of serum markers, (2) synovial thickening, (3) PDA, and (4) DAS28 were used to predict changes in TSS over the first 54 weeks or the full 110 weeks of the study. The resulting correlation coefficients between predictions from the different approaches and timepoints and the actual rates of change in TSS are shown in FIG. 10. Treatment variables (measurement time and treatment modality) were also used in the predictive models.

Models based on multiple biomarkers, US, or DAS28 all performed well at predicting the rate of change in TSS, with predicted progression rates correlating to progression rates in TSS in the combined subject population (p<0.05). Among the different US measurements, predictions based on the week 18 assessment of PDA correlated most strongly with actual TSS progression rates (rho (Spearman correlation coefficient)=0.83 for week 54 progression). Early synovial thickening based predictions were also correlated to progression, although not as strongly (rho=0.69 for prediction of week 54 progression from pre-treatment or week 18 measurement). Thus, for US-based prediction of radiographic progression, week 18 assessment of synovial vascularity by PDA was optimal in this study. Biomarker-based predictions were also correlated to actual rates of TSS progression. The week 6 data yielded the best prediction of week 54 progression (Spearman's rho=0.87). See FIG. 11. Serum proteins prioritized for multivariate biomarker models are indicated in Table 1, and represent the diversity of marker types evaluated. Interestingly, of the seven markers prioritized in multivariate modeling, three (CCL2, FGF2, C2C) were not individually associated with either DAS or US measurements. Models combining biomarker and imaging data did not outperform models based on US or biomarkers alone (rho=0.686 for biomarkers+synovial thickening; rho=0.833 for biomarkers+PDA). DAS28-based predictions of rate of change in TSS were also correlated to actual progression rates. Predictions based on DAS28 assessed at 6 and 18 weeks performed comparably (rho=0.76 and 0.77, respectively, for prediction of 54-week progression) and outperformed pre-treatment based predictions. For all measurements, correlations were higher for prediction of 54-week progression than for prediction of 110-week progression. Comparing all prediction approaches, the week 6 serum biomarkers and week 18 PDA measurements yielded the highest correlation coefficients to TSS progression rate.

Because the prediction models include time and treatment variables, the measured variables (biomarkers, US, and DAS) were evaluated for their contribution to the predictive model. From Equation 1, the contribution of variable measurement Xto the predicted change in total Sharp score between two timepoints is given by the interaction term (Σᵢ₌₁β_{i+n,k}Xᵢₗₖ)·Δtime, in which the measurement is comparable to an average progression rate and is multiplied by the time interval (Δtime). Biomarkers, PDA, and DAS28 all made significant (p<0.05) contributions to their respective models via this term, whereas the contribution of synovial thickening, while not zero, did not meet the p<0.05 significance cutoff. These results confirm that measurements of biomarkers, PDA, and DAS28 significantly impact the corresponding predictive models, contributing information beyond what is derived from knowledge of treatment modality.

Analysis of Predictions within Infliximab Arm

Given previous suggestions that treatment with infliximab may result in dissociation of disease activity and radiographic progression, we further evaluated whether predictions based on measurement variables were significantly correlated to radiographic progression within the infliximab treatment arm. We used measurements at 6 weeks (for serum markers) or 18 weeks (for US and DAS28) to predict year 1 progression, and measurements taken at 54 weeks to predict year 2 progression in subjects on infliximab+methotrexate treatment throughout the entire study. The results indicate that predictions based on biomarkers or DAS28 are significantly correlated to actual progression rates within the IFX arm, with correlation coefficients of 0.45 and 0.61 respectively. See Table 3.

TABLE 3

| | | | | | MTX + IFX arm only | | |
|---|---|---|---|---|---|---|---|
| | MTX and MTX + IFX arms | | | | year 1 and 2 | | |
| | year 1 radiographic progression | | | | radiographic progression | | |
| | predictor | | correlation | | predictor | correlation | |
| | time-point | | coefficient | p | time-points | coefficient | p |
| serum biomarkers | 6 | wks | 0.81 | <0.001 | 6 & 54 wks | 0.45 | 0.023 |
| PDA | 18 | wk | 0.63 | 0.001 | 18 & 54 wks | 0.30 | 0.096 |
| ST | 0 | wks | 0.63 | 0.008 | 0 & 54 wks | 0.10 | 0.35 |
| DAS28-CRP | 6 or 18 | wks | 0.66 | <0.001 | 6 & 54 wks | 0.61 | 0.002 |

Correlations based on predictions using PDA or ST measurements were not found to be significant at the p<0.05 cutoff. It should be noted, however, that the small number of subjects on infliximab and the limited range of radiographic progression observed across these subjects make correlation a stringent test in this scenario.

### Modeling the Kinetics of Skeletal Response

The predictive models that were created based on biomarker, ultrasound, or disease activity measurements enable analysis of the time-dependent changes in skeletal structural damage progression in response to each treatment (infliximab and methotrexate). To simplify analysis of the results, the week 6 serum biomarkers were used to train a modified model that did not include treatment modality as a variable. The modified model was then applied to each timepoint of data to predict the dynamics of the progression rate evolution over the course of the trial. See FIG. 12.

The results suggest that the progression rate drops rapidly in response to infliximab, having essentially equilibrated by week 6. This is consistent with the rapid impact of infliximab on disease activity and the inflammatory processes that presumably drive skeletal damage. From week 54 to week 110 the progression rate remained essentially steady, at approximately 5 points per year (mean=0.12-0.13 points per week, median=0.1-0.13 points per week). Thus, in this study subjects still experienced steady structural damage progression despite up to two years of combination infliximab+methotrexate treatment, with no evidence of a long-term continued reduction in the progression rate.

Interpretation of the response to therapy within the first year in the methotrexate (i.e., placebo) arm was complicated by the early fluctuations in predicted progression rate. During the first year, however, the mean progression rate in the methotrexate arm was predicted to be significantly higher than in the infliximab arm, consistent with greater progression actually observed in the placebo arm in year 1. In contrast, after the second year of treatment, during which all subjects received active combination therapy, the progression rate approached that seen in subjects receiving infliximab throughout, with no significant difference in mean progression rate between treatment arms, and identical median progression rates. Again, this prediction reflects the comparable radiographic progression measured in both arms of the trial in the second year.

### Discussion

The analyses in methotrexate and infliximab treated subjects indicated that measurements of soluble biomarkers, DAS28, or ultrasound PDA, in combination with time and treatment variables, can be used to estimate rates of skeletal damage progression and predict subsequent joint damage in RA.

### Relationship to RA Pathophysiology

The ultrasound and biomarker measures that predicted skeletal damage progression in this study correspond to critical features of RA including synovial angiogenesis, leukocyte recruitment, innate and adaptive immune driven synovial inflammation, fibroblast hyperplasia and ultimately, cartilage and bone destruction (FIG. 8).

Angiogenesis: Angiogenesis and vascularization have been previously linked to skeletal damage progression in RA (refs), and are reflected both in US-PDA and molecular biomarkers correlated here with TSS, including growth factors (VEGF-A, FGF-2), chemokines (CXCL10, IL8, CCL2) and even acute phase proteins (SAA). In fact, VEGF-A, CXCL10, IL8, and SAA are also correlated to vascularity as measured by PDA, whereas FGF-2 and CCL2 are represented in the multivariate serum-marker progression models.

Leukocyte Recruitment: Recruitment and activation of leukocytes in the synovial tissue are critical drivers of synovial inflammation and synovial thickening, and ultimately damage progression in RA. Chemokines (CXCL10, CCL2, CCL4, IL8) that attract these cells to the synovial tissue are associated with skeletal damage progression and in some cases (CXCL10 and IL8), synovial thickening.

Innate Immunity: The role of innate cells such as macrophages and the cytokines they produce, especially TNF-a, IL-1b, and IL-6, is evidenced by the improvement in damage progression seen with corresponding cytokine targeted therapies (refs). Furthermore, these cytokines are key regulators of the hepatic acute phase response, responsible for the production of CRP and SAA. Notably, TNFR1, IL-1b, IL-6, and CRP are correlated individually to both synovial thickening and TSS progression, and are also prioritized by multivariate serum-marker models.

Adaptive Immunity: The adaptive immune response also critically contributes to skeletal damage progression. Positivity for rheumatoid factor and/or antibodies to citrullinated proteins is associated with more aggressive progression (refs), and reducing lymphocyte activity via costimulatory blockade with abatacept or via B cell depletion with rituximab affords skeletal benefit (refs). We found T and B/plasma cell derived molecules such as IL2R and kappa free light chains (KFLC) were individually correlated to both synovial thickening and skeletal damage progression, although these were not prioritized by multivariate modeling.

Fibroblast activation: Tissue fibroblasts also contribute to synovial inflammation and hyperplasia, and directly drive cartilage degradation through elaboration of MMP-1 and MMP-3. These cells are major producers of IL-6, chemokines, and growth factors such as FGF-2, VEGF, and possibly EGF that affect the proliferation and tissue remodeling activity of fibroblasts. Thus, the association of some of these markers with synovial thickening, and all of them with skeletal damage progression also reflects fibroblast activity.

Skeletal destruction: TNF-a, IL-1b, and IL-6 stimulate chondrocyte production of MMPs and TIMPs that influence cartilage degradation and the release of matrix molecules including aggrecan, hyaluronan and collagen degradation products including C2C, C12C, CTXII and pyridinoline. Cytokines and growth factors including M-CSF, TNF-a, IL-1b, IL-6, and VEGF-A also promote differentiation and activation of osteoclasts and thereby bone erosion and the release of collagen peptides such as pyridinoline and ICTP. Thus, markers directly driving or derived from skeletal damage also correlate with TSS.

Predicting radiographic progression in combined subject population: The markers and measurements described were used to develop predictive models of damage progression across the trial population. Among US measurements considered, predictions based on 18-week PDA data were optimal for prediction of TSS progression rate. Synovial thickening based predictions did not perform as well as PDA, and did not make a significant contribution (p<0.05) to models including time and treatment variables. Although PDA performed well at predicting damage progression, US imaging may not be available or practical in some clinical settings (refs). Broad utility will ultimately depend on procedural standards, operator skill, equipment quality, and interoperator and intermachine reproducibility (Taylor 2004). Thus, marker-based approaches could offer a useful complementary approach to assessing skeletal damage progression risk and therapeutic response. We examined 93 serum markers and identified 26 of these as individually associated with changes in TSS. For individual markers, correlations were highest at 6 weeks post therapy initiation. Multivariate predictions of rate of change in TSS based on 6 week serum data were correlated to measured changes in TSS. For the various approaches (US, biomarker, clinical variables), markers, and timepoints considered, the highest correlation coefficients in this study were observed for predictions based on multiple serum markers at 6 weeks.

Predictions were generally more accurate when using data collected after therapy initiation. Presumably, the time lag from treatment initiation allows the biomarkers, synovial measures, and DAS scores associated with ongoing damage to register the impact of the new treatment as it alters the rate of ongoing destruction. The peak performance of data obtained within 6-18 weeks after treatment initiation suggests that the longer term effects of therapy on skeletal outcome can be evaluated early in the treatment course. However, due to the inclusion of treatment modality in the prediction models, even baseline measures are predictive of post-treatment damage progression, and temporal differences are hard to assess due to the limited size of the trial. Even so, the finding that early measurements are useful is encouraging, as rapid detection of changes in response to therapy can enable earlier treatment optimization by informing clinical decisions regarding therapy continuation, dose modification, or treatment alteration, ideally reducing long term damage and disability. In addition to improving individualized subject management, early prediction of skeletal impact can also benefit clinical research and drug development by allowing evaluation of skeletal responsiveness in shorter clinical trials which currently focus on faster-responding disease activity measures for efficacy proof of concept and dose-finding.

Radiographic progression in infliximab-treated subjects: Notably, these results were obtained for clinical intervention with MTX alone and in combination with anti-TNF therapy. The value of treatment modality as a variable in the prediction of progression suggests that the quantitative relationship between predictive measurements and skeletal damage progression depends on treatment. However, the fact that serum biomarkers, PDA, and DAS28 contribute significantly to the corresponding models indicates that these measurements provide additional predictive information beyond knowledge of treatment alone. Some studies have suggested a dissociation of disease activity and radiographic progression with anti-TNF, but not MTX, treatment. For example, analysis of the ATTRACT trial of IFX+MTX in MTX inadequate responders (Lipsky 2000, Smolen 2005) reported no evidence of radiographic progression in IFX-treated subjects, even in ACR20 or DAS nonresponders. Thus, it is critical to demonstrate that approaches for prediction of skeletal damage progression can be applied not only to MTX treated subjects, but also to IFX treated subjects. In this study, biomarker and DAS-based model predictions were significantly correlated with actual progression in each trial arm separately, indicating that DAS and biomarkers are not dissociated from skeletal damage progression. In fact, the ATTRACT data also showed significant if weak correlations between absolute DAS and radiographic progression (rho=0.25, p<0.001 at 54 weeks; rho=0.18 p=0.003 at 102 weeks) (Lipsky 2001 letter), and the ASPIRE study of IFX+MTX in MTX-naïve subjects found a relationship between residual disease activity and progression, although the slope of the relationship was lower in the IFX+MTX than in the MTX monotherapy arm. See Smolen, 2010. In this study, the relationship between DAS and progression appears strong (rho=0.61, p=0.002) for DAS-based prediction in the IFX arm. This may in part be due to a wide range of rates of structural damage progression, including many rapid progressors, in this study, enabling detection of correlations. The fact that all DAS evaluations were performed by the same physician, eliminating inter-observer variability, might also contribute to the strong relationship between DAS and progression. Biomarker-based model predictions were also shown to be significantly correlated with progression within the IFX arm (rho=0.45, p=0.02) and may offer an objective approach less susceptible to subjective variability.

These results suggest that predictive approaches do indeed benefit from appropriate sampling of inflammatory pathways, even in anti-TNF treated subjects. Thus, our results support the view that TNF-a blockade does not decouple inflammation and skeletal damage but rather modifies the quantitative relationship between the two processes, and that at least biomarker and DAS based models, in combination with treatment information, are valuable in predicting damage progression in anti-TNF treated subjects, a finding which should be verified in larger clinical studies with broader ranges of subject responses within each arm.

Finally, this Example illustrates how progression markers and models can be used to analyze the dynamics of progression rate over time in response to different therapies. Our results indicate that skeletal protection by infliximab is due to a rapid, early reduction in progression rate after initiation of therapy as opposed to a gradual easing of damage. A steady radiographic trajectory appears to be maintained starting at 6 weeks and continuing to the end of the two year trial, suggesting that subjects still experiencing damage progression may require further treatment modification. Furthermore, at the end of the second year, the median progression rates in both arms were identical, indicating that the one year delay in initiation of infliximab did not compromise its ability to reduce progression rate.

### SUMMARY

This Example demonstrates the use of multi-biomarker based models for early prediction of radiographic progression. Starting with a large initial panel of serum markers, specific markers were identified that are predictive of progression, either individually or in multivariate models, and evaluated the relationship of these markers to other predictors of progression, including ultrasound and disease activity measurements. The relationship of the biomarkers and ultrasound measurements to the pathophysiologic processes of angiogenesis, leukocyte recruitment, synovial inflammation, fibroblast hyperplasia, and cartilage and bone metabolism provide evidence of a critical crosstalk between these processes and damage progression, even in anti-TNF treated subjects. Development of validated predictive tests for skeletal damage progression through further modeling and testing in datasets from large trials with varied treatment modalities and responses offers a chance to revolutionize subject monitoring and treatment in rheumatoid arthritis.

### Example 2

Example 2 demonstrates that biomarkers used according to the methods of the present teachings correlate with MRI measurements of joint inflammation and damage.

In this Example, samples were analyzed from 36 pairs of patient visits with serial MRI scans, scored using the RAMRIS method by Synarc. Approximately 60 samples were completely processed and analyzed. The serum levels obtained from 118 biomarker assays were analyzed in these samples. Biomarker concentrations were used to predict absolute MRI scores (erosion, synovitis, osteitis, and joint space narrowing) as well as rate of change of erosion and joint space narrowing.

### Methods

Assays were designed, in multiplex or ELISA format, for measuring multiple disease-related protein biomarkers. These assays were identified through a screening and optimization process, prior to assaying the samples. All markers were analyzed by one of three platforms: ELISA, MSD®, or LUMINEX®. The respective assays, vendors, and platforms used for the set of SDMRK biomarkers specifically were as follows: CCL22, Meso Scale Discovery, MSD®; CHI3L1 (YKL-40), Quidel, ELISA; COMP, Immuno-Biological Laboraties (IBL-America), ELISA; CRP, Meso Scale Discovery, MSD®; CSF1, Meso Scale Discovery, MSD®; CXCL10, Meso Scale Discovery, MSD®; EGF, R&D Systems, LUMINEX®; ICAM1, Meso Scale Discovery, MSD®; ICAM3, Meso Scale Discovery, MSD®; ICTP, Immunodiagnostic Systems (IDS), ELISA; IL1B, Meso Scale Discovery, MSD®; IL2RA, Millipore, LUMINEX®; IL6, R&D Systems, LUMINEX®; IL6R, Millipore, LUMINEX®; IL8, Meso Scale Discovery, MSD®; LEP, R&D Systems, LUMINEX®; MMP1, R&D Systems, LUMINEX®; MMP3, R&D Systems, LUMINEX®; PYD, USCN Life Science, ELISA; RETN, R&D Systems, LUMINEX®; SAA1, Meso Scale Discovery, MSD®; THBD, Meso Scale Discovery, MSD®; TIMP1, R&D Systems, LUMINEX®; TNFRSF11B, Meso Scale Delivery, MSD®; TNFRSF1A, Meso Scale Delivery, MSD®; TNFSF11, Millipore, LUMINEX®; VCAM1, Meso Scale Discovery, MSD®; and, VEGFA, R&D Systems, LUMINEX®.

All assays were performed following the manufacturer's instructions, with subject samples randomly assigned to the sample positions on the plate layouts. Four pooled sera, from healthy, RA, SLE and osteoarthritis (OA) subjects, were included in each assay plate as process controls. All samples were assayed at least in duplicate. Seven-point calibration curves were constructed for each biomarker for an accurate determination of the measureable range of test sera.

Prior to statistical analyses, all assay data were reviewed for pass/fail criteria as predefined by standard operating procedures, including inter-assay CV, intra-assay CV, percent number of samples within the measureable range of the calibration curve, and four serum process controls within the range of the calibration curve. The biomarker values that were not in the measureable range of the calibration curves were marked as missing data, and imputed by the lowest/highest detected value across all the samples within a given biomarker assay. No imputation was performed for the univariate analyses. For multivariate analysis, missing data imputation methods commonly used in microarray expression data and well-known in the art were used. See, e.g., R. Little and D. Rubin, Statistical Analysis with Missing Data, 2nd Edition 2002, John Wiley and Sons, Inc., NJ. Biomarkers were excluded from analysis where more than 20% of the data were missing, and the remaining data were imputed by the KNN algorithm (where k=5 nearest neighbors). KNN functions on the intuitive idea that close objects are more likely to be in the same category. Thus, in KNN, predictions are based on a set of prototype examples that are used to predict new (i.e., unseen) data based on the majority vote (for classification tasks) over a set of k-nearest prototypes. Given a new case of dependent values (query point), one would like to estimate the outcome based on the KNN examples. KNN achieves this by finding k examples that are closest in Euclidian distance to the query point.

Correlation test was used for identifying biomarkers that had association with the current MRI measures. Markers were also identified that differed in serum levels between subjects whose RAMRIS erosion scores increased, and those whose scores did not. For this analysis, the methodology of Significance Analysis of Microarrays (SAM) was used. See Tibshirani and Chu, PNAS 2001, 98:5116-5121. In this Example the two groups being compared were the eroders and non-eroders (based on any increase in the erosion score), and the marker levels were compared between erosion groups. The Score(d), then, was derived from Numerator (r)/Denominator (s+s0), where Numerator (r) is the difference between the two groups, and Denominator (s+s0) is the standard deviation. The Fold Change is the ratio of two values, describing how much the two values differ. The q-value measures how significant the marker is: as d>0 increases, the corresponding q-value decreases. It is also a multiple comparison test.

### Results

Markers were identified that correlated cross-sectionally with MRI measures of current joint inflammation and damage, based on erosion, osteitis, and synovitis scores. FIG. 13 indicates the Spearman correlation values for each biomarker's correlation with the erosion score, FIG. 14 indicates the Spearman correlation values associated with osteitis scores, and FIG. 15 indicates the Spearman correlation values associated with synovitis scores. In each figure, ObsCorr is the observed correlation between biomarker level and the particular MRI score; PermP-value is the p-value for that ObsCorr via the permutation test; AdjPermFDR is the false discovery rate for that PermP-value (e.g., an AdjPermP-value of 0.2 means 20% of the biomarker levels could be expected to be false positives for that ObsCorr value); AsymP-value is the p-value for that ObsCorr via the parametric test; and, AdjCorrTestFDR is the FDR for that AsymP-value.

FIG. 17 demonstrates these results. Score(d) in this FIG. 17 is a test statistic in the SAM method, analogous to the T-test that is used when comparing groups. A total of 21 biomarkers were identified as being associated with progression (q<0.2).

The results of this Example demonstrate that by measuring the concentration level for a given marker at timepoint 1, one can predict whether there will be an increase in a subject's erosions from that timepoint 1 to timepoint 2.

Because osteitis and synovitis joint inflammation are prognostic of subsequent joint structural damage (see, e.g., P. Boyesen, E A Haavardsholm et al., “MRI synovitis is associated with subsequent joint damage in early rheumatoid arthritis patients,” presentation at American College of Rheumatology 2008 Annual Scientific Meeting), the methods of the present teachings are thus prognostic of a subject's future structural damage.

### Example 3

Example 3 demonstrates the identification of biomarkers correlated with change in total Sharp score, and the use of the present teachings in differentiating between RA subjects that are and are not experiencing joint erosion (“eroders” and “non-eroders,” respectively).

For this Example, samples were obtained from 249 RA subjects with X-ray data. The duration of RA for all subjects at time of sampling was from two to ten years. All subjects were on DMARD therapy (not biologics). Subjects were categorized as eroders vs. non-eroders, 125 of each, as identified by standard qualitative radiologist X-ray reads. Candidate biomarkers were analyzed as in Example 2 by implementing SAM. Markers were identified that differed in concentration between eroders and non-eroders, based on cross-sectional X-rays, using SAM (see Example 2). Only samples less than four years old were used, because serum protein concentrations were found to decrease as the amount of time samples were stored at −80° C. increased (data not shown).

A total of 36 candidate markers were found to differ in serum concentration between eroders and non-eroders. See FIG. 18 for results (the headers in this figure have the same meaning as in FIGS. 13-15).

The results indicated that for a given marker, the average concentration level in the eroder group was greater than the average concentration level in the non-eroder group.

### Example 4

Example 4 demonstrates the transformation of observed biomarker levels into an SDI score by various statistical modeling methodologies, which SDI score serves as a quantitative measurement of the rate of change in joint structural damage, as for measuring the extent of disease progression in inflammatory disease, in this example RA. Certain embodiments of the present teachings comprise utilizing the SDMRK set of biomarkers for determining an SDI score that demonstrates high association with the rate of change in joint structural damage, and performs better than DAS28-ESR, CRP, DAS28-ESR with CCP, or DAS28-ESR with RF in predicting rate of change in Sharp score.

A total of 90 candidate biomarkers were examined in serum samples obtained at two timepoints, baseline and Year1, from 160 of the subjects enrolled in the BeSt trial (“BeSt” being the Dutch acronym for Behandel-Strategieën, “treatment strategies), a five-year blinded study to compare four different treatment arms for aggressive early RA—standard, sequential DMARD monotherapy, starting with MTX; step-up combination DMARD therapy, starting with MTX only, then adding other DMARDs and prednisone; combination therapy with MTX and prednisone; and, combination therapy with MTX and infliximab. See Y P M Goekoop-Ruiterman et al., Arth. Rheum. 2005, 52(11):3381-3390. Van der Heijde-modified Sharp scores (mSS) and clinical data including Disease Activity Scores (DAS28-CRP) were obtained at baseline, Year1 and Year2. The concentrations of individual biomarkers at baseline and Year1 were assessed for their association with change in total mSS at Year2, to thus demonstrate the power of the biomarkers in predicting total change in mSS. See FIG. 19.

Statistical models were built using combinations of serum biomarkers to predict the rate of change in total mSS (TSS). In these models, biomarker levels determined at a timepoint A were used to predict the average rate of change in mSS between that timepoint A and a timepoint B. In this Example, A and B were roughly 12 months apart. A predicted rate of change in total mSS(RSS) was thus determined using a statistical model and incorporating the levels of combinations of serum biomarkers. This predicted rate of change for a subject was denoted as the Structural Damage Index (SDI). A linear model was built with the algorithm as follows: SDIₖ=β₀+Σᵢ₌₁ⁿβᵢXᵢₖ+eₖ where Xᵢₖ is the marker concentration for the ith biomarker and kth patient, β is the biomarker coefficient, e is the error prediction for subject k, and SDIₖ represents the predicted change in mSS from the time that the biomarkers are measured over the next 12 months for subject k. Lasso, a penalized regression method, was used to estimate the coefficients β for the model. A statistical method was discovered that enhanced the prediction of the RSS; vis., the Multivariate Response with Curds and Whey (see L. Breiman and J H Friedman, J. R. Statist. Soc. B 1997, 59(1):3-54) in combination with Lasso (Curds and Whey Lasso, or CW-Lasso; see R. Tibshirani, J. R. Statist. Soc. B 1996, 58(1):267-288). This method was used to predict RSS and Disease Activity Score (DAS) simultaneously, and used the predicted value of DAS to enhance SDI. In other words, the prediction of SDI used the DAS information without requiring the DAS itself to be a predictor in the model. Hence, DAS was only required for model training process, but not to validate the model.

Good disease control may influence the rate of change in mSS; hence, additional analyses incorporating therapy change information into the biomarker model were also performed. Various models, built by conventional statistical measures as described herein, were compared to the serum biomarker model. Performance of the models was evaluated by the Pearson correlation coefficient between actual and predicted rates of change and by the area under the ROC curve (AUC) in cross-validated test sets. Mean mSS rate of change in the test sets was used to dichotomize subjects into high and low groups for the AUC calculation.

Serum biomarker combinations were identified that were able to predict radiographic progression in joint structural damage with a correlation of R=0.52 and AUC=0.73, which was superior to predictions based on DAS28-ESR(R=0.33, AUC=0.61), CRP (R=0.38, AUC=0.67), DAS28-ESR with CCP (R=0122, AUC=061), or RE (R=0.37, AUC=0.62). See FIG. 20. In total, 35 individual biomarkers were associated with joint damage progression (false discovery rate<0.1). Incorporating therapy information into the biomarker model did not change the model performance.

Multiple-biomarker models useful in predicting structural damage were developed based on the teachings of this and other examples herein. See FIGS. 1 to 5.

The best-performing models included markers of bone and cartilage destruction, pro-inflammatory cytokines and acute phase proteins. Combinations of biomarkers were able to predict radiographic outcomes despite therapy changes and good control of disease activity. Serum biomarker-based indices have the potential to improve prediction of structural damage progression over standard clinical measures of disease activity in RA subjects.

### Example 5

Example 5 describes the process whereby biomarkers can be used to predict radiographic joint structural damage progression, even when serum biomarker concentrations are not obtained at baseline.

### Methods

In this Example, biomarkers levels were measured by 79 biomarker assays in 256 samples, from 195 RA subjects on stable therapy. The subjects were evaluated at three timepoints: baseline, Year1, and Year2. Sharp scores were obtained at baseline and at Year2, and the serum concentration levels of 71 candidate markers were determined at Year1 and Year2. See FIG. 21. The objective was to use biomarkers to estimate the change in Sharp score; i.e., biomarker levels at Year1 and Year2 to predict change in Sharp score from baseline to Year2. Correlation test was used for testing each individual biomarker assay's association with the change of mSS from baseline to Year2 using biomarker at Year1 and Year2 separately. False Discovery Rate was used for multiple testing correction. Biomarkers at Year1 had the strongest signals.

The results demonstrated 20 biomarkers that were significantly associated with joint damage either using Year 1 or Year 2 biomarker measurements. See FIG. 22. The results also demonstrated that biomarkers can associate with the rate of change in mSS even when they are not measured simultaneously with the first mSS.

### Example 6

A multi-biomarker structural damage score using combined information from serum biomarkers to predict the risk and quantity of joint damage over 12 months in individual patients. Among clinical variables, starting SHS, erosion score, and several clinical measures of disease activity were predictive of radiographic progression. Multi-biomarker structural damage (MBSD) scores had stronger observed associations with radiographic progression than clinical variables. MBSD scores and starting erosion scores were independently predictive of radiographic progression. Limitations included the fact that patients generally had early RA and that therapy and therapy changes were not taken into account. This study demonstrates that biomarker approaches can provide clinically useful information about patients' risk of progressive joint damage.

### Patients and Clinical Data

307 serum samples were selected from 187 patients in an early arthritis cohort (van Aken J, et al. Clin Exp Rheumatol. 2003; 21(5 suppl 31):S100-S105. and de Rooy D P, et al. Rheumatol. 2011; 50(1):93-100. Epub 2010 Jul. 16.) Patients were required to have a diagnosis of RA based on 1987 ACR criteria. A patient was deemed to have erosions if the starting x-ray erosion score was >0. Since most patients in the entire cohort did not experience any increase in the Sharp-van der Heijde Score (SHS) over a 12-month period, we enriched for progressive joint damage in order to increase power to observe associations between biomarkers and progression. Patients were selected with these objectives:
One-third of patients with 12-month change in SHS (Δ SHS) hi
One-third of patients with Δ SHS-t
One-third of patients with 0<Δ SHS<5

As a result, visits other than baseline were used for some patients.

### Sample Handling, Assay Methods,

28 biomarkers were measured using quantitative immunoassays:
CCL-22, CRP, EGF, ICAM-1, IL-1B, IL-6, IL-6R, IL-8, leptin, MMP-1, MMP-3, resistin (res), SAA, TNF-RI, VCAM-1, VEGF, and YKL-40 were measured using customized assays on the Meso Scale Discovery MULTI-ARRAY™ platform.
COMP, CXCL-10, ICAM-3, ICTP, IL-2RA, M-CSF, OPG, PYD, RANKL, thrombomodulin and TIMP1 were measured using individual ELISAs.
Due to limited sample volume, ICTP, RANKL, COMP, and ICAM-3 were measured in only 50 of the 307 samples.

### Statistical Analysis

The ability of biomarkers or clinical variables at a visit was analysed for utility in predicting joint-damage progression over the following 12 months. To account for the effects of multiple hypothesis testing, the statistical significance of individual biomarker correlations with Δ SHS was evaluated by the false discovery rate (FDR) method of Benjamini and Hochberg. (Benjamini Y, Hochberg Y. J R Stat Soc Series B Stat Methodol. 1995; 57:289-300.) To assess the performance of multivariate algorithms at predicting Δ SHS, linear models were trained to predict Δ SHS as a continuous variable using LASSO regression. (Tibshirani R. J R Stat Soc Series B Methodol. 1996; 58(1):267-288.) To evaluate sensitivity, specificity, and classification accuracy, models were trained to predict whether or not patients would experience joint-damage progression by logistic regression using the Δ SHS estimate from linear SDI models as predictor variable. (Friedman J, et al. J Stat Softw. 2010; 33(1):1-22.) Performance of SDI models was evaluated in Leave One Out cross-validation. To identify independent predictors of Δ SHS, multivariate linear models were fitted using ordinary least squares (OLS) regression.

Clinical Variables Associated with Joint-Damage Progression

At the first visit included for each patient in the study (which was not necessarily their first visit as part of the Early Arthritis Cohort), patients exhibited mostly low disease activity (median DAS=2.3, FIG. 23). In total, 94% of patients had evidence of erosions (starting erosion score>0). The median 12-month Δ SHS was 1 (FIG. 24).

Of the clinical variables mentioned in FIG. 23, the following had significant Spearman correlations with Δ SHS over the 12 months following the study visit (FDR<0.05, FIG. 25): starting erosion score, starting SHS, ESR, starting JSN score, SJC44, CRP, and DAS. RF titre, anti-CCP titre, RAI, Patient Global VAS, and age were not significantly correlated to Δ SHS.

Individual Biomarkers Associated with Joint-Damage Progression

The concentrations of 16 biomarkers (ICAM-1, IL-1B, IL-6, MMP-1, MMP-3, SAA, TNF-RI, VCAM-1, VEGF, CXCL-10, ICTP, IL-2RA, PYD, RANKL, resistin and CRP) were correlated with Δ SHS (FIG. 26, FDR<0.05) in prespecified algorithms. All statistically significant correlations were positive. IL-6 had the highest correlation to Δ SHS overall and YKL-40 had the highest correlation to Δ SHS in anti-CCP negative patients. These biomarkers represented a variety of pathways and functional classes, including pro-inflammatory cytokines, adhesion molecules, metalloproteinases, and breakdown products of bone and cartilage (FIG. 27). FIG. 27 shows the 16 biomarkers with significant correlations to ΔSHS, plus ACPA. Thin arrows represent interactions, and each is annotated with the names of biomarkers that play a role in that interaction.

### Performance of Multi Biomarker SDI Algorithms

Algorithms combining biomarker concentrations into an SDI score were developed and compared with clinical variables for predicting joint-damage progression. Performance was evaluated by area under the receiver operator characteristic curve (AUROC) for predicting whether patients would experience Δ SHS>1, the median amount of progression. The SDI score, based on biomarkers alone, had greater observed AUROC (0.73) than the best-performing clinical variables (FIG. 28), although the difference was not statistically significant (p>0.05). To assess the prediction performance of combined information available in clinical practice, multivariate models incorporating commonly available variables (SJC44, CRP, ESR, anti-CCP status, presence of erosions, RAI, Patient Global, and RF status) were evaluated. These combined clinical models gave higher observed AUROC than the individual constituent variables, but lower than the SDI score (FIG. 28). A combined model including SDI biomarkers and the starting erosion score had the highest observed AUROC (0.74, FIG. 28). Similar patterns of relative performance were observed for correlation with Δ SHS. For the SDI score identifying patients with above median progression, the sensitivity, specificity, and overall accuracy were 63%, 73%, and 68%, respectively.

### Analysis of Independent Predictors of Joint-Damage Progression

In OLS regression, starting erosion score (p<0.001) and SDI score (p=0.002) were independent predictors of Δ SHS (FIG. 29).

1. A method for scoring a sample, said method comprising:
receiving a first dataset associated with a first sample obtained from a first subject,
wherein said first dataset comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP 1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); and,
determining a first SDI score from said first dataset using an interpretation function,
wherein the first SDI score provides a quantitative measure of the rate of change in joint structural damage in said first subject.

2. The method of claim 1 wherein said first dataset is obtained by a method comprising:
obtaining said first sample from said first subject, wherein said first sample comprises a plurality of analytes;
contacting said first sample with a reagent;
generating a plurality of complexes between said reagent and said plurality of analytes; and,
detecting said plurality of complexes to obtain said first dataset associated with said first sample, wherein said first dataset comprises quantitative data for said at least two markers.

3. The method of claim 1, wherein said first subject diagnosed with an inflammatory disease.

4. The method of claim 3, wherein said inflammatory disease is rheumatoid arthritis.

5. The method of claim 1, wherein said first SDI score is predictive of the rate of change of a clinical assessment.

6. The method of claim 1, wherein said interpretation function is based on a predictive model.

7. The method of claim 1, wherein said joint structural damage comprises joint erosion and joint space narrowing.

8. The method of claim 5, wherein said clinical assessment is selected from the group consisting of: a DAS, a DAS28, a DAS28-ESR, a DAS28-CRP, a RAMRIS, a Sharp score, a total Sharp score (TSS), a van der Heijde-modified Sharp score, a van der Heijde modified total Sharp score, a tender joint count, a swollen joint count, a joint space narrowing score, an erosion score, and an ultrasound score.

9. The method of claim 5, wherein said clinical assessment is a Sharp score.

10. The method of claim 5, wherein said clinical assessment is a total Sharp score.

11. The method of claim 6, wherein said predictive model is developed using an algorithm comprising a Curds and Whey method, Curds and Whey-Lasso method, forward linear stepwise regression, or a Lasso shrinkage and selection method for linear regression.

12. The method of claim 1, further comprising:
receiving a second dataset associated with a second sample obtained from said first subject, wherein said first sample and said second sample are obtained from said first subject at different times;
determining a second SDI score from said second dataset using said interpretation function; and,
comparing said first SDI score and said second SDI score to determine a change in said SDI scores, wherein said change indicates a change in said rate of joint structural damage in said first subject.

13. The method of claim 12, wherein said indicated change in rate of joint structural damage indicates the presence, absence or extent of the subject's response to a therapeutic regimen.

14. The method of claim 10, further comprising determining a prognosis for rheumatoid arthritis progression in said first subject based on said predicted Sharp score change rate.

15. The method of claim 1, wherein one of said at least two markers is CRP or SAA1.

16. The method of claim 10, wherein said interpretation function is SDIₖ=β₀+Σᵢ₌₁ⁿβᵢXᵢₖ+eₖ, where Xᵢₖ is the marker concentration for the ith biomarker and kth patient, β is the biomarker coefficient, and SDIₖ represents the predicted change in Sharp score from the time that the biomarkers are measured over the period of interest for subject k.

17. The method of claim 1, wherein said SDI score is used as an inflammatory disease surrogate endpoint.

18. The method of claim 17, wherein said inflammatory disease is rheumatoid arthritis.

19. A method for determining a presence or absence of rheumatoid arthritis in a subject, the method comprising:
determining SDI scores according the method of claim 1 for subjects in a population wherein said subjects are negative for rheumatoid arthritis;
deriving an aggregate SDI value for said population based on said determined SDI scores;
determining a second SDI score for a second subject;
comparing the aggregate SDI value to the second SDI score; and
determining a presence or absence of rheumatoid arthritis in said second subject based on said comparison.

20. The method of claim 1, wherein said first subject has received a treatment for rheumatoid arthritis, and further comprising the steps of:
determining a second SDI score according to the method of claim 1 for a second subject wherein said second subject is of the same species as said first subject and wherein said second subject has received treatment for rheumatoid arthritis;
comparing said first SDI score to said second SDI score; and,
determining a treatment efficacy for said first subject based on said score comparison.

21. The method of claim 1, further comprising determining a response to rheumatoid arthritis therapy based on said SDI score.

22. The method of claim 1, further comprising selecting a rheumatoid arthritis therapeutic regimen based on said SDI score.

23. The method of claim 1, further comprising determining a rheumatoid arthritis treatment course based on said SDI score.

24. The method of claim 1, further comprising rating a rate of change in joint structural damage as low, medium or high based on said SDI score.

25. The method of claim 1, wherein the predictive model performance is characterized by an AUC ranging from 0.60 to 0.99.

26. The method of claim 1, wherein the predictive model performance is characterized by an AUC ranging from 0.70 to 0.79.

27. The method of claim 1, wherein the predictive model performance is characterized by an AUC ranging from 0.80 to 0.89.

28. The method of claim 1, wherein said at least two markers (IL2RA and IL6), (IL2RA and SAA1), (IL6 and SAA1), (IL1B and IL2RA), (TNFRSF11B and IL6), (ICAM1 and IL6), (IL6 and PYD), (CCL22 and IL6), (CHI3L1 and IL6), (CRP and IL6), (IL6 and MMP3), (ICAM3 and IL2RA), (IL6 and VEGFA), (IL6 and RANKL), (ICAM3 and IL6), (IL6 and THBD), (IL6 and MCSF), (IL6 and TNFRSF1A), (IL6 and LEP), (IL6 and IL6R), (IL6 and VCAM1), (IL6 and IL8), (COMP and IL6), (IL2RA and RETN), (IL6 and RETN), (IL2RA and IL6R), (IL6 and MMP1), (TNFRSF11B and RETN), (COMP and IL2RA), (IL1B and IL6), (IL6 and TIMP1), (CHI3L1 and RETN), (IL2RA and LEP), (IL2RA and TIMP1), (CXCL10 and IL6), (EGF and IL6), (IL2RA and RANKL), (IL2RA and MMP3), (IL2RA and THBD), (IL1B and SAA1), (LEP and SAA1), (CRP and IL2RA), (ICTP and IL6), (IL2RA and MCSF) or (ICAM1 and IL2RA).

29. The method of claim 1, wherein said at least two markers comprise one set of markers selected from the group consisting of TWOMRK Set Nos. 1 through 138 of FIG. 1.

30. The method of claim 1, wherein said at least two markers comprises at least three markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

31. The method of claim 1, wherein said at least two markers comprises one set of three markers selected from the group consisting of THREEMRK Set Nos. 1 through 482 of FIG. 2.

32. The method of claim 1, wherein said at least two markers comprises at least four markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

33. The method of claim 1, wherein said at least two markers comprises one set of four markers selected from the group consisting of FOURMRK Set Nos. 1 through 25 of FIG. 3.

34. The method of claim 1, wherein said at least two markers comprises at least five markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

35. The method of claim 1, wherein said at least two markers comprises one set of five markers selected from the group consisting of FIVEMRK Set Nos. 1 through 30 of FIG. 4.

36. The method of claim 1, wherein said at least two markers comprises at least six markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

37. The method of claim 1, wherein said at least six markers comprises one set of six markers selected from the group consisting of SIXMRK Set Nos. 1 through 36 of FIG. 5.

38. The method of claim 1, further comprising reporting said SDI score to said first subject.

39. The method of claim 1, wherein said first SDI score is predictive of the risk of joint structural damage progression.

40. A computer-implemented method for scoring a sample, said method comprising:
receiving a first dataset associated with a first sample obtained from a first subject,
wherein said first dataset comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP 1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); and,
determining by one or more processors a first SDI score from said first dataset using an interpretation function, wherein the first SDI score provides a quantitative measure of the rate of change in joint structural damage in said first subject.

41. The computer-implemented method of claim 40 wherein said first dataset is obtained by a method comprising:
obtaining said first sample from said first subject, wherein said first sample comprises a plurality of analytes;
contacting said first sample with a reagent;
generating a plurality of complexes between said reagent and said plurality of analytes; and,
detecting said plurality of complexes to obtain said first dataset associated with said first sample, wherein said first dataset comprises quantitative data for said at least two markers.

42. The computer-implemented method of claim 40, wherein said first subject diagnosed with an inflammatory disease.

43. The computer-implemented method of claim 42, wherein said inflammatory disease is rheumatoid arthritis.

44. The computer-implemented method of claim 40, wherein said first SDI score is predictive of the rate of change of a clinical assessment.

45. The computer-implemented method of claim 40, wherein said interpretation function is based on a predictive model.

46. The computer-implemented method of claim 40, wherein said joint structural damage comprises joint erosion and joint space narrowing.

47. The computer-implemented method of claim 44, wherein said clinical assessment is selected from the group consisting of: a DAS, a DAS28, a DAS28-ESR, a DAS28-CRP, a RAMRIS, a Sharp score, a total Sharp score (TSS), a van der Heijde-modified Sharp score, a van der Heijde modified total Sharp score, a tender joint count, a swollen joint count, a joint space narrowing score, an erosion score, and an ultrasound score.

48. The computer-implemented method of claim 44, wherein said clinical assessment is a Sharp score.

49. The computer-implemented method of claim 44, wherein said clinical assessment is a total Sharp score.

50. The computer-implemented method of claim 45, wherein said predictive model is developed using an algorithm comprising a Curds and Whey method, Curds and Whey-Lasso method, forward linear stepwise regression, or a Lasso shrinkage and selection method for linear regression.

51. The computer-implemented method of claim 40, further comprising:
receiving a second dataset associated with a second sample obtained from said first subject, wherein said first sample and said second sample are obtained from said first subject at different times;
determining by said one or more processors a second SDI score from said second dataset using said interpretation function; and,
comparing by said one or more processors said first SDI score and said second SDI score to determine a change in said SDI scores, wherein said change indicates a change in said rate of joint structural damage in said first subject.

52. The computer-implemented method of claim 51, wherein said indicated change in rate of joint structural damage indicates the presence, absence or extent of the subject's response to a therapeutic regimen.

53. The computer-implemented method of claim 49, further comprising determining a prognosis for rheumatoid arthritis progression in said first subject based on said predicted Sharp score change rate.

54. The computer-implemented method of claim 40, wherein one of said at least two markers is CRP or SAA1.

55. The computer-implemented method of claim 49, wherein said interpretation function is SDIₖ=β₀+Σᵢ₌₁ⁿβᵢXᵢₖ+eₖ, where Xᵢₖ is the marker concentration for the ith biomarker and kth patient, β is the biomarker coefficient, and SDIₖ represents the predicted change in Sharp score from the time that the biomarkers are measured over the period of interest for subject k.

56. The computer-implemented method of claim 40, wherein said SDI score is used as an inflammatory disease surrogate endpoint.

57. The computer-implemented method of claim 56, wherein said inflammatory disease is rheumatoid arthritis.

58. A computer-implemented method for determining a presence or absence of rheumatoid arthritis in a subject, the method comprising:
determining SDI scores according the method of claim 40 for subjects in a population wherein said subjects are negative for rheumatoid arthritis;
deriving by said one or more processors an aggregate SDI value for said population based on said determined SDI scores;
determining by said one or more processors a second SDI score for a second subject;
comparing the aggregate SDI value to the second SDI score; and
determining a presence or absence of rheumatoid arthritis in said second subject based on said comparison.

59. The computer-implemented method of claim 40, wherein said first subject has received a treatment for rheumatoid arthritis, and further comprising the steps of:
determining by said one or more processors a second SDI score according to the method of claim 1 for a second subject wherein said second subject is of the same species as said first subject and wherein said second subject has received treatment for rheumatoid arthritis;
comparing said first SDI score to said second SDI score; and,
determining a treatment efficacy for said first subject based on said score comparison.

60. The computer-implemented method of claim 40, further comprising determining a response to rheumatoid arthritis therapy based on said SDI score.

61. The computer-implemented method of claim 40, further comprising selecting a rheumatoid arthritis therapeutic regimen based on said SDI score.

62. The computer-implemented method of claim 40, further comprising rating a rate of change in joint structural damage as low, medium or high based on said SDI score.

63. The computer-implemented method of claim 40, wherein the predictive model performance is characterized by an AUC ranging from 0.60 to 0.99.

64. The computer-implemented method of claim 40, wherein the predictive model performance is characterized by an AUC ranging from 0.70 to 0.79.

65. The computer-implemented method of claim 40, wherein the predictive model performance is characterized by an AUC ranging from 0.80 to 0.89.

66. The computer-implemented method of claim 40, wherein said at least two markers (IL2RA and IL6), (IL2RA and SAA1), (IL6 and SAA1), (IL1B and IL2RA), (TNFRSF11B and IL6), (ICAM1 and IL6), (IL6 and PYD), (CCL22 and IL6), (CHI3L1 and IL6), (CRP and IL6), (IL6 and MMP3), (ICAM3 and IL2RA), (IL6 and VEGFA), (IL6 and RANKL), (ICAM3 and IL6), (IL6 and THBD), (IL6 and MCSF), (IL6 and TNFRSF1A), (IL6 and LEP), (IL6 and IL6R), (IL6 and VCAM1), (IL6 and IL8), (COMP and IL6), (IL2RA and RETN), (IL6 and RETN), (IL2RA and IL6R), (IL6 and MMP1), (TNFRSF11B and RETN), (COMP and IL2RA), (IL1B and IL6), (IL6 and TIMP1), (CHI3L1 and RETN), (IL2RA and LEP), (IL2RA and TIMP1), (CXCL10 and IL6), (EGF and IL6), (IL2RA and RANKL), (IL2RA and MMP3), (IL2RA and THBD), (IL1B and SAA1), (LEP and SAA1), (CRP and IL2RA), (ICTP and IL6), (IL2RA and MCSF) or (ICAM1 and IL2RA).

67. The computer-implemented method of claim 40, wherein said at least two markers comprise one set of markers selected from the group consisting of TWOMRK Set Nos. 1 through 138 of FIG. 1.

68. The computer-implemented method of claim 40, wherein said at least two markers comprises at least three markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

69. The computer-implemented method of claim 40, wherein said at least two markers comprises one set of three markers selected from the group consisting of THREEMRK Set Nos. 1 through 482 of FIG. 2.

70. The computer-implemented method of claim 40, wherein said at least two markers comprises at least four markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

71. The computer-implemented method of claim 40, wherein said at least two markers comprises one set of four markers selected from the group consisting of FOURMRK Set Nos. 1 through 25 of FIG. 3.

72. The computer-implemented method of claim 40, wherein said at least two markers comprises at least five markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

73. The computer-implemented method of claim 40, wherein said at least two markers comprises one set of five markers selected from the group consisting of FIVEMRK Set Nos. 1 through 30 of FIG. 4.

74. The computer-implemented method of claim 40, wherein said at least two markers comprises at least six markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

75. The computer-implemented method of claim 40, wherein said at least six markers comprises one set of six markers selected from the group consisting of SIXMRK Set Nos. 1 through 36 of FIG. 5.

76. The computer-implemented method of claim 40, wherein said first SDI score is predictive of the risk of joint structural damage progression.

77. A system for scoring a sample, said method comprising:
a storage memory for storing a first dataset associated with a first sample obtained from a first subject, wherein said first dataset comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); and,
a processor communicatively coupled to the storage memory for determining a first SDI score from said first dataset using an interpretation function, wherein the first SDI score provides a quantitative measure of the rate of change in joint structural damage in said first subject.

78. The system of claim 77 wherein said first dataset is obtained by a method comprising:
obtaining said first sample from said first subject, wherein said first sample comprises a plurality of analytes;
contacting said first sample with a reagent;
generating a plurality of complexes between said reagent and said plurality of analytes; and,
detecting said plurality of complexes to obtain said first dataset associated with said first sample, wherein said first dataset comprises quantitative data for said at least two markers.

79. The system of claim 77, wherein said first subject diagnosed with an inflammatory disease.

80. The system of claim 79, wherein said inflammatory disease is rheumatoid arthritis.

81. The system of claim 77, wherein said first SDI score is predictive of the rate of change of a clinical assessment.

82. The system of claim 77, wherein said interpretation function is based on a predictive model.

83. The system of claim 77, wherein said joint structural damage comprises joint erosion and joint space narrowing.

84. The system of claim 81, wherein said clinical assessment is selected from the group consisting of: a DAS, a DAS28, a DAS28-ESR, a DAS28-CRP, a RAMRIS, a Sharp score, a total Sharp score (TSS), a van der Heijde-modified Sharp score, a van der Heijde modified total Sharp score, a tender joint count, a swollen joint count, a joint space narrowing score, an erosion score, and an ultrasound score.

85. The system of claim 81, wherein said clinical assessment is a Sharp score.

86. The system of claim 81, wherein said clinical assessment is a total Sharp score.

87. The system of claim 77, wherein said predictive model is developed using an algorithm comprising a Curds and Whey method, Curds and Whey-Lasso method, forward linear stepwise regression, or a Lasso shrinkage and selection method for linear regression.

88. The system of claim 77, wherein:
said storage memory further stores a second dataset associated with a second sample obtained from said first subject, wherein said first sample and said second sample are obtained from said first subject at different times; and
said processor further determines a second SDI score from said second dataset using said interpretation function compares said first SDI score and said second SDI score to determine a change in said SDI scores, wherein said change indicates a change in said rate of joint structural damage in said first subject.

89. The system of claim 88, wherein said indicated change in rate of joint structural damage indicates the presence, absence or extent of the subject's response to a therapeutic regimen.

90. The system of claim 86, wherein said processor further determines a prognosis for rheumatoid arthritis progression in said first subject based on said predicted Sharp score change rate.

91. The system of claim 77, wherein one of said at least two markers is CRP or SAA1.

92. The system of claim 86, wherein said interpretation function is SDIₖ=β₀+Σᵢ₌₁ⁿβᵢXᵢₖ+eₖ, where Xᵢₖ is the marker concentration for the ith biomarker and kth patient, β is the biomarker coefficient, and SDIₖ represents the predicted change in Sharp score from the time that the biomarkers are measured over the period of interest for subject k.

93. The system of claim 77, wherein said SDI score is used as an inflammatory disease surrogate endpoint.

94. The system of claim 93, wherein said inflammatory disease is rheumatoid arthritis.

95. The system of claim 77 wherein said processor is further configured to:
determine SDI scores according the method of claim 40 for subjects in a population wherein said subjects are negative for rheumatoid arthritis;
derive an aggregate SDI value for said population based on said determined SDI scores;
determine a second SDI score for a second subject;
compare the aggregate SDI value to the second SDI score; and
determine a presence or absence of rheumatoid arthritis in said second subject based on said comparison.

96. The system of claim 77, wherein said first subject has received a treatment for rheumatoid arthritis, and said processor is further configured to:
determine a second SDI score according to the method of claim 1 for a second subject wherein said second subject is of the same species as said first subject and wherein said second subject has received treatment for rheumatoid arthritis;
compare said first SDI score to said second SDI score; and,
determine a treatment efficacy for said first subject based on said score comparison.

97. The system of claim 77, wherein said processor is further configured to determine a response to rheumatoid arthritis therapy based on said SDI score.

98. The system of claim 77, wherein said processor is further configured to determine rate of change in joint structural damage as low, medium or high based on said SDI score.

99. The system of claim 77, wherein the predictive model performance is characterized by an AUC ranging from 0.60 to 0.99.

100. The system of claim 77, wherein the predictive model performance is characterized by an AUC ranging from 0.70 to 0.79.

101. The system of claim 77, wherein the predictive model performance is characterized by an AUC ranging from 0.80 to 0.89.

102. The system of claim 77, wherein said at least two markers (IL2RA and IL6), (IL2RA and SAA1), (IL6 and SAA1), (IL1B and IL2RA), (TNFRSF11B and IL6), (ICAM1 and IL6), (IL6 and PYD), (CCL22 and IL6), (CHI3L1 and IL6), (CRP and IL6), (IL6 and MMP3), (ICAM3 and IL2RA), (IL6 and VEGFA), (IL6 and RANKL), (ICAM3 and IL6), (IL6 and THBD), (IL6 and MCSF), (IL6 and TNFRSF1A), (IL6 and LEP), (IL6 and IL6R), (IL6 and VCAM1), (IL6 and IL8), (COMP and IL6), (IL2RA and RETN), (IL6 and RETN), (IL2RA and IL6R), (IL6 and MMP1), (TNFRSF11B and RETN), (COMP and IL2RA), (IL1B and IL6), (IL6 and TIMP1), (CHI3L1 and RETN), (IL2RA and LEP), (IL2RA and TIMP1), (CXCL10 and IL6), (EGF and IL6), (IL2RA and RANKL), (IL2RA and MMP3), (IL2RA and THBD), (IL1B and SAA1), (LEP and SAA1), (CRP and IL2RA), (ICTP and IL6), (IL2RA and MCSF) or (ICAM1 and IL2RA).

103. The system of claim 77, wherein said at least two markers comprise one set of markers selected from the group consisting of TWOMRK Set Nos. 1 through 138 of FIG. 1.

104. The system of claim 77, wherein said at least two markers comprises at least three markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

105. The system of claim 77, wherein said at least two markers comprises one set of three markers selected from the group consisting of THREEMRK Set Nos. 1 through 482 of FIG. 2.

106. The system of claim 77, wherein said at least two markers comprises at least four markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

107. The system of claim 77, wherein said at least two markers comprises one set of four markers selected from the group consisting of FOURMRK Set Nos. 1 through 25 of FIG. 3.

108. The system of claim 77, wherein said at least two markers comprises at least five markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

109. The system of claim 77, wherein said at least two markers comprises one set of five markers selected from the group consisting of FIVEMRK Set Nos. 1 through 30 of FIG. 4.

110. The system of claim 77, wherein said at least two markers comprises at least six markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

111. The system of claim 77, wherein said at least six markers comprises one set of six markers selected from the group consisting of SIXMRK Set Nos. 1 through 36 of FIG. 5.

112. The system of claim 77, wherein said first SDI score is predictive of the risk of joint structural damage progression.

113. A non-transitory computer-readable storage medium storing computer-executable program code, the program code comprising program code for:
receiving a first dataset associated with a first sample obtained from a first subject,
wherein said first dataset comprises quantitative data for at least two markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP 1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA); and,
determining a first SDI score from said first dataset using an interpretation function,
wherein the first SDI score provides a quantitative measure of the rate of change in joint structural damage in said first subject.

114. The non-transitory computer-readable storage medium of claim 113 wherein said first dataset is obtained by a method comprising:
obtaining said first sample from said first subject, wherein said first sample comprises a plurality of analytes;
contacting said first sample with a reagent;
generating a plurality of complexes between said reagent and said plurality of analytes; and,
detecting said plurality of complexes to obtain said first dataset associated with said first sample, wherein said first dataset comprises quantitative data for said at least two markers.

115. The non-transitory computer-readable storage medium of claim 113, wherein said first subject diagnosed with an inflammatory disease.

116. The non-transitory computer-readable storage medium of claim 115, wherein said inflammatory disease is rheumatoid arthritis.

117. The non-transitory computer-readable storage medium of claim 113, wherein said first SDI score is predictive of the rate of change of a clinical assessment.

118. The non-transitory computer-readable storage medium of claim 113, wherein said interpretation function is based on a predictive model.

119. The non-transitory computer-readable storage medium of claim 113, wherein said joint structural damage comprises joint erosion and joint space narrowing.

120. The non-transitory computer-readable storage medium of claim 117, wherein said clinical assessment is selected from the group consisting of: a DAS, a DAS28, a DAS28-ESR, a DAS28-CRP, a RAMRIS, a Sharp score, a total Sharp score (TSS), a van der Heijde-modified Sharp score, a van der Heijde modified total Sharp score, a tender joint count, a swollen joint count, a joint space narrowing score, an erosion score, and an ultrasound score.

121. The non-transitory computer-readable storage medium of claim 117, wherein said clinical assessment is a Sharp score.

122. The non-transitory computer-readable storage medium of claim 117, wherein said clinical assessment is a total Sharp score.

123. The non-transitory computer-readable storage medium of claim 118, wherein said predictive model is developed using an algorithm comprising a Curds and Whey method, Curds and Whey-Lasso method, forward linear stepwise regression, or a Lasso shrinkage and selection method for linear regression.

124. The non-transitory computer-readable storage medium of claim 113, further comprising program code for:
receiving a second dataset associated with a second sample obtained from said first subject, wherein said first sample and said second sample are obtained from said first subject at different times;
determining a second SDI score from said second dataset using said interpretation function; and,
comparing said first SDI score and said second SDI score to determine a change in said SDI scores, wherein said change indicates a change in said rate of joint structural damage in said first subject.

125. The non-transitory computer-readable storage medium of claim 124, wherein said indicated change in rate of joint structural damage indicates the presence, absence or extent of the subject's response to a therapeutic regimen.

126. The non-transitory computer-readable storage medium of claim 123, further comprising determining a prognosis for rheumatoid arthritis progression in said first subject based on said predicted Sharp score change rate.

127. The non-transitory computer-readable storage medium of claim 113, wherein one of said at least two markers is CRP or SAA1.

128. The non-transitory computer-readable storage medium of claim 121, wherein said interpretation function is SDIₖ=β₀+Σᵢ₌₁ⁿβᵢXᵢₖ+eₖ, where Xᵢₖ is the marker concentration for the ith biomarker and kth patient, β is the biomarker coefficient, and SDIₖ represents the predicted change in Sharp score from the time that the biomarkers are measured over the period of interest for subject k.

129. The non-transitory computer-readable storage medium of claim 113, wherein said SDI score is used as an inflammatory disease surrogate endpoint.

130. The non-transitory computer-readable storage medium of claim 128, wherein said inflammatory disease is rheumatoid arthritis.

131. The non-transitory computer-readable storage medium of claim 113 further comprising program code for:
determining SDI scores for subjects in a population wherein said subjects are negative for rheumatoid arthritis;
deriving an aggregate SDI value for said population based on said determined SDI scores;
determining a second SDI score for a second subject;
comparing the aggregate SDI value to the second SDI score; and
determining a presence or absence of rheumatoid arthritis in said second subject based on said comparison.

132. The non-transitory computer-readable storage medium of claim 113 wherein said first subject has received a treatment for rheumatoid arthritis, and further comprising program code for:
determining a second SDI score according to the method of claim 1 for a second subject wherein said second subject is of the same species as said first subject and wherein said second subject has received treatment for rheumatoid arthritis;
comparing said first SDI score to said second SDI score; and,
determining a treatment efficacy for said first subject based on said score comparison.

133. The non-transitory computer-readable storage medium of claim 113, further comprising determining a response to rheumatoid arthritis therapy based on said SDI score.

134. The non-transitory computer-readable storage medium of claim 113, further comprising program code for rating a rate of change in joint structural damage as low, medium or high based on said SDI score.

135. The non-transitory computer-readable storage medium of claim 113, wherein the predictive model performance is characterized by an AUC ranging from 0.60 to 0.99.

136. The non-transitory computer-readable storage medium of claim 113, wherein the predictive model performance is characterized by an AUC ranging from 0.70 to 0.79.

137. The non-transitory computer-readable storage medium of claim 113, wherein the predictive model performance is characterized by an AUC ranging from 0.80 to 0.89.

138. The non-transitory computer-readable storage medium of claim 113, wherein said at least two markers (IL2RA and IL6), (IL2RA and SAA1), (IL6 and SAA1), (IL1B and IL2RA), (TNFRSF11B and IL6), (ICAM1 and IL6), (IL6 and PYD), (CCL22 and IL6), (CHI3L1 and IL6), (CRP and IL6), (IL6 and MMP3), (ICAM3 and IL2RA), (IL6 and VEGFA), (IL6 and RANKL), (ICAM3 and IL6), (IL6 and THBD), (IL6 and MCSF), (IL6 and TNFRSF1A), (IL6 and LEP), (IL6 and IL6R), (IL6 and VCAM1), (IL6 and IL8), (COMP and IL6), (IL2RA and RETN), (IL6 and RETN), (IL2RA and IL6R), (IL6 and MMP1), (TNFRSF11B and RETN), (COMP and IL2RA), (IL1B and IL6), (IL6 and TIMP1), (CHI3L1 and RETN), (IL2RA and LEP), (IL2RA and TIMP1), (CXCL10 and IL6), (EGF and IL6), (IL2RA and RANKL), (IL2RA and MMP3), (IL2RA and THBD), (IL1B and SAA1), (LEP and SAA1), (CRP and IL2RA), (ICTP and IL6), (IL2RA and MCSF) or (ICAM1 and IL2RA).

139. The non-transitory computer-readable storage medium of claim 113, wherein said at least two markers comprise one set of markers selected from the group consisting of TWOMRK Set Nos. 1 through 138 of FIG. 1.

140. The non-transitory computer-readable storage medium of claim 113, wherein said at least two markers comprises at least three markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

141. The non-transitory computer-readable storage medium of claim 113, wherein said at least two markers comprises one set of three markers selected from the group consisting of THREEMRK Set Nos. 1 through 482 of FIG. 2.

142. The non-transitory computer-readable storage medium of claim 113, wherein said at least two markers comprises at least four markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

143. The non-transitory computer-readable storage medium of claim 113, wherein said at least two markers comprises one set of four markers selected from the group consisting of FOURMRK Set Nos. 1 through 25 of FIG. 3.

144. The non-transitory computer-readable storage medium of claim 113, wherein said at least two markers comprises at least five markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

145. The non-transitory computer-readable storage medium of claim 113, wherein said at least two markers comprises one set of five markers selected from the group consisting of FIVEMRK Set Nos. 1 through 30 of FIG. 4.

146. The non-transitory computer-readable storage medium of claim 113, wherein said at least two markers comprises at least six markers selected from the group consisting of: chemokine (C—C motif) ligand 22 (CCL22); chitinase 3-like 1 (cartilage glycoprotein-39) (CHI3L1); cartilage oligomeric matrix protein (COMP); C-reactive protein, pentraxin-related (CRP); colony stimulating factor 1 (macrophage) (CSF1); chemokine (C—X—C motif) ligand 10 (CXCL10); epidermal growth factor (beta-urogastrone) (EGF); intercellular adhesion molecule 1 (ICAM1); intercellular adhesion molecule 3 (ICAM3); C-telopeptide pyridinoline crosslinks of type I collagen (ICTP); interleukin 1, beta (IL1B); interleukin 2 receptor, alpha (IL2RA); interleukin 6 (interferon, beta 2) (IL6); interleukin 6 receptor (IL6R); interleukin 8 (IL8); leptin (LEP); matrix metallopeptidase 1 (interstitial collagenase) (MMP1); matrix metallopeptidase 3 (stromelysin 1, progelatinase) (MMP3); pyridinoline (PYD); resistin (RETN); serum amyloid A1 (SAA1); thrombomodulin (THBD); TIMP metallopeptidase inhibitor 1 (TIMP1); tumor necrosis factor receptor superfamily, member 11b (TNFRSF11B); tumor necrosis factor receptor superfamily, member 1A (TNFRSF1A); tumor necrosis factor (ligand) superfamily, member 11 (TNFSF11); vascular cell adhesion molecule 1 (VCAM1); and, vascular endothelial growth factor A (VEGFA).

147. The non-transitory computer-readable storage medium of claim 113, wherein said at least six markers comprises one set of six markers selected from the group consisting of SIXMRK Set Nos. 1 through 36 of FIG. 5.

148. The non-transitory computer-readable storage medium of claim 113, wherein said first SDI score is predictive of the risk of joint structural damage progression.
